(19) United States
(12) Patent Application Publication
(10) Pub. No.: US 2026/0341588 A1
(43) Pub. Date: Oct. 29, 2026

(54) COIL COMPONENT, METHOD FOR MANUFACTURING COIL COMPONENT, AND ELECTRONIC/ELECTRIC DEVICE

(71) Applicant: DELTA ELECTRONICS (JAPAN), INC., Tokyo (JP)

(72) Inventors: Satoshi MARUYAMA, Tokyo (JP); Takeshi Takahashi, Tokyo (JP); Kosuke Chimata, Tokyo (JP); Shuji Iguchi, Tokyo (JP); Setsuko Maruyama, Tokyo (JP)

(73) Assignee: DELTA ELECTRONICS (JAPAN), INC., Tokyo (JP)

(21) Appl. No.: 19/406,949

(22) Filed: Dec. 3, 2025

Related U.S. Application Data
(63) Continuation of application No. PCT/JP2023/021227, filed on Jun. 7, 2023.

(51) Int. Cl. H01F 27/34; H01F 17/04; H01F 27/28; H01F 27/29; H01F 41/10

(52) U.S. Cl. CPC H01F 27/34; H01F 17/04; H01F 27/2852; H01F 27/29; H01F 2017/048; H01F 27/348; H01F 41/10

(57) ABSTRACT

A coil component includes a coil member, a main body portion, and a support member. The coil member includes a coil conductor portion that includes a first spiral conductor portion of a spiral shape when viewed in a first direction. The main body portion contains magnetic powder, and has an outer surface extending in a first direction and two intersecting surfaces arranged alongside in the first direction, and covering at least partially the coil member with the intersecting surfaces. The support member contacts the coil member and forms a first interface intersecting the first direction. The support member has an exposed support surface exposed from the main body portion. The exposed support surface includes a first exposed surface, which has an in-plane direction along the first direction.

### CROSS REFERENCE TO RELATED APPLICATIONS

This application is a continuation application of PCT Application No. PCT/JP2023/021227, filed on Jun. 7, 2023. The content of the application is incorporated herein by reference.

### BACKGROUND OF THE INVENTION

### 1. Field of the Invention

The present invention relates to a coil component, a method for manufacturing a coil component, and an electronic/electric device.

### 2. Description of Related Art

Patent Document 1 and Patent Document 2 describe coil components in which the lead-out member and the external electrode are connected by a connecting electrode or a support electrode inside the main body. Patent Document 3 describes a coil component in which the opposing surfaces of the main body are connected longitudinally across the lead-out member, and the coil part has a connection electrode with a surface perpendicular to the longitudinal direction exposed from the body. Patent Document 4 describes a coil component in which a bump electrode formed on the upper surface of a dummy lead conductor connects a planar spiral conductor to an external electrode (lower surface) through a resin layer containing metallic magnetic powder. Patent Document 5, Patent Document 6, and Patent Document 7 describe coil components in which the lead-out electrode or post member within the main body extends along the axial direction of the coil to connect the coil to the terminal electrode (lower surface).

### PRIOR ART DOCUMENT

### Patent Document

[Patent Document 1] US Patent Publication No. 2020/0105456

[Patent Document 2] US Patent Publication No. 2022/0189680

[Patent Document 3] US Patent Publication No. 2021/0183561

[Patent Document 4] JP Patent Publication No. 2014-013815

[Patent Document 5] JP Patent Publication No. 2017-103359

[Patent Document 6] JP Patent Publication No. 2017-199719

[Patent Document 7] JP Patent Publication No. 2018-160610

### SUMMARY OF THE INVENTION

### Problems to be Solved by the Invention

In a coil component, magnetic properties of a product are significantly altered by the magnetic field generated around the connecting electrode and the support member. Furthermore, when the coil member is covered by a main body portion containing a magnetic powder, it is desirable to ensure sufficient positioning accuracy of the coil member relative to the main body portion and to reduce the resistance at the interface between the connecting electrode and the lead-out section.

The present invention aims to provide a coil component, a method for manufacturing a coil component, and an electronic/electric device, by which sufficient positioning accuracy of the coil member relative to the main body portion can be achieved and stable magnetic properties can be obtained.

### Means to Solve the Problems

In an aspect of the present invention, a coil component includes a coil member, a main body portion, and a support member. The coil member includes a coil conductor portion, which includes a first spiral conductor portion of a spiral shape when viewed in a first direction. The main body portion contains magnetic powder, and has an outer surface extending in a first direction and two intersecting surfaces arranged alongside in the first direction, and covering at least partially the coil member with the intersecting surfaces. The support member contacts the coil member and forms a first interface intersecting the first direction. The support member has an exposed support surface exposed from the main body portion. The exposed support surface includes a first exposed surface, which has an in-plane direction along the first direction.

According to the structure as configured, reinforcement in the first direction is provided by the support member in contact with the coil member, thereby improving the positioning accuracy of the coil member relative to the main body portion and increasing the strength of the coil component.

In the coil component described above, the support member may have a support conductor portion, which is conductive, and at least a part of the first interface may be formed from a contact interface between a conductive surface of the support conductor portion and a conductive surface of the coil conductor portion. Accordingly, the connection area with the conductive material (for example, external terminal or solder) is improved.

In the coil component described above, the exposed support surface may include an exposed conductive surface formed from the support conductor portion. Accordingly, the solder joint surface between the exposed conductive surface and an external electrode is stabilized. In this case, the exposed support surface may include the exposed conductive surface exposed between the two intersecting surfaces arranged alongside in the first direction.

At this time, at least a part of the first exposed surface may be formed from the exposed conductive surface. Accordingly, the adhesion between the exposed conductive surface, which is at least a part of the first exposed surface of the coil component, and the conductive material (for example, external terminal or solder) is improved.

In the coil component described above, the exposed support surface may include a second exposed surface intersecting the first direction, and at least a part of the second exposed surface may be formed from the exposed conductive surface. Accordingly, the adhesion between the exposed conductive surface, which is at least a part of the second exposed surface of the coil component, and the conductive material (for example, external terminal or solder) is improved.

In the coil component described above, at least a part of the first exposed surface may be formed from the exposed conductive surface. Accordingly, the adhesion between the exposed conductive surface, which is at least a part of the first exposed surface of the coil component, and the conductive material (for example, external terminal or solder), as well as the adhesion between the exposed conductive surface, which is at least a part of the second exposed surface, and the conductive material (for example, external terminal or solder), are improved.

In the coil component described above, the entire outer surface may be insulated. Accordingly, solder is prevented from adhering to the outer surface of the coil component, and the installation area of the coil component is reduced.

In the coil component described above, at least one of the two intersecting surfaces may be insulated by an insulating layer. Accordingly, the side opposite to the mounting surface in the coil component is insulated, and the installation area of the coil component is reduced.

In the coil component described above, the insulating layer may include a layer formed of a resin having an average thickness of 0.10 μm to 10.0 μm. Accordingly, deterioration of magnetic properties due to the support conductor portion is prevented, and the magnetic properties of the coil component are maintained.

In the coil component described above, an external electrode in contact with the exposed conductive surface may be further provided. Accordingly, the solder joint surface formed by the external electrode is stabilized.

In the coil component described above, a part of the outermost surface may be formed from the exposed conductive surface. Accordingly, the exposed conductive surface and a conductive member (for example, external terminal or solder) are directly connected, and the coil component is miniaturized by eliminating the external electrode.

In the coil component described above, the coil conductor portion may include the spiral conductor portion and the lead-out section continuously connected to the spiral conductor portion in a direction perpendicular to the first direction. The lead-out section may have an exposed lead-out surface exposed from the outer surface of the main body portion. At least a part of the first interface may be formed from a contact interface between a conductive surface of the lead-out section and a conductive surface of the support conductor portion. Accordingly, an increase in the length of the lead-out section is suppressed, and magnetic flux canceled by the lead-out section can be reduced.

In the coil component described above, the support member may be configured to taper toward the tip while contacting the conductive surface of the coil conductor portion. Accordingly, the volume of magnetic powder near the coil conductor portion is increased, and magnetic flux is effectively utilized.

In the coil component described above, the exposed lead-out surface may extend in a direction perpendicular to the first direction. Accordingly, the adhesion between the exposed lead-out surface and a conductive member (for example, external terminal or solder) is improved.

In the coil component described above, the main body portion may connect two surfaces parallel to the first direction via the support member. Accordingly, deterioration of magnetic properties of the coil component is reduced, and adhesion between the support member and a conductive member (for example, external terminal or solder) is improved.

In the coil component described above, the outer surface may include a plurality of surfaces, and two adjacent surfaces among the plurality of surfaces may be connected by a connecting portion. The support member, in at least a part of the connecting portion, may be exposed from the main body portion. Accordingly, adhesion between the outer surface of the coil component and a conductive member (e.g., external terminal or solder) is improved by utilizing the support member exposed from the main body portion as the connecting portion.

In the coil component described above, the main body portion may have a first recess part recessed in the first direction on at least one of the two surfaces arranged alongside in the first direction, and at least a part of the exposed conductive surface may be located on a recessed surface of the first recess part. Accordingly, the occupied volume (height) of the coil component after soldering is reduced due to the recessed surface of the first recess part.

In the coil component described above, the coil member may have a second recess recessed in the first direction, and at least a part of the first interface may be formed from a contact interface between at least a part of a recessed surface, which is a surface formed from an opening edge and an inner surface of the second recess, and the support member. Accordingly, the contact interface between the support member and the coil member is ensured, and the bonding strength between the support member and the coil member is improved.

In the coil component described above, the support member may have a support conductor portion, which is conductive, and at least a part of the first interface may be formed from a contact interface between a conductive surface of at least a part of the recessed surface and the conductive surface of the support conductor portion. Accordingly, conductive contact with the support member at the second recess is achieved.

In the coil component described above, the support member may have a soft magnetic support member, and at least a part of the first interface may be formed from a contact interface between the soft magnetic support member and the coil member. The relative permeability of the soft magnetic support member in the first direction may be greater than the relative permeability of the main body portion in the first direction. Accordingly, the magnetic properties of the coil component are improved due to the soft magnetic portion support of the support member.

In the coil component described above, the main body portion may connect two surfaces parallel to the first direction via the support member. Accordingly, the magnetic properties of the coil component are improved.

In the coil component described above, the outer surface may include a plurality of surfaces, and two adjacent surfaces among the plurality of surfaces may be connected by a connecting portion. The support member, in at least a part of the connecting portion, may be exposed from the main body portion. Accordingly, adhesion between the outer surface of the coil component and a conductive member (e.g., external terminal or solder) is improved by utilizing the support member exposed from the main body portion as the connecting portion.

In the coil component described above, the main body portion may have an outer shape of rectangular parallelepiped, which has sides parallel to the first direction. The support member may be arranged to include at least one end part of four sides of the main body portion parallel to the first direction. Accordingly, the magnetic properties of the coil component are improved.

In the coil component described above, the soft magnetic support member may be an insulator. Accordingly, eddy current loss of the coil component is reduced.

In the coil component described above, the support member may have a soft magnetic support member, and the relative permeability of the soft magnetic support member in the first direction may be greater than the relative permeability of the main body portion in the first direction. Accordingly, the magnetic properties of the coil component are improved.

In another aspect of the present invention, a method for manufacturing a coil component comprises: a first step of forming a plurality of spiral portions having a spiral shape when viewed in the first direction, and a conductor pattern including a connecting portion connecting the plurality of spiral portions; a second step of forming a support member material extending from the connecting portion in the first direction after the first step; a third step of supplying a material containing a magnetic powder to cover the conductor pattern at least on two surfaces in the first direction, and forming a plate material; and a fourth step of cutting the plate material so that the first direction is parallel to a cut surface, and separating the plate material into a plurality of first members (products), which include the spiral portions and a part of the connecting portion, and a second member, which includes the remaining part of the connecting portion. In the fourth step, the second member includes all or part of the support member material. Accordingly, the manufacturing process of the coil component is simplified, and the positional accuracy of the coil member relative to the main body portion is improved.

In the method for manufacturing a coil component described above, the first step may include forming an insulator portion on a surface of the conductor pattern after forming the conductor pattern.

In the method for manufacturing a coil component described above, the second step may include forming an insulator portion on a surface of the conductor pattern and on a surface of the support member material after forming the support member material.

In the method for manufacturing a coil component described above, the first members separated in the fourth step may include a part of the support member material.

In the method for manufacturing a coil component described above, in the fourth step, before separating the first members and the second member, a portion of the plate material where the support member material is disposed may be half-cut from a first direction to form a linear recess part extending in a second direction orthogonal to the first direction, with the support member material exposed on a bottom surface. The plate material may then be cut so that a dividing line between the first member and the second member passes through a bottom surface of the linear recess part, thereby forming a stepped portion in the first member where the support member material is exposed at a lower surface of the stepped portion.

In the method for manufacturing a coil component described above, the fourth step may include removing a part of the connecting portion or a part of the support member material to expose a conductive surface, and forming an electrode electrically connected to the conductive surface, and then separating the first members and the second member.

In the method for manufacturing a coil component described above, in the fourth step, the second member may include entire the support member material.

In the method for manufacturing a coil component described above, in the fourth step, the first members may include a part of the support member material, and the support member material may be exposed on the surfaces of the first members.

In the method for manufacturing a coil component described above, a fifth step of forming an external electrode on the conductive surfaces of the first members may further be included.

In a further aspect, the present invention provides an electronic/electric device, in which the above coil component is mounted. In the electronic/electric device, the coil component is connected to a substrate at terminal members provided on exposed conductor portions located at each of the two end parts of the coil conductor portion and exposed outwards.

### Effect of the Invention

According to the present invention, a coil component, a method for manufacturing a coil component, and electronic/electric device are provided, by which sufficient positioning accuracy of the coil member relative to the main body portion can be achieved and stable magnetic properties can be obtained.

### BRIEF DESCRIPTION OF THE DRAWINGS

FIG. 1 is a perspective view conceptually illustrating the shape of a coil component according to a first embodiment of the present invention.

FIG. 2 is a diagram illustrating the structure of a coil conductor portion provided in the coil component according to the first embodiment of the present invention.

FIG. 3 is an XY plan view illustrating the structure of a first spiral conductor portion provided in the coil component according to the first embodiment of the present invention.

FIG. 4 is an XY plan view illustrating the structure of a second spiral conductor portion provided in the coil component according to the first embodiment of the present invention.

FIG. 5A is a cross-sectional view on the XZ plane illustrating the structure of the coil component according to the first embodiment of the present invention.

FIG. 5B is a cross-sectional view on the YZ plane illustrating the structure of the coil component according to the first embodiment of the present invention.

FIG. 6 is an XY plan view illustrating the structure of a first spiral conductor portion provided in the coil component according to a second embodiment of the present invention.

FIG. 7A is a cross-sectional view on the XZ plane illustrating the structure of the coil component according to the second embodiment of the present invention.

FIG. 7B is a cross-sectional view on the YZ plane illustrating the structure of the coil component according to the second embodiment of the present invention.

FIG. 8 is an XY plan view illustrating the structure of a first spiral conductor portion provided in the coil component according to a third embodiment of the present invention.

FIG. 9A is a cross-sectional view on the XZ plane illustrating the structure of the coil component according to the third embodiment of the present invention.

FIG. 9B is a cross-sectional view on the YZ plane illustrating the structure of the coil component according to the third embodiment of the present invention.

FIG. 10 is an XY plan view illustrating the structure of a first spiral conductor portion provided in the coil component according to a fourth embodiment of the present invention.

FIG. 11A is a cross-sectional view on the XZ plane illustrating the structure of the coil component according to the fourth embodiment of the present invention.

FIG. 11B is a cross-sectional view on the YZ plane illustrating the structure of the coil component according to the fourth embodiment of the present invention.

FIG. 12 is an XY plan view illustrating the structure of a first spiral conductor portion provided in the coil component according to a fifth embodiment of the present invention.

FIG. 13A is a cross-sectional view on the XZ plane illustrating the structure of the coil component according to the fifth embodiment of the present invention.

FIG. 13B is a cross-sectional view on the YZ plane illustrating the structure of the coil component according to the fifth embodiment of the present invention.

FIG. 14 is an XY plan view illustrating the structure of a first spiral conductor portion provided in the coil component according to a sixth embodiment of the present invention.

FIG. 15A is a cross-sectional view on the XZ plane illustrating the structure of the coil component according to the sixth embodiment of the present invention.

FIG. 15B is a cross-sectional view on the YZ plane illustrating the structure of the coil component according to the sixth embodiment of the present invention.

FIG. 16 is an XY plan view illustrating the structure of a first spiral conductor portion provided in the coil component according to a seventh embodiment of the present invention.

FIG. 17A is a cross-sectional view on the XZ plane illustrating the structure of the coil component according to the seventh embodiment of the present invention.

FIG. 17B is a cross-sectional view on the YZ plane illustrating the structure of the coil component according to the seventh embodiment of the present invention.

FIG. 18 is a partial cross-sectional view illustrating an example of a second recess.

FIG. 19A is a diagram illustrating an example of a manufacturing method of the coil component according to the first embodiment.

FIG. 19B is a diagram illustrating an example of a manufacturing method of the coil component according to the first embodiment.

FIG. 20A is a diagram illustrating an example of a manufacturing method of the coil component according to the first embodiment.

FIG. 20B is a diagram illustrating an example of a manufacturing method of the coil component according to the first embodiment.

FIG. 21A is a diagram illustrating an example of a manufacturing method of the coil component according to the first embodiment.

FIG. 21B is a diagram illustrating an example of a manufacturing method of the coil component according to the first embodiment.

FIG. 22A is a diagram illustrating an example of a manufacturing method of the coil component according to the first embodiment.

FIG. 22B is a diagram illustrating an example of a manufacturing method of the coil component according to the first embodiment.

FIG. 23A is a diagram illustrating an example of a manufacturing method of the coil component according to the first embodiment.

FIG. 23B is a diagram illustrating an example of a manufacturing method of the coil component according to the first embodiment.

FIG. 24A is a diagram illustrating an example of a manufacturing method of the coil component according to the first embodiment.

FIG. 24B is a diagram illustrating an example of a manufacturing method of the coil component according to the first embodiment.

FIG. 25A is a diagram illustrating an example of a manufacturing method of the coil component according to the first embodiment.

FIG. 25B is a diagram illustrating an example of a manufacturing method of the coil component according to the first embodiment.

FIG. 26A is a diagram illustrating an example of a manufacturing method of the coil component according to the first embodiment.

FIG. 26B is a diagram illustrating an example of a manufacturing method of the coil component according to the first embodiment.

FIG. 26C is a diagram illustrating an example of a manufacturing method of the coil component according to the first embodiment.

FIG. 27A is a diagram illustrating an example of a manufacturing method of the coil component according to the first embodiment.

FIG. 27B is a diagram illustrating an example of a manufacturing method of the coil component according to the first embodiment.

FIG. 27C is a diagram illustrating an example of a manufacturing method of the coil component according to the first embodiment.

FIG. 28A is a diagram illustrating an example of a manufacturing method of the coil component according to the second embodiment.

FIG. 28B is a diagram illustrating an example of a manufacturing method of the coil component according to the second embodiment.

FIG. 29A is a diagram illustrating an example of a manufacturing method of the coil component according to the second embodiment.

FIG. 29B is a diagram illustrating an example of a manufacturing method of the coil component according to the second embodiment.

FIG. 30A is a diagram illustrating an example of a manufacturing method of the coil component according to the second embodiment.

FIG. 30B is a diagram illustrating an example of a manufacturing method of the coil component according to the second embodiment.

FIG. 31A is a diagram illustrating an example of a manufacturing method of the coil component according to the second embodiment.

FIG. 31B is a diagram illustrating an example of a manufacturing method of the coil component according to the second embodiment.

FIG. 32A is a diagram illustrating an example of a manufacturing method of the coil component according to the second embodiment.

FIG. 32B is a diagram illustrating an example of a manufacturing method of the coil component according to the second embodiment.

FIG. 33A is a diagram illustrating an example of a manufacturing method of the coil component according to the second embodiment.

FIG. 33B is a diagram illustrating an example of a manufacturing method of the coil component according to the second embodiment.

FIG. 34A is a diagram illustrating an example of a manufacturing method of the coil component according to the second embodiment.

FIG. 34B is a diagram illustrating an example of a manufacturing method of the coil component according to the second embodiment.

FIG. 35A is a diagram illustrating an example of a manufacturing method of the coil component according to the second embodiment.

FIG. 35B is a diagram illustrating an example of a manufacturing method of the coil component according to the second embodiment.

FIG. 35C is a diagram illustrating an example of a manufacturing method of the coil component according to the second embodiment.

FIG. 36A is a diagram illustrating an example of a manufacturing method of the coil component according to the second embodiment.

FIG. 36B is a diagram illustrating an example of a manufacturing method of the coil component according to the second embodiment.

FIG. 36C is a diagram illustrating an example of a manufacturing method of the coil component according to the second embodiment.

FIG. 37A is a diagram illustrating an example of a manufacturing method of the coil component according to the third embodiment.

FIG. 37B is a diagram illustrating an example of a manufacturing method of the coil component according to the third embodiment.

FIG. 38A is a diagram illustrating an example of a manufacturing method of the coil component according to the third embodiment.

FIG. 38B is a diagram illustrating an example of a manufacturing method of the coil component according to the third embodiment.

FIG. 39A is a diagram illustrating an example of a manufacturing method of the coil component according to the third embodiment.

FIG. 39B is a diagram illustrating an example of a manufacturing method of the coil component according to the third embodiment.

FIG. 39C is a diagram illustrating an example of a manufacturing method of the coil component according to the third embodiment.

FIG. 40A is a diagram illustrating an example of a manufacturing method of the coil component according to the third embodiment.

FIG. 40B is a diagram illustrating an example of a manufacturing method of the coil component according to the third embodiment.

FIG. 40C is a diagram illustrating an example of a manufacturing method of the coil component according to the third embodiment.

FIG. 41A is a diagram illustrating an example of a manufacturing method of the coil component according to the fourth embodiment.

FIG. 41B is a diagram illustrating an example of a manufacturing method of the coil component according to the fourth embodiment.

FIG. 42A is a diagram illustrating an example of a manufacturing method of the coil component according to the fourth embodiment.

FIG. 42B is a diagram illustrating an example of a manufacturing method of the coil component according to the fourth embodiment.

FIG. 43A is a diagram illustrating an example of a manufacturing method of the coil component according to the fourth embodiment.

FIG. 43B is a diagram illustrating an example of a manufacturing method of the coil component according to the fourth embodiment.

FIG. 43C is a diagram illustrating an example of a manufacturing method of the coil component according to the fourth embodiment.

FIG. 44A is a diagram illustrating an example of a manufacturing method of the coil component according to the fourth embodiment.

FIG. 44B is a diagram illustrating an example of a manufacturing method of the coil component according to the fourth embodiment.

FIG. 44C is a diagram illustrating an example of a manufacturing method of the coil component according to the fourth embodiment.

FIG. 45A is a diagram illustrating an example of a manufacturing method of the coil component according to the fifth embodiment.

FIG. 45B is a diagram illustrating an example of a manufacturing method of the coil component according to the fifth embodiment.

FIG. 46A is a diagram illustrating an example of a manufacturing method of the coil component according to the fifth embodiment.

FIG. 46B is a diagram illustrating an example of a manufacturing method of the coil component according to the fifth embodiment.

FIG. 46C is a diagram illustrating an example of a manufacturing method of the coil component according to the fifth embodiment.

FIG. 47A is a diagram illustrating an example of a manufacturing method of the coil component according to the sixth embodiment.

FIG. 47B is a diagram illustrating an example of a manufacturing method of the coil component according to the sixth embodiment.

FIG. 48A is a diagram illustrating an example of a manufacturing method of the coil component according to the sixth embodiment.

FIG. 48B is a diagram illustrating an example of a manufacturing method of the coil component according to the sixth embodiment.

FIG. 49A is a diagram illustrating an example of a manufacturing method of the coil component according to the sixth embodiment.

FIG. 49B is a diagram illustrating an example of a manufacturing method of the coil component according to the sixth embodiment.

FIG. 50A is a diagram illustrating an example of a manufacturing method of the coil component according to the sixth embodiment.

FIG. 50B is a diagram illustrating an example of a manufacturing method of the coil component according to the sixth embodiment.

FIG. 51A is a diagram illustrating an example of a manufacturing method of the coil component according to the sixth embodiment.

FIG. 51B is a diagram illustrating an example of a manufacturing method of the coil component according to the sixth embodiment.

FIG. 52A is a diagram illustrating an example of a manufacturing method of the coil component according to the sixth embodiment.

FIG. 52B is a diagram illustrating an example of a manufacturing method of the coil component according to the sixth embodiment.

FIG. 53A is a diagram illustrating an example of a manufacturing method of the coil component according to the sixth embodiment.

FIG. 53B is a diagram illustrating an example of a manufacturing method of the coil component according to the sixth embodiment.

FIG. 54A is a diagram illustrating an example of a manufacturing method of the coil component according to the sixth embodiment.

FIG. 54B is a diagram illustrating an example of a manufacturing method of the coil component according to the sixth embodiment.

FIG. 54C is a diagram illustrating an example of a manufacturing method of the coil component according to the sixth embodiment.

FIG. 55A is a diagram illustrating an example of a manufacturing method of the coil component according to the sixth embodiment.

FIG. 55B is a diagram illustrating an example of a manufacturing method of the coil component according to the sixth embodiment.

FIG. 55C is a diagram illustrating an example of a manufacturing method of the coil component according to the sixth embodiment.

FIG. 56A is a diagram illustrating an example of another manufacturing method of the coil component according to the second embodiment.

FIG. 56B is a diagram illustrating an example of another manufacturing method of the coil component according to the second embodiment.

FIG. 57A is a diagram illustrating an example of another manufacturing method of the coil component according to the second embodiment.

FIG. 57B is a diagram illustrating an example of another manufacturing method of the coil component according to the second embodiment.

FIG. 58A is a diagram illustrating an example of another manufacturing method of the coil component according to the second embodiment.

FIG. 58B is a diagram illustrating an example of another manufacturing method of the coil component according to the second embodiment.

FIG. 59A is a diagram illustrating an example of another manufacturing method of the coil component according to the second embodiment.

FIG. 59B is a diagram illustrating an example of another manufacturing method of the coil component according to the second embodiment.

FIG. 60A is a diagram illustrating an example of another manufacturing method of the coil component according to the second embodiment.

FIG. 60B is a diagram illustrating an example of another manufacturing method of the coil component according to the second embodiment.

FIG. 61A is a diagram illustrating an example of another manufacturing method of the coil component according to the second embodiment.

FIG. 61B is a diagram illustrating an example of another manufacturing method of the coil component according to the second embodiment.

FIG. 62A is a diagram illustrating an example of another manufacturing method of the coil component according to the second embodiment.

FIG. 62B is a diagram illustrating an example of another manufacturing method of the coil component according to the second embodiment.

FIG. 63A is a diagram illustrating an example of another manufacturing method of the coil component according to the second embodiment.

FIG. 63B is a diagram illustrating an example of another manufacturing method of the coil component according to the second embodiment.

FIG. 64A is a diagram illustrating an example of another manufacturing method of the coil component according to the second embodiment.

FIG. 64B is a diagram illustrating an example of another manufacturing method of the coil component according to the second embodiment.

FIG. 65A is a diagram illustrating an example of another manufacturing method of the coil component according to the second embodiment.

FIG. 65B is a diagram illustrating an example of another manufacturing method of the coil component according to the second embodiment.

FIG. 66A is a diagram illustrating an example of another manufacturing method of the coil component according to the second embodiment.

FIG. 66B is a diagram illustrating an example of another manufacturing method of the coil component according to the second embodiment.

FIG. 66C is a diagram illustrating an example of another manufacturing method of the coil component according to the second embodiment.

FIG. 67A is a diagram illustrating an example of a manufacturing method of the coil component according to the seventh embodiment.

FIG. 67B is a diagram illustrating an example of a manufacturing method of the coil component according to the seventh embodiment.

FIG. 68A is a diagram illustrating an example of a manufacturing method of the coil component according to the seventh embodiment.

FIG. 68B is a diagram illustrating an example of a manufacturing method of the coil component according to the seventh embodiment.

FIG. 69A is a diagram illustrating an example of a manufacturing method of the coil component according to the seventh embodiment.

FIG. 69B is a diagram illustrating an example of a manufacturing method of the coil component according to the seventh embodiment.

FIG. 70A is a diagram illustrating an example of a manufacturing method of the coil component according to the seventh embodiment.

FIG. 70B is a diagram illustrating an example of a manufacturing method of the coil component according to the seventh embodiment.

FIG. 71A is a diagram illustrating an example of a manufacturing method of the coil component according to the seventh embodiment.

FIG. 71B is a diagram illustrating an example of a manufacturing method of the coil component according to the seventh embodiment.

FIG. 72A is a diagram illustrating an example of a manufacturing method of the coil component according to the seventh embodiment.

FIG. 72B is a diagram illustrating an example of a manufacturing method of the coil component according to the seventh embodiment.

FIG. 73A is a diagram illustrating an example of a manufacturing method of the coil component according to the seventh embodiment.

FIG. 73B is a diagram illustrating an example of a manufacturing method of the coil component according to the seventh embodiment.

FIG. 74A is a diagram illustrating an example of a manufacturing method of the coil component according to the seventh embodiment.

FIG. 74B is a diagram illustrating an example of a manufacturing method of the coil component according to the seventh embodiment.

FIG. 75 is a diagram illustrating an example of a manufacturing method of the coil component according to the seventh embodiment.

FIG. 76A is a diagram illustrating an example of a manufacturing method of the coil component according to the seventh embodiment.

FIG. 76B is a diagram illustrating an example of a manufacturing method of the coil component according to the seventh embodiment.

FIG. 77A is a diagram illustrating an example of a manufacturing method of the coil component according to the seventh embodiment.

FIG. 77B is a diagram illustrating an example of a manufacturing method of the coil component according to the seventh embodiment.

FIG. 77C is a diagram illustrating an example of a manufacturing method of the coil component according to the seventh embodiment.

FIG. 78A is a diagram illustrating an example of the structure of a land according to the present embodiment.

FIG. 78B is a diagram illustrating an example of the structure of a land according to the present embodiment.

FIG. 79A is a schematic cross-sectional view exemplifying a mounted state of a support member.

FIG. 79B is a schematic cross-sectional view exemplifying a mounted state of a support member.

FIG. 80A is a diagram illustrating another example of the structure of a land according to the present embodiment.

FIG. 80B is a schematic cross-sectional view exemplifying a mounted state of a support member.

### DETAILED DESCRIPTION

Below, embodiments according to the present invention will be described in detail with reference to the drawings.

### (Coil Component)

### (First Embodiment)

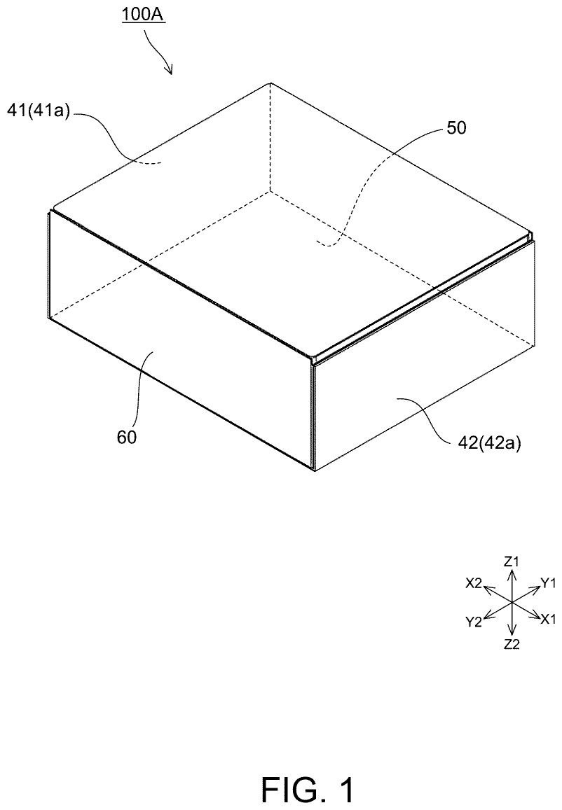

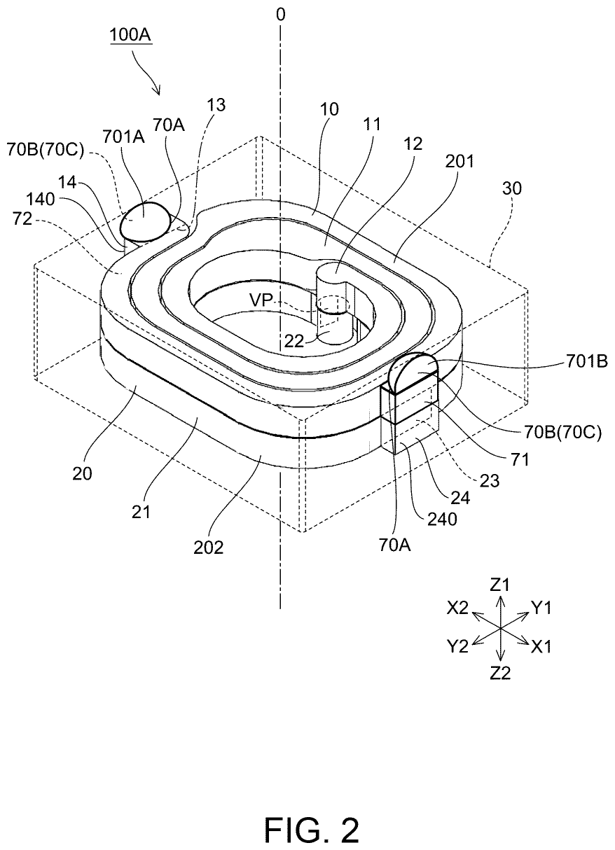

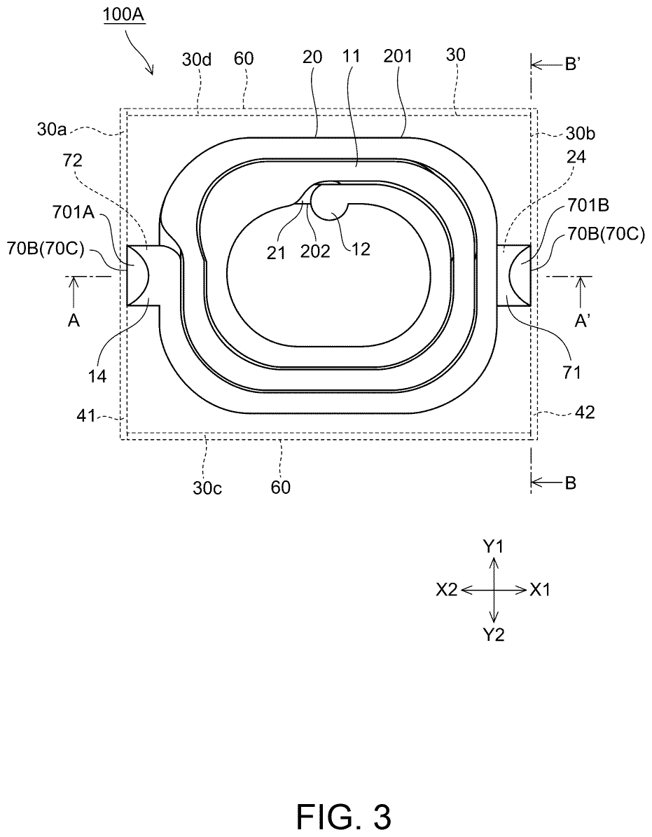

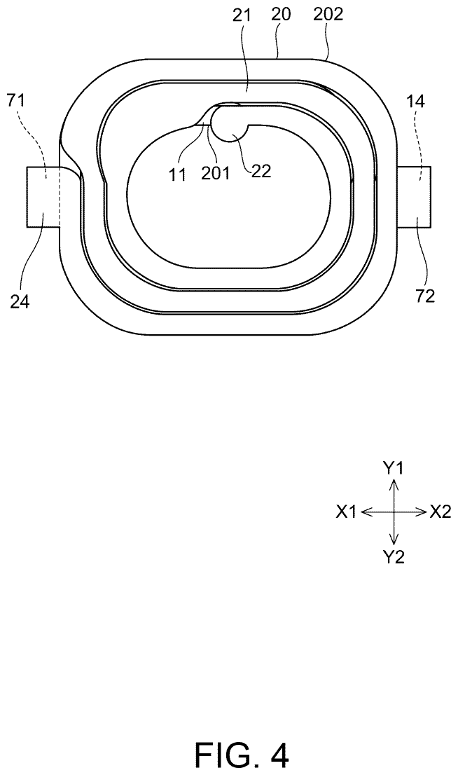

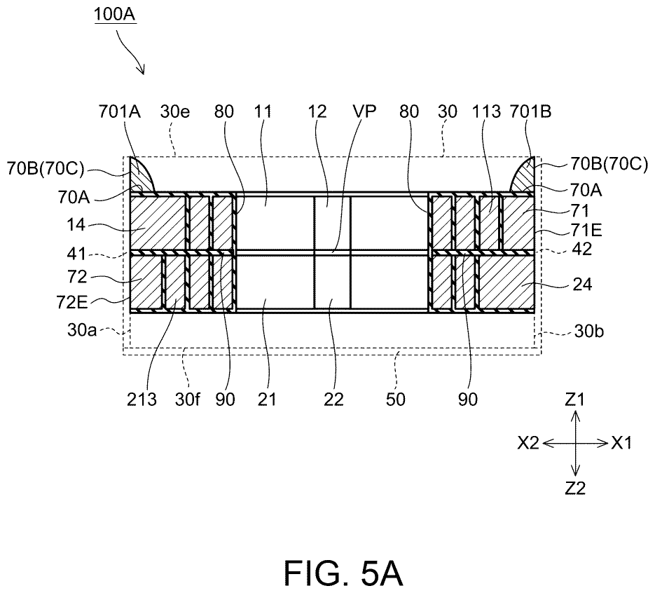

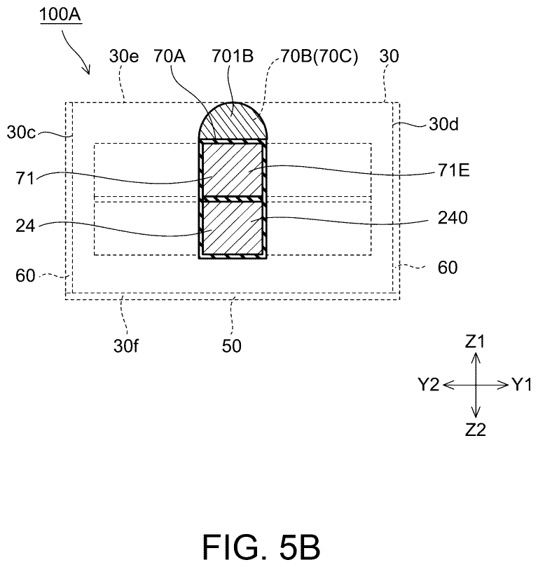

FIG. 1 is a perspective view conceptually illustrating the shape of a coil component according to a first embodiment of the present invention. FIG. 2 is a diagram illustrating the structure of a coil conductor portion provided in the coil component according to the first embodiment of the present invention. In FIG. 2, for ease of explanation, the coil conductor portion is drawn with solid lines, the main body portion is drawn with dash lines, and other components are omitted. FIG. 3 is an XY plan view illustrating the structure of a first spiral conductor portion provided in the coil component according to the first embodiment of the present invention. In FIG. 3, also for ease of explanation, the coil conductor portion is drawn with solid lines, the main body portion is drawn with dash lines, and other components are omitted. FIG. 4 is an XY plan view illustrating the structure of a second spiral conductor portion provided in the coil component according to the first embodiment of the present invention. FIG. 5A and FIG. 5B are cross-sectional views illustrating the structure of the coil member included in the coil component according to the first embodiment of the present invention. FIG. 2 is a diagram viewed from the Z1 side in the Z1-Z2 direction, and FIG. 3 is a diagram viewed from the Z1 side in the Z1-Z2 direction, wherein only the coil conductor portion is shown in the coil member, while the main body portion, terminal members, and outer cover are shown with dash lines. FIG. 4 shows only the coil conductor portion as viewed from the Z2 side in the Z1-Z2 direction. FIG. 5A shows the main body, terminal section, and outer cover indicated by dashed lines, and the cross-cross section taken along line A-A′ in FIG. 3 is shown as an XZ cross-sectional view. FIG. 5B shows the main body and outer cover indicated by dashed lines, and the cross-cross section taken along line B-B′ in FIG. 3 is shown as a YZ cross-sectional view. FIG. 4 shows only the coil conductor portion as viewed from the Z2 side in the Z1-Z2 direction. FIG. 5A shows the main body portion, terminal member, and outer cover with dash lines. The cross cross section taken along line A-A′ in FIG. 3 is depicted as an XZ cross-sectional view. FIG. 5B shows the main body portion and outer cover with dash lines. The cross cross section taken along line B-B′ in FIG. 3 is depicted as a YZ cross-sectional view.

### (Overall Configuration)

The coil component 100A according to the first embodiment of the present invention includes a coil member 10 having a coil conductor portion 20, a main body portion 30, a first terminal member 41, a second terminal member 42, outer covers 50, 60, and support members 701A, 701B.

### (Coil)

As shown in FIG. 2 and FIG. 3, the coil member 10 includes a coil conductor portion 20. The coil conductor portion 20 includes a first conductor portion 201. The first conductor portion 201 includes a first spiral conductor portion 11 having a spiral shape. The spiral shape revolves around the axis O along a first direction (Z1-Z2 direction) and extends away from the axis O, from one end part 12, which is an inner-side end of the first spiral conductor portion 11, toward the other end part 13, which is the outer-side end of the first spiral conductor portion 11. In other words, the first spiral conductor portion 11 is one of the spiral portions included in the coil conductor portion 20. In FIG. 2, viewed from the Z1 side in the Z1-Z2 direction, the first spiral conductor portion 11 is a conductor arranged in a spiral shape revolving clockwise away from the axis O from the end part 12 toward the end part 13. In this specification, the “spiral direction” in the spiral conductor portion refers to the direction extending from the inner circumferential end toward the outer circumferential end.

The conductor (conductive material) constituting the coil conductor portion 20 is not limited as long as it possesses appropriate conductivity. Specific examples of the conductor constituting the coil conductor portion 20 include copper, copper alloys, aluminum, and aluminum alloys. The coil conductor portion 20 can be manufactured using film formation techniques such as plating. The coil member 10 has an insulating coil insulator portion (not shown in FIG. 1 to FIG. 4) on the surface of the coil conductor portion 20. The coil insulator portion ensures insulation between adjacent conductors within the coil conductive section 20 (between the surfaces of mutually facing conductors). The coil insulator portion is formed of, for example, a resin material. For the coil conductor portion 20, the coil insulator portion is not provided at the ends of the two end members (first lead-out section 14, second lead-out section 24). The coil member 10 is thus allowed to be electrically connected to other components at these ends.

As shown in FIG. 2 and FIG. 4, the coil conductor portion 20 includes a second conductor portion 202 having a second spiral conductor portion 21 arranged alongside with the first spiral conductor portion 11 in the first direction. That is, in this embodiment, the coil conductor portion 20 includes a plurality of spiral portions. Specifically, the coil conductor portion 20 includes two spiral portions consisting of a first spiral conductor portion 11 and a second spiral conductor portion 21. The second spiral conductor portion 21 has a spiral shape, which revolves around the axis O along a first direction (Z1-Z2 direction) and extends away from the axis O, from one end part 22, which is an inner-side end of the second spiral conductor portion 21, toward the other end part 23, which is the outer-side end of the second spiral conductor portion 21. In other words, the first spiral conductor portion 11 is one of the spiral portions included in the coil conductor portion 20. In the second spiral conductor portion 21, viewed from the Z1 side in the Z1-Z2 direction, the second spiral conductor portion 21 is a conductor arranged in a spiral shape revolving away from the axis O in the opposite direction (counterclockwise in FIG. 2) to the first spiral conductor portion 11. The average gap distance in the first direction (Z1-Z2 direction) between the first spiral conductor portion 11 and the second spiral conductor portion 21 is not particularly limited. The smaller the gap distance, the easier it is to reduce the height of coil component 100 (dimension in the Z1-Z2 direction). However, if it is excessively small, the insulation between the first spiral conductor portion 11 and the second spiral conductor portion 21 tends to deteriorate. From the perspective of achieving both a low profile (low height) of the coil component 100 and high insulation between first spiral conductor portion 11 and second spiral conductor portion 21, it may be preferable for the gap distance to be 0.4 μm or more and 20 μm or less. The gap distance is preferably 1.0 μm or greater, and more preferably 5.0 μm or greater, in order to reduce variation in the gap distance during manufacturing and to more reliably support the coils within the same plane.

The end part 12 of the first spiral conductor portion 11 and the end part 22 of the second spiral conductor portion 21 are electrically connected via a via member VP. Starting from a connecting portion to the via member VP, the first spiral conductor portion 11 and the second spiral conductor portion 21 revolve in opposite directions. The via member VP may be formed from the same conductor as the coil conductor portion 20. In one specific example, the via member VP is made of the same material as the first coil conductor portion 11 and the second coil conductor portion 21, and is manufactured simultaneously with the first coil conductor portion 11 and the second coil conductor portion 21. In this case, the via member VP is integrated with the end part 12 of the first spiral conductor portion 11 and the end part 22 of the second spiral conductor portion 21.

The first lead-out section 14 is connected to the end part 13 of the first spiral conductor portion 11 as a part of the first conductor portion 201. The second lead-out section 24 is connected to the end part 23 of the second spiral conductor portion 21 as a part of the second conductor portion 202. Therefore, the end part 13 of the first spiral conductor portion 11 is essentially the interface with the first lead-out section 14, and the end part 23 of the second spiral conductor portion 21 is essentially the interface with the second lead-out section 24. In a specific example, the first lead-out section 14 and the second lead-out section 24 are made of the same material as the first spiral conductor portion 11 and the second spiral conductor portion 21, and are manufactured simultaneously with the first spiral conductor portion 11 and the second spiral conductor portion 21. In other words, the first conductor portion 201 is manufactured as a single piece, and the second conductor portion 202 is also manufactured as a single piece. In this case, the first lead-out section 14 is integrally formed with the other end portion 13 of the first spiral conductor portion 11 without a boundary, and the second lead-out section 24 is integrally formed with the other end portion 23 of the second spiral conductor portion 21 without a boundary.

In other words, in this embodiment, the coil conductor portion 20 includes a first conductor portion 201 having a first spiral conductor portion 11 and a first lead-out section 14, a second conductor portion 202 having a second spiral conductor portion 21 and a second lead-out section 24, and a via member VP, all of which are formed of a common conductive material.

### (Main Body Portion)

The main body portion 30 contains magnetic powder and has an outer surface with multiple faces extending in the first direction, and two intersecting faces arranged alongside in the first direction. The main body portion 30 covers at least a portion of the coil member 10 with the two intersecting faces. In this embodiment, the main body portion 30 is substantially shaped as a rectangular parallelepiped and includes a plurality of faces, which are two outer faces 30a and 30b arranged alongside in the X1-X2 direction, two outer side faces 30c and 30d arranged alongside in the Y1-Y2 direction, and two intersecting faces 30e and 30f arranged alongside in the first direction. Furthermore, the main body portion 30 is located at an end of the coil member 10, and encloses the portion other than the outermost end face (X2 side in X1-X2 direction) of the first lead-out section 14, and the outermost end face (X1 side in X1-X2 direction) of the second lead-out section 24.

The magnetic powder may be a metallic magnetic powder formed of a metal material, and in this case, its crystallographic structure is not particularly limited. The structure may include a crystalline phase or an amorphous phase. Here, a crystalline material is defined as a material formed of a crystalline phase, an amorphous material as a material formed of an amorphous phase, and a composite material as a material formed of both a crystalline phase and an amorphous phase. If the diffraction spectrum obtained by a general X-ray diffraction method includes sharp diffraction peaks that identify the type of crystalline phase, the material contains a crystalline phase. If the diffraction spectrum obtained by a general X-ray diffraction method includes broad peaks indicating an amorphous phase, the material contains an amorphous phase. If the DSC curve obtained by differential thermal analysis includes a peak indicating crystallization, that is, heat generation accompanying a phase change from an amorphous phase to a crystalline phase, the material also contains an amorphous phase.

The material system of the magnetic powder is not particularly limited. Specific examples of crystalline materials include Fe—Si—Cr alloys, Fe—Ni alloys, Fe—Co alloys, Fe—V alloys, Fe—Al alloys, Fe—Si alloys, Fe—Si—Al alloys, pure iron, and ferrite. Carbonyl iron powder is preferred as the powder of pure iron. Specific examples of amorphous materials include Fe—Si—B alloys, Fe—P—C alloys, and Co—Fe—Si—B alloys. Specific examples of composite materials include Fe—Zr alloys, Fe—Zr—B alloys, Fe—Si—B—Nb—Cu alloys, and Fe—Si—B—P—Cu alloys. When the magnetic powder is a metal powder containing Fe, the synergistic effect of improving magnetic properties is particularly significant.

The chemical composition of the magnetic powder is not particularly limited. For example, an Fe—Si—Cr alloy may contain 1.0 to 10.0 mass % of Si, 1.0 to 10.0 mass % of Cr, and the balance consisting of Fe and impurities. An Fe—Ni alloy may contain 1.0 to 99.0 mass % of Ni and the balance consisting of Fe and impurities. Furthermore, an Fe—P—C alloy may contain 1.0 to 13.0 atomic % of P, 1.0 to 13.0 atomic % of C, and the balance consisting of Fe and impurities. The Fe—P—C alloy may optionally contain one or more elements selected from the group consisting of Ni, Sn, Cr, B, and Si. In this case, for example, the amount of Ni may be 0 to 10.0 atomic %, Sn may be 0 to 3.0 atomic %, Cr may be 0 to 6.0 atomic %, B may be 0 to 9.0 atomic %, and Si may be 0 to 7.0 atomic %. The amount of Fe is preferably 65 atomic % or more. Furthermore, an Fe—Si—B—Nb—Cu alloy may contain 1.0 to 16.0 atomic % of Si, 1.0 to 15.0 atomic % of B, 0.50 to 5.0 atomic % of Nb, 0.50 to 5.0 atomic % of Cu, and the balance consisting of Fe and impurities. In this case, the amount of Fe is preferably 65 atomic % or more.

The shape of the magnetic powder is not particularly limited. The magnetic powder may be spherical, elliptical, flaky, or irregular in shape. The manufacturing method for obtaining these shapes is also not particularly limited.

The particle size distribution of the magnetic powder is not particularly limited. The particle size distribution of the magnetic powder can be obtained, for example, by analyzing an image (secondary electron image) captured by scanning electron microscopy of a cut surface of the main body portion 30. For example, the average circle-equivalent diameter of the magnetic powder may be 0.50 to 50.0 μm. The distribution of circle-equivalent diameters may include multiple peaks.

The magnetic powder may be subjected to surface insulation treatment. When the magnetic powder is subjected to surface insulation treatment, the insulation resistance of the main body portion 30 is improved. The type of surface insulation treatment applied to the magnetic powder is not particularly limited. Examples include phosphate treatment, phosphate salt treatment, and oxidation treatment. The magnetic powder may have an insulating covering on the surface of the magnetic particles. The insulating covering may contain at least one selected from the group consisting of Si, P, and B, and oxygen (O).

The magnetic powder may be a mixed material in which multiple powder materials are mixed. The magnetic powder is preferably a ferromagnetic material and more preferably a soft magnetic material.

The main body portion 30 may further contain optional sub-materials. The optional sub-materials include, for example, a binder material or a modifier. The binder material binds particles such as magnetic powder contained in the main body portion 30. The binder material is preferably an insulating material to impart insulation resistance to the main body portion 30.

The binder material may be an organic material or an inorganic material. The organic material may be a resin material. Examples of resin materials include acrylic resin, silicone resin, epoxy resin, phenolic resin, urea resin, melamine resin, and polyester resin. The inorganic material may be a glass-based material such as water glass. The binder material may be a product of a reaction such as thermal decomposition or a mixture of multiple materials.

The modifier may improve the fluidity of the powder or adjust the curing speed of the binder material. The modifier may be a glass-based material.

The dimensions of the main body portion 30 are not particularly limited. For example, the maximal dimension of the main body portion 30 may be 3.2 mm or less.

### (External Terminal)

As shown in FIG. 2, the end face (exposed lead-out surface 140) on the outermost side (X2 side in X1-X2 direction) of the first lead-out section 14, and the end face (exposed lead-out surface 240) on the outermost side (X1 side in X1-X2 direction) of the second lead-out section 24, which are located at the end parts of the coil member 10, are exposed from the main body section 30 on the side surfaces of the main body section 30 arranged alongside in the X1-X2 direction. A first terminal member 41 is provided to make electrical contact with the exposed lead-out surface 140, and a second terminal member 42 is provided to make electrical contact with the exposed lead-out surface 240.

The first terminal member 41 has a side portion 41a covering the X2-side surface of the main body portion 30 in the X1-X2 direction. The second terminal member 42 has a side portion 42a covering the X1-side surface of the main body portion 30 in the X1-X2 direction. The first terminal member 41 may also include a bottom portion arranged to cover a portion of the bottom surface (the surface on Z2 side in Z1-Z2 direction) of the main body portion 30. Furthermore, the second terminal member 42 may have a bottom portion provided on the bottom surface of the main body portion 30, spaced apart from the bottom portion of the first terminal member 41, and covering a portion of its bottom surface. The portion of the bottom surface is the portion facing the substrate during use.

The positions of the first terminal member 41 and the second terminal member 42 are not limited to the positions described above. The first terminal member 41 and the second terminal member 42 may be formed to cover a portion of the upper surface (the surface on Z1 side in Z1-Z2 direction) of the main body portion 30. Furthermore, the first terminal member 41 and the second terminal member 42 may be provided only on one portion of the bottom surface (the surface on Z2 side in Z1-Z2 direction) of the main body portion 30. In this case, the coil conductor portion 20 may have a connecting conductor portion (not shown) connecting from the two end parts of the coil member 10 (first lead-out section 14, second lead-out section 24) through the interior of the main body portion 30 to the bottom surface of the main body portion 30. In this case, the two end parts of the coil member 10 (the exposed lead-out surfaces 140, 240) are not be exposed to the side surfaces of the main body portion 30. Instead, the connecting conductor portion may be exposed to the bottom surface of the main body portion 30.

The material and composition of the first terminal member 41 and the second terminal member 42 are not limited as long as they possess appropriate conductivity. As a non-limiting example of the first terminal member 41 and the second terminal member 42, a layer having a Cu plating/Ni plating/Sn plating structure from the side proximate to the surface of the main body portion 30 may be exemplified. The first terminal member 41 and the second terminal member 42 may be formed from a coating-type electrode formed of a conductive material, such as silver, dispersed in a resin or the like. Alternatively, the first terminal member 41 and the second terminal member 42 may be formed from a combination of plating and a coating-type electrode.

### (Outer Cover)

Insulating outer covers 50 and 60 are provided as an insulating layer on the intersecting surface 30f of the main body 30 on the Z2 side in the Z1-Z2 direction and on the side surfaces arranged alongside in the Y1-Y2 direction, respectively. The outer cover 50, 60 may be provided on the mounting surface of the coil component 100A (the surface on the side of the intersecting surface 30e located on Z1 side in Z1-Z2 direction of the main body 30). For example, if bottom portions are provided for the first terminal member 41 and the second terminal member 42, respectively, to extend on a portion of the main body portion 30 on the side of the intersecting surface 30e, the insulating outer cover may be provided on the portion of the intersecting surface 30e of the main body portion 30, where the bottom portions are not provided. The outer cover 50, 60 may include a layer formed of resin having an average thickness of 0.10 μm to 10.0 μm. This makes it easier to maintain the magnetic properties of the coil component 100A, enhance the surface insulation of the coil component 100A to improve its reliability, and improve the appearance of the coil component 100A. The coil component 100A may also be provided without the outer cover 50, 60. The outer cover 50, 60 can be formed at any position on the surface of the main body 30 as needed for the intended purpose.

### (Dummy Conductor Portion)

The coil component 100A according to this embodiment includes a first dummy conductor portion 72 and a second dummy conductor portion 71, both of non-spiral shape. As shown in FIG. 5A and FIG. 5B, the first dummy conductor portion 72 faces the first lead-out section 14 in the first direction (Z1-Z2 direction) across the first insulator portion 90 and has a portion contacting the first insulating portion 90. Furthermore, the first dummy conductive member 72 is spaced apart from the second conductor portion 202 (specifically, the second outer-side turn 213) in a direction intersecting the first direction (specifically, X1-X2 direction).

With the presence of the first dummy conductor portion 72, a member composed of a conductor is positioned in the first direction of the first lead-out section 14, similar to the first spiral conductor portion 11. Consequently, when applying an external force along the first direction to arrange magnetic powder around the coil member 10, pressure variations are less likely to occur, and therefore deformation of the coil member 10 is less likely to occur.

Furthermore, in this example, since no conductive substance exists between the first dummy conductor portion 72 and the first lead-out section 14, when considering the coil member 10 alone, the first dummy conductor portion 72 and the first lead-out section 14 are electrically insulated from each other. Therefore, the first dummy conductor portion 72 is in an electrically insulated state from both the first conductor portion 201 and the second conductor portion 202.

In FIG. 5A, the end part (dummy end surface portion 72E) of the first dummy conductor portion 72 on the outer side (X2 side in X1-X2 direction) is exposed, but it is not limited thereto. For example, a second insulator portion 80 may be provided to contact the dummy end surface portion 72E.

The configuration of the second dummy conductor portion 71 is the same as that of the first dummy conductor portion 72. In other words, the second dummy conductor portion 71 faces the second lead-out section 24 in the first direction (Z1-Z2 direction) across the first insulator portion 90 and has a portion contacting the first insulator portion 90, and is separated from the first conductor portion 201 (specifically, the first outer-side turn 113) in a direction intersecting the first direction (specifically, X1-X2 direction). By being arranged in this manner, the second dummy conductor portion 71 is also electrically insulated from both the first conductor portion 201 and the second conductor portion 202. The first dummy conductor portion 72 and the first conductor portion 201 are electrically connected to each other via the first terminal member 41, so they do not necessarily need to be insulated. Similarly, the second dummy conductor portion 71 and the second conductor portion 202 need not necessarily be insulated from each other since they are electrically connected by the second terminal member 42. Therefore, the first dummy conductor portion 72 and the first conductor portion 201 may either be in direct contact or electrically connected through the conductor in the via. Similarly, the second dummy conductor portion 71 and the second conductor portion 202 may be in direct contact or may be electrically connected through the conductor in the via. The electrical connection widens the current path of the coil member and is effective on reduction of DCR.

### (First Insulation Section)

As shown in the cross-sectional view of FIG. 5A, the coil insulator portion includes a first insulator portion 90 in contact with at least a portion of one end part of the first spiral conductive section 11 on a side of the first direction, specifically the end part facing the second spiral conductor section 21 (Z2 side in Z1-Z2 direction). The first insulating portion 90, as shown in the cross-sectional view of FIG. 5, is located on the side (Z2 side in Z1-Z2 direction) opposite to the side (Z1 side in Z1-Z2 direction) in contact with the first spiral conductor portion 11, and is in contact with at least a portion of one end part of the second spiral conductor portion 21 on the first-direction side, specifically the end part on the side (Z1 side in Z1-Z2 direction) facing the first spiral conductor portion 11. In other words, the first insulator portion 90 is interposed between the first spiral conductor portion 11 and the second spiral conductor portion 21, which are arranged alongside in the first direction, and contacts both. Thus, with the contact between the first insulator portion 90 and the first spiral conductor portion 11, reliable insulation of the first spiral conductor portion 11 is achieved. Furthermore, as shown in the cross-sectional view of FIG. 5B, the first insulator portion 90 contacts both the first spiral conductor portion 11 and the second spiral conductor portion 21, thereby stably preventing short-circuiting between the first spiral conductor portion 11 and the second spiral conductor portion 21.

The material constituting the first insulator portion 90 is not particularly limited as long as it has suitable insulating properties. Preferably, the first insulator portion 90 has a volume resistivity of 1.0×10¹⁴ Ω·cm or more as measured by ASTM D257. More preferably, the volume resistivity is 1.0×10¹⁵ Ω·cm or more, and even more preferably 1.0×10¹⁶ Ω·cm or more. The upper limit of the volume resistivity is not particularly limited and may be 1.0×10²⁰ Ω·cm or less. The first insulator portion 90 preferably has excellent dielectric properties, specifically a relative permittivity at 60 Hz of 4.0 or less as measured by ASTM D150. More preferably, the relative permittivity is 3.5 or less, and even more preferably 3.0 or less. The lower limit of the relative permittivity is not particularly limited and may be 1.0 or more. The methods for measuring volume resistivity and relative permittivity are not limited. For example, a test sample prepared from a material equivalent to the first insulator portion 90 may be analyzed using component analysis or FT-IR to identify the material and evaluate its properties such as volume resistivity.

The material constituting the first insulator portion 90 may be an organic material, an inorganic material, or a composite material of organic and inorganic materials. When the first insulator portion 90 is formed of a composite material, the inorganic material may have a particulate shape and be dispersed in a matrix formed of the organic material. Examples of organic materials include polyimide resin, polyethylene resin, polypropylene resin, polyamide resin, polyester resin, polyamide-imide resin, polysulfone resin, polycarbonate resin, liquid crystal polymer resin, polyvinylidene fluoride resin, and polytetrafluoroethylene resin. Examples of inorganic materials, particularly in composite materials, include oxides, carbides, nitrides, and inorganic salts. For example, oxides include silica, alumina, and zirconia; carbides and nitrides include silicon carbide and boron nitride; and inorganic salts include minerals such as wollastonite, kaolin, and mica. Among these, oxide-based materials such as oxides, silicates, and phosphates are preferred in terms of cost and insulation. Preferably, the inorganic material contains at least one selected from the group consisting of silicon (Si), phosphorus (P), boron (B), and calcium (Ca).

### (Second Insulator Portion)

The coil insulator portion includes a second insulator portion 80. As shown in FIG. 5A, the second insulator portion 80 is provided on at least a portion of the surface of the first spiral conductor portion 11 and the surface of the second spiral conductor portion 21.

In this embodiment, the material constituting the second insulator portion 80 is not limited as long as it possesses appropriate insulating properties. For example, the second insulator portion 80 is thermoplastic and includes a thermoplastic resin containing a parylene-based polymer. Other examples of thermoplastic resins include polyethylene, polypropylene, polyamide, polyester, polyamide-imide, polyimide, polysulfone, polycarbonate, liquid crystal polymer, polyvinylidene fluoride, and polytetrafluoroethylene. It may be preferable that the entire second insulator portion 80 is thermoplastic, and for example, contain inorganic insulating particles in addition to the above thermoplastic resin. Furthermore, the second insulator portion 80 may be made of the same material as that of the first insulator portion 90.

The second insulator portion 80 preferably has excellent insulating properties, specifically a volume resistivity of 1.0×10¹⁴ Ω·cm or more as measured by ASTM D257. More preferably, the volume resistivity is 1.0×10¹⁵ Ω·cm or more, and even more preferably 1.0×10¹⁶ Ω·cm or more. The upper limit of the volume resistivity is not particularly limited and may be 1.0×10²⁰ Ω·cm or less. The second insulator portion 80 preferably has excellent dielectric properties, specifically a relative permittivity at 60 Hz of 4.0 or less as measured by ASTM D150. More preferably, the relative permittivity is 3.5 or less, and even more preferably 3.0 or less. The lower limit of the relative permittivity is not particularly limited and may be 1.0 or more. Measurement of volume resistivity and relative permittivity uses a material equivalent to the second insulator portion 80 prepared to the required dimensions, similar to the method for the first insulator portion 90. The material corresponding to the second insulator portion 80 can be identified, as in the case of the first insulator portion 90, through analytical methods such as component analysis or FT-IR.

### (Support Member)

Pillar members made of, for example, solder balls, heteronuclear solder balls (copper-core solder balls, resin-core solder balls, etc.), or conductive materials (such as copper) may be used as support members 701A and 701B. The support members 701A and 701B form a first interface 70A that contacts the coil member 10 and intersects the first direction (Z1-Z2 direction). In this example, the support members 701A and 701B are positioned on the Z1 side of the Z1-Z2 direction of coil member 10. In other words, the support member 701A is positioned on the Z1 side of the Z1-Z2 direction of first lead-out section 14, and the support member 701B is positioned on the Z1 side of the Z1-Z2 direction of first dummy conductor portion 72. In other words, the support members 701A and 701B are provided at the central portion in the Y1-Y2 direction in respective end parts of the main body portion 30 in the X1-X2 direction.

When viewed in the first direction (Z1-Z2 direction), the support member 701A overlaps with the first lead-out section 14 of the coil member 10 and the first dummy conductor portion 72, while the support member 701B overlaps with the second lead-out section 24 of the coil member 10 and the first dummy conductor portion 72.

The support member 701A, 701B has an exposed support surface 70B exposed from the main body portion 30. The exposed support surface 70B includes a first exposed surface 70C having an in-plane direction along the first direction. The first exposed surface 70C is exposed from two outer surfaces 30a and 30b parallel to the YZ plane of the main body portion 30.

When the support member 701A, 701B includes a support conductor portion, which is conductive, at least a portion of the first interface 70A may be a contact interface between the conductive surface of the support conductor portion and the conductive surface of the coil conductor portion 20. Furthermore, when the support member 701A, 701B includes a support conductor portion, which is conductive, at least a portion of the first exposed surface 70C of the exposed support surface 70B may also be formed from an exposed conductive surface, which is formed from the support conductor portion.

The first terminal member 41 is provided on the outer surface 30a, and the second terminal member 42 is provided on the outer surface 30b. By bonding each of the first terminal member 41 and the second terminal member 42 to the first exposed surface 70C, the bonding strength and electrical conductivity between the coil conductive portion 20 and the first terminal member 41 and second terminal member 42 are enhanced. Accordingly, the connection area with a conductive material (external terminal or solder) of the coil component 100A is increased.

Furthermore, the first dummy conductor portion 72 has a dummy end surface portion 72E exposed from the outer surface of the main body portion 30. Additionally, the first lead-out section 14 and the second lead-out section 24 have end surfaces (exposed lead-out surfaces 140, 240) exposed from the outer surface of the main body portion 30. The first terminal member 41 is joined to the dummy end surface portion 72E and the exposed lead-out surface 140, while the second terminal member 42 is joined to the dummy end surface portion 71E and the exposed lead-out surface 240. Furthermore, when at least a portion of the first interface 70A is formed from the contact interface between the conductive surfaces of the first lead-out section 14 and the second lead-out section 24 and the conductive surface of the support conductor portion, the bonding strength and electrical conductivity between the coil conductor portion 20 and the first terminal member 41 and second terminal member 42 are enhanced, while also enabling an increase in the connection area with a conductive material (external terminal or solder) of the coil component 100A.

### (Second Embodiment)

Next, the coil component according to the second embodiment of the present invention will be described. In the following description, details common to the coil component according to the first embodiment will be omitted.

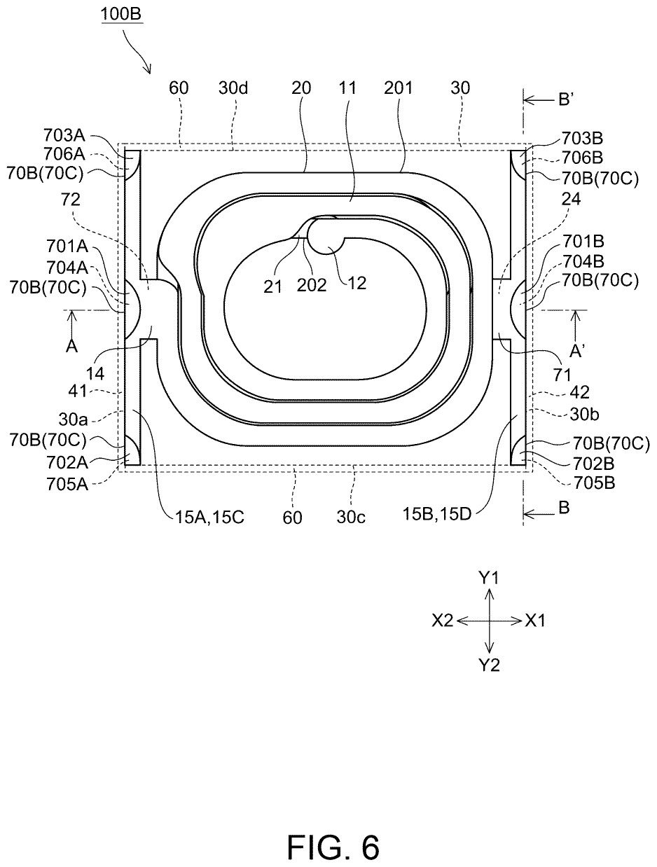

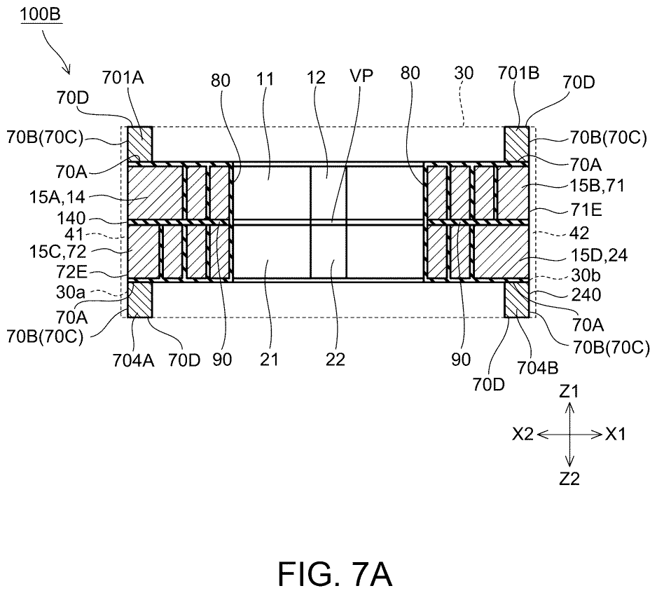

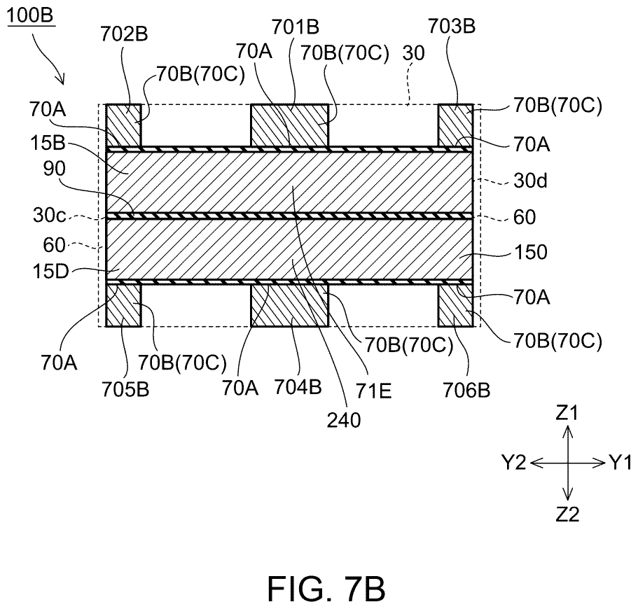

FIG. 6 is an XY plane view illustrating the structure of the first spiral conductor portion included in the coil component according to the second embodiment of the present invention. In FIG. 6, for ease of explanation, the coil conductor portion is drawn with solid lines, the main body portion is drawn with dashed lines, and other components are omitted. FIG. 7A and FIG. 7B are cross-sectional views illustrating the structure of the coil member included in the coil component according to the second embodiment of the present invention. FIG. 7A shows the cross section taken along line A-A′ in FIG. 6 as an XZ cross-sectional view, and FIG. 7B shows the cross section taken along line B-B′ in FIG. 6 as a YZ cross-sectional view.

### (First Connecting Portion)

In the coil component 100B according to the second embodiment, a first connecting portion 15A, 15B, 15C, 15D is provided on each of the two outer surfaces 30a and 30b of the main body portion 30, which are parallel to the YZ plane. The first connecting portion 15A is connected to the first lead-out section 14 and configured to extend in the Y1-Y2 direction on the Z1 side of the first insulator portion 90 in the Z1-Z2 direction. The first connecting portion 15A is provided so as to span two outer surfaces 30c and 30d of the main body portion 30, which are parallel to the XZ plane. In a specific example, the first connecting portion 15A is made of the same material as the first spiral conductor portion 11 and the first lead-out section 14 and is manufactured simultaneously with the first spiral conductor portion 11 and the first lead-out section 14.

The first connecting portion 15A connected to the first lead-out section 14 is included within the coil conductor portion 20. When the first connector portion 15A is integrally formed with the first lead-out section 14, the first connecting portion 15A may constitute a part of the first lead-out section 14. In this case, the surface of the first connecting portion 15A exposed from the main body portion 30 serves as the exposed lead-out surface 140.

The first connecting portion 15B is connected to the second dummy conductor portion 71 and is configured to extend in the Y1-Y2 direction on the Z1 side of the first insulator portion 90 in the Z1-Z2 direction. The first connecting portion 15B is provided so as to span two outer surfaces 30c and 30d of the main body portion 30, which are parallel to the XZ plane. In a specific example, the first connecting portion 15B is made of the same material as the first spiral conductor portion 11 and the first dummy conductor portion 72 and is manufactured simultaneously with the first spiral conductor portion 11 and the first dummy conductor portion 72. When the first connecting portion 15B is integrally provided with the first dummy conductor portion 72, the first connecting portion 15B may constitute a part of the first dummy conductor portion 72. In this case, a surface of the first connecting portion 15B exposed from the outer surface 30b of the main body portion 30 serves as a dummy end-face portion 71E.

The first connecting portion 15C is connected to the first dummy conductor portion 72 and is configured to extend in the Y1-Y2 direction on the Z2 side of the first insulator portion 90 in the Z1-Z2 direction. The first connecting portion 15C is provided so as to span two outer surfaces 30c and 30d of the main body portion 30, which are parallel to the XZ plane. In a specific example, the first connecting portion 15C is made of the same material as the second spiral conductor portion 21 and the first dummy conductor portion 72 and is manufactured simultaneously with the second spiral conductor portion 21 and the first dummy conductor portion 72. When the first connecting portion 15C is integrally provided with the first dummy conductor portion 72, the first connecting portion 15C may constitute a part of the first dummy conductor portion 72. In this case, a surface of the first connecting portion 15C exposed from the outer surface 30a of the main body portion 30 serves as a dummy end-face portion 72E.

The first connecting portion 15D is connected to the second lead-out section 24 and is configured to extend in the Y1-Y2 direction on the Z2 side of the first insulator portion 90 in the Z1-Z2 direction. The first connecting portion 15D is provided so as to span two outer surfaces 30c and 30d of the main body portion 30, which are parallel to the XZ plane. In a specific example, the first connecting portion 15D is made of the same material as the second spiral conductor portion 21 and the second lead-out section 24 and is manufactured simultaneously with the second spiral conductor portion 21 and the second lead-out section 24. The first connecting portion 15D connected to the second lead-out section 24 is included in the coil conductor portion 20. When the first connecting portion 15D is integrally provided with the second lead-out section 24, the first connecting portion 15D may constitute a part of the second lead-out section 24. In this case, a surface of the first connecting portion 15D exposed from the main body portion 30 serves as a exposed lead-out surface 240.

### (Support Member)

Similar to the support members 701A and 701B, pillar members made of, for example, solder balls, heteronuclear solder balls (copper-core solder balls, resin-core solder balls, etc.), or conductive materials (such as copper) may be used as support members 704A and 704B. The support members 704A and 704B form a first interface 70A that contacts the coil member 10 and intersects the first direction (Z1-Z2 direction). In this example, the support members 704A and 704B are positioned on the Z2 side of the Z1-Z2 direction of the coil member 10. Specifically, the support member 704A is positioned on the Z2 side of the Z1-Z2 direction of the first dummy conductor portion 72, and the support member 704B is positioned on the Z2 side of the Z1-Z2 direction of the second lead-out section 24. In other words, the support members 704A and 704B are provided at the central portion in the Y1-Y2 direction in respective end parts of the main body portion 30 in the X1-X2 direction.

When viewed in the first direction (Z1-Z2 direction), the support member 704A overlaps with the first lead-out section 14 of the coil member 10 and the first dummy conductor portion 72, while the support member 704B overlaps with the second lead-out section 24 of the coil member 10 and the first dummy conductor portion 72.

The support members 704A and 704B have an exposed support surface 70B exposed from the main body portion 30. The exposed support surface 70B includes a first exposed surface 70C having an in-plane direction along the first direction. The first exposed surface 70C is exposed from two outer surfaces 30a and 30b parallel to the YZ plane of the main body portion 30.

When the support members 704A and 704B include a support conductor portion, which is conductive, at least a portion of the first interface 70A may be a contact interface between the conductive surface of the support conductor portion and the conductive surface of the coil conductor portion 20. Furthermore, when the support members 704A and 704B include a support conductor portion, which is conductive, at least a portion of the first exposed surface 70C of the exposed support surface 70B may also be formed from an exposed conductive surface, which is formed from the support conductor portion.

The first terminal member 41 is provided on the outer surface 30a, and the second terminal member 42 is provided on the outer surface 30b. By bonding each of the first terminal member 41 and the second terminal member 42 to the first exposed surface 70C, the bonding strength and electrical conductivity between the coil conductive portion 20 and the first terminal member 41 and second terminal member 42 are enhanced. Accordingly, the connection area with a conductive material (external terminal or solder) of the coil component 100B is increased.

Similar to the support members 701A, 701B, 704A and 704B, pillar members made of, for example, solder balls, heteronuclear solder balls (copper-core solder balls, resin-core solder balls, etc.), or conductive materials (such as copper) may be used as support members 702A, 702B, 703A, 703B, 705A, 705B, 706A, and 706B. The support members 702A, 702B, 703A, 703B, 705A, 705B, 706A, and 706B contacts the coil member 10 and form a first interface 70A that intersects the first direction (Z1-Z2 direction). In this example, the support members 702A, 702B, 703A, and 703B are positioned on the Z1 side of the Z1-Z2 direction of the coil member 10. Specifically, the support members 702A and 703A are positioned on the Z1 side of the Z1-Z2 direction of the first connecting portion 15A, and the support members 702B and 703B are positioned on the Z1 side of the Z1-Z2 direction of the first connecting portion 15B. Each of the support members 702A, 702B, 703A, and 703B is provided at a corner portion of the main body portion 30.

The support members 705A, 705B, 706A, and 706B are positioned on the Z2 side of the Z1-Z2 direction of the coil member 10. Specifically, the support members 705A and 706A are positioned on the Z2 side of the Z1-Z2 direction of the first connecting portion 15C, and the support members 705B and 706B are positioned on the Z2 side of the Z1-Z2 direction of the first connecting portion 15D. Each of the support members 705A, 705B, 706A, and 706B is provided at a corner portion of the main body portion 30.

The support members 702A, 702B, 703A, 703B, 705A, 705B, 706A, and 706B have an exposed support surface 70B exposed from the main body portion 30. The exposed support surface 70B includes a first exposed surface 70C having an in-plane direction along the first direction. Specifically, the first exposed surface 70C of the support members 702A and 705A positioned at the corner portion between the outer surfaces 30a and 30c is exposed from the outer surfaces 30a and 30c. The first exposed surface 70C of the support members 703A and 706A positioned at the corner portion between the outer surfaces 30a and 30d is exposed from the outer surfaces 30a and 30d. The first exposed surface 70C of the support members 702B and 705B positioned at the corner portion between the outer surfaces 30b and 30c is exposed from the outer surfaces 30b and 30c. The first exposed surface 70C of the support members 703B and 706B positioned at the corner portion between the outer surfaces 30b and 30d is exposed from the outer surfaces 30b and 30d.

The exposed support surface 70B may further include a second exposed surface 70D intersecting the first direction. At least a portion of the second exposed surface 70D may be formed from an exposed conductive surface. Specifically, the second exposed surface 70D of the support members 703A, 703B, 704A, and 704B is exposed from the outer surface on the Z1 side of the Z1-Z2 direction of the main body portion 30, and the second exposed surface 70D of the support members 705A, 705B, 706A, and 706B is exposed from the outer surface on the Z2 side of the Z1-Z2 direction of the main body portion 30. Accordingly, the exposed conductive surface constitutes a part of the outermost surface of the coil component 100B. For imparting insulation to the outermost surface of the coil component 100B, the outer cover 50, 60 may be extended toward the second exposed surface 70D and brought into contact with the second exposed surface 70D. Furthermore, for improving the peeling strength of the first terminal member 41 and the second terminal member 42, the first terminal member 41 and the second terminal member 42 may extend toward the second exposed surface 70D and brought into contact with the second exposed surface 70D.

When the support members 702A, 702B, 703A, 703B, 705A, 705B, 706A, and 706B include a support conductor portion, which is conductive, at least a portion of the first interface 70A may be a contact interface between the conductive surface of the support conductor portion and the conductive surface of the coil conductor portion 20. Furthermore, when the support members 702A, 702B, 703A, 703B, 705A, 705B, 706A, and 706B include a support conductor portion, which is conductive, at least a portion of the first exposed surface 70C of the exposed support surface 70B may also be formed from an exposed conductive surface, which is formed from the support conductor portion.

The first terminal member 41 is provided on the outer surface 30a, and the second terminal member 42 is provided on the outer surface 30b. The first terminal member 41 is bonded to the exposed lead-out surface 140, the exposed connecting surface 150, and the first exposed surface 70C exposed from the outer surface 30a, while the second terminal member 42 is bonded to the exposed lead-out surface 240, the exposed connecting surface 150, and the first exposed surface 70C exposed from the outer surface 30b. By bonding these surfaces, the bonding strength and electrical conductivity between the coil conductor portion 20 and the first terminal member 41 and second terminal member 42 are enhanced, while also enabling an increase in the connection area with a conductive material (external terminal or solder) of the coil component 100B.

### (Third Embodiment)

Next, a coil component according to the third embodiment of the present invention will be described. In the following description, portions common to the coil component according to the first embodiment will be omitted.

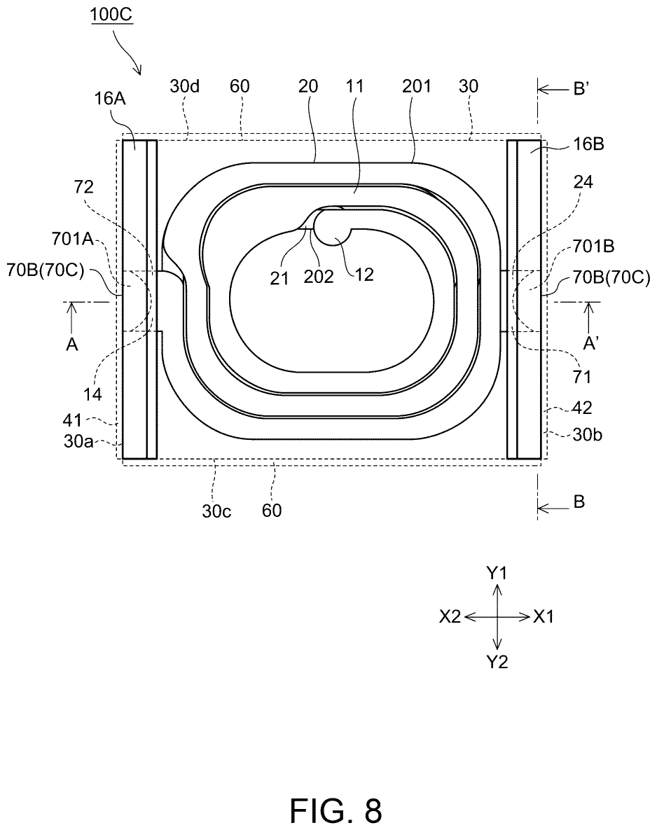

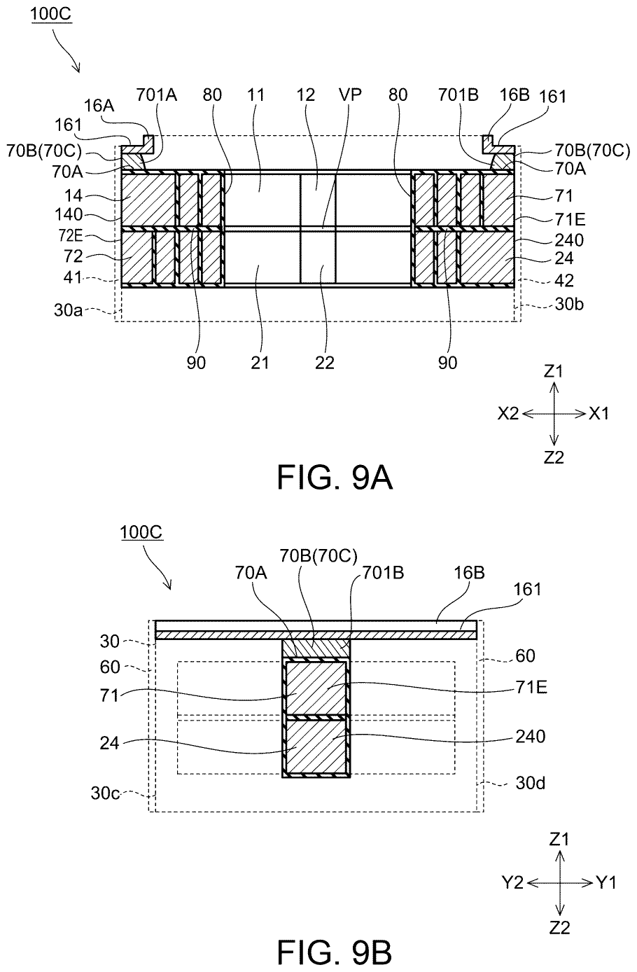

FIG. 8 is an XY plan view illustrating the structure of the first spiral conductor portion included in the coil component according to the third embodiment of the present invention. In FIG. 8, for ease of explanation, the coil conductor portion is shown by solid lines, the main body portion is shown by broken lines, and other components are omitted. FIG. 9A and FIG. 9B are cross-sectional views illustrating the structure of the coil member included in the coil component according to the third embodiment of the present invention. FIG. 9A shows an XZ cross-sectional view taken along line A-A′ in FIG. 8, and FIG. 9B shows a YZ cross-sectional view taken along line B-B′ in FIG. 8.

### (External Electrode)

External electrodes 16A and 16B are provided so as to extend in the Y1-Y2 direction on the Z1 side in the Z1-Z2 direction of the main body portion 30. The external electrode 16A is in contact with an exposed conductive surface of the exposed support surface 70B of the support member 701A, and the external electrode 16B is in contact with an exposed conductive surface of the exposed support surface 70B of the support member 701B. The exposed conductive surface constitutes a part of the outermost surface of the main body portion 30.

In this example, the external electrodes 16A and 16B are provided so as to span two outer surfaces 30c and 30d of the main body portion 30, which are parallel to the XZ plane. The external electrodes 16A and 16B may include a first recess part 161 recessed toward the first direction (Z2 side in Z1-Z2 direction). This configuration allows the recessed surface of the first recess part 161 to reduce the occupied volume (height) of the coil component 100C after soldering.

The first terminal member 41 may be provided on the outer surface 30a, and the second terminal member 42 may be provided on the outer surface 30b. The first terminal member 41 is bonded to the exposed lead-out surface 140 exposed from the outer surface 30a, the dummy end-face portion 72E, the first exposed surface 70C, and the external electrode 16A. The second terminal member 42 is bonded to the exposed lead-out surface 240 exposed from the outer surface 30b, the dummy end-face portion 71E, the first exposed surface 70C, and the external electrode 16B. By bonding these surfaces, the bonding strength and electrical conductivity between the coil conductor portion 20 and the first terminal member 41 and second terminal member 42 are enhanced, while also enabling an increase in the connection area with a conductive material (external terminal or solder) of the coil component 100C. Here, for further reducing the mounting area of the coil component 100C, the first terminal member 41 and the second terminal member 42 may be omitted. In this case, from the perspective of improving the surface insulation and reliability of the coil component 100C, the outer cover 60 may be brought into contact with the outer surfaces 30a and 30b. This point is similarly applicable to other embodiments including the external electrodes 16A and 16B described below.

### (Fourth Embodiment)

Next, a coil component according to the fourth embodiment of the present invention will be described. In the following description, portions common to the coil component according to the first embodiment will be omitted.

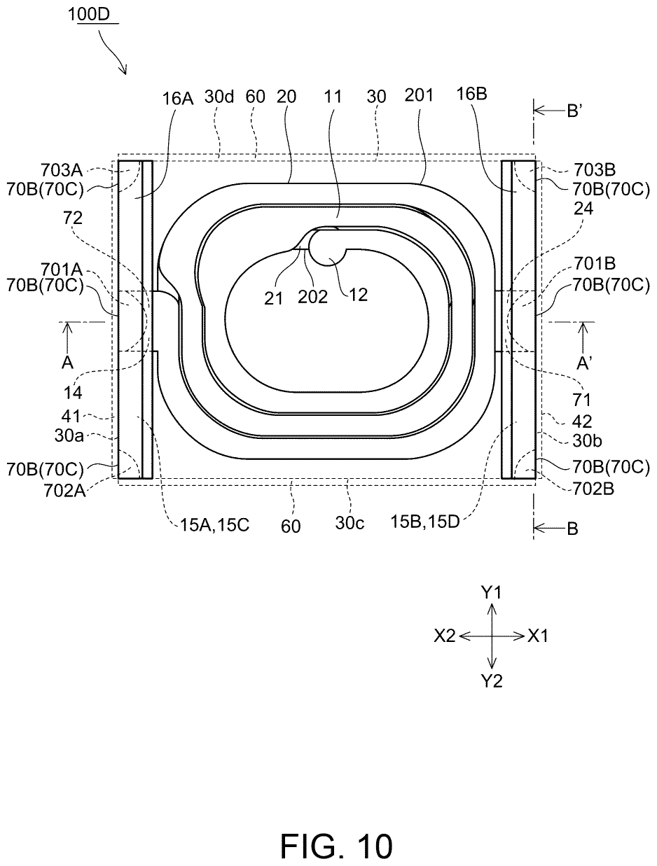

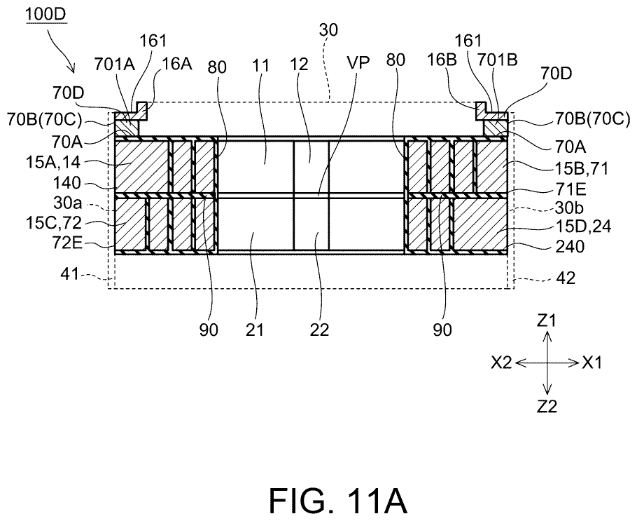

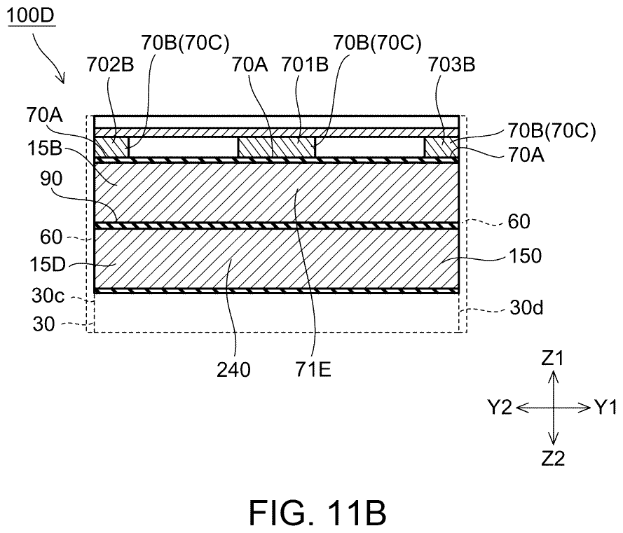

FIG. 10 is an XY plan view illustrating the structure of the first spiral conductor portion included in the coil component according to the fourth embodiment of the present invention. In FIG. 10, for convenience of explanation, the coil conductor portion is shown by solid lines, the main body portion is shown by broken lines, and other components are omitted. FIG. 11A and FIG. 11B are cross-sectional views illustrating the structure of the coil member included in the coil component according to the fourth embodiment of the present invention. FIG. 11A shows an XZ cross-sectional view taken along line A-A′ in FIG. 10, and FIG. 11B shows a YZ cross-sectional view taken along line B-B′ in FIG. 10.

### (Support Member)

In the coil component 100D according to the fourth embodiment, the support members 701A, 701B, 702A, 702B, and 703A, 703B are similar to the support members 701A, 701B, 702A, 702B, and 703A, 703B of the coil component 100B according to the second embodiment.

### (External Electrode)

In the coil component 100D according to the fourth embodiment, the external electrodes 16A and 16B are similar to the external electrodes 16A and 16B of the coil component 100C according to the third embodiment. That is, the external electrodes 16A and 16B are provided so as to extend in the Y1 -Y2 direction on the Z1 side in the Z1-Z2 direction of the main body portion 30.

The external electrode 16A is in contact with an exposed conductive surface of the exposed support surface 70B of the support member 701A, 702A, 703A, and the external electrode 16B is in contact with an exposed conductive surface of the exposed support surface 70B of the support member 701B, 702B, 703B.

In this example, the external electrodes 16A and 16B are provided so as to span two outer surfaces 30c and 30d of the main body portion 30, which are parallel to the XZ plane. The external electrodes 16A and 16B may include a first recess part 161 recessed toward the first direction (Z1-Z2 direction, Z2 side).

The first terminal member 41 may be provided on the outer surface 30a, and the second terminal member 42 may be provided on the outer surface 30b. The first terminal member 41 is bonded to the exposed lead-out surface 140 exposed from the outer surface 30a, the connecting portion exposed surface 150, the first exposed surface 70C, and the external electrode 16A. The second terminal member 42 is bonded to the exposed lead-out surface 240 exposed from the outer surface 30b, the connecting portion exposed surface 150, the first exposed surface 70C, and the external electrode 16B. By bonding these surfaces, the bonding strength and electrical conductivity between the coil conductor portion 20 and the first terminal member 41 and second terminal member 42 are enhanced, while also enabling an increase in the connection area with a conductive material (external terminal or solder) of the coil component 100D.

### (Fifth Embodiment)

Next, a coil component according to the fifth embodiment of the present invention will be described. In the following description, portions common to the coil component according to the first embodiment will be omitted.

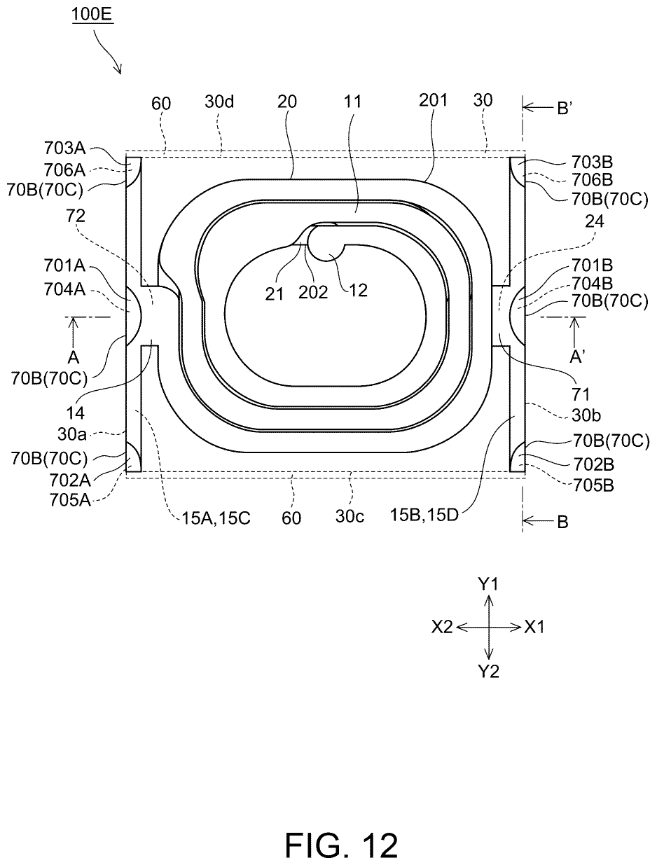

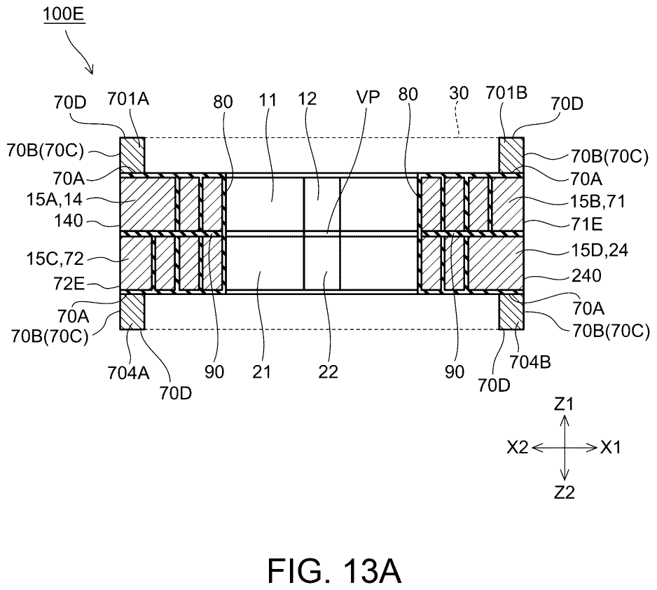

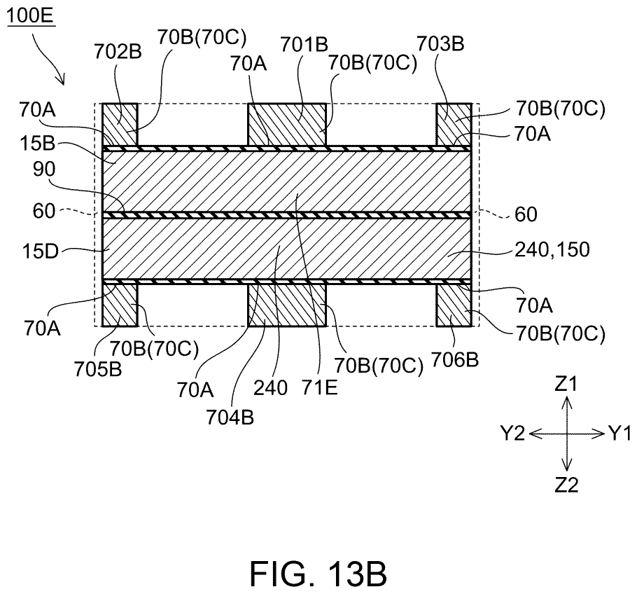

FIG. 12 is an XY plan view illustrating the structure of the first spiral conductor portion included in the coil component according to the fifth embodiment of the present invention. In FIG. 12, for convenience of explanation, the coil conductor portion is shown by solid lines, the main body portion is shown by broken lines, and other components are omitted. FIG. 13A and FIG. 13B are cross-sectional views illustrating the structure of the coil member included in the coil component according to the fifth embodiment of the present invention. FIG. 13A shows an XZ cross-sectional view taken along line A-A′ in FIG. 12, and FIG. 13B shows a YZ cross-sectional view taken along line B-B′ in FIG. 12.

In the coil component 100E according to the fifth embodiment, the first terminal member 41 and the second terminal member 42 provided in the coil component 100B according to the second embodiment are not included. That is, the exposed lead-out surface 140, the connecting portion exposed surface 150, and the first exposed surface 70C exposed from the outer surface 30a of the main body portion 30 are used as connection surfaces (electrode surfaces for mounting) for a conductive material (external terminal or solder), and the exposed lead-out surface 240, the connecting portion exposed surface 150, and the first exposed surface 70C exposed from the outer surface 30b of the main body portion 30 are used as connection surfaces (electrode surfaces for mounting) for a conductive material (external terminal or solder). Accordingly, it is not necessary to provide the first terminal member 41 and the second terminal member 42, thereby enabling downsizing of the coil component 100E, reduction of manufacturing steps, and cost reduction.

### (Sixth Embodiment)

Next, a coil component according to the sixth embodiment of the present invention will be described. In the following description, portions common to the coil component according to the first embodiment will be omitted.

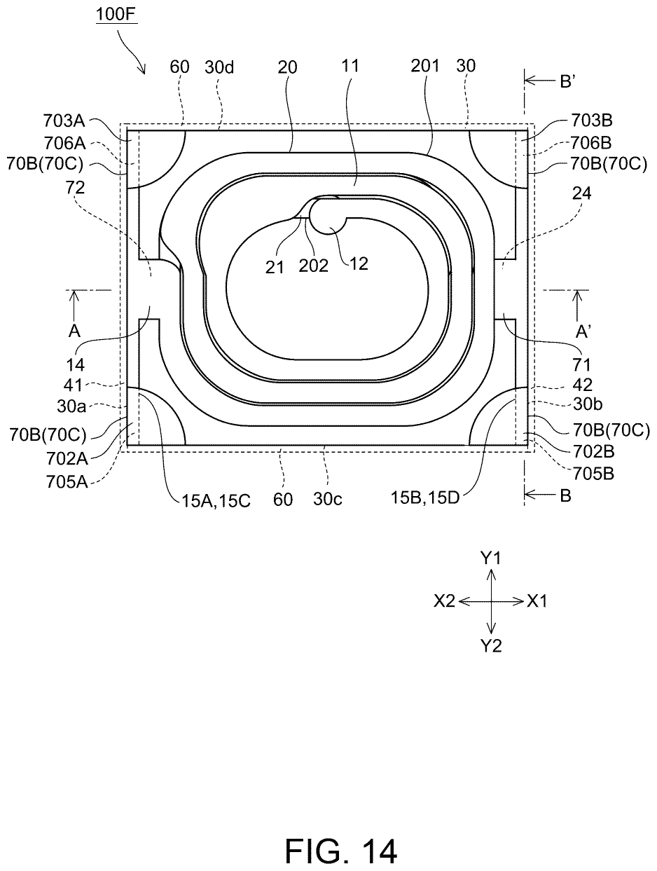

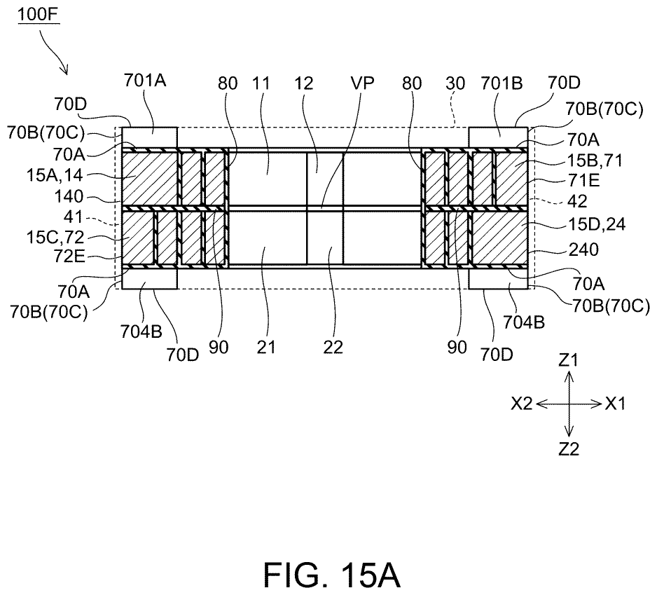

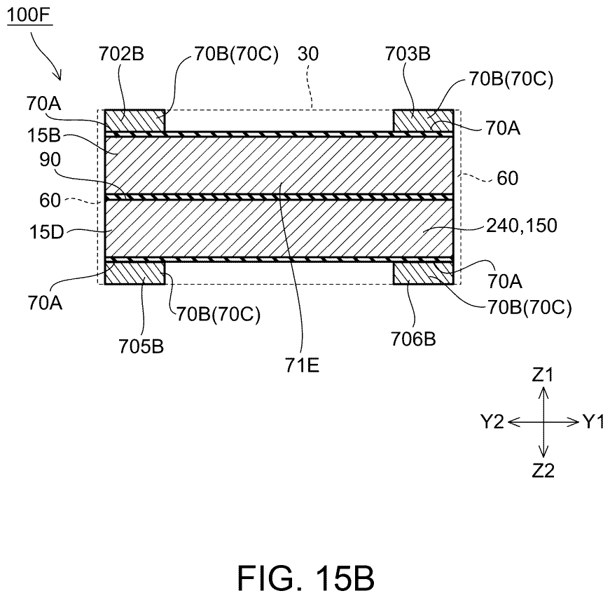

FIG. 14 is an XY plan view illustrating the structure of the first spiral conductor portion included in the coil component according to the sixth embodiment of the present invention. In FIG. 14, for convenience of explanation, the coil conductor portion is shown by solid lines, the main body portion is shown by broken lines, and other components are omitted. FIG. 15A and FIG. 15B are cross-sectional views illustrating the structure of the coil member included in the coil component according to the sixth embodiment of the present invention. FIG. 15A shows an XZ cross-sectional view taken along line A-A′ in FIG. 14, and FIG. 15B shows a YZ cross-sectional view taken along line B-B′ in FIG. 14.

### (Support Member)

The support members 702A, 702B, 703A, and 703B are positioned at corner portions of the main body portion 30 on the Z1 side in the Z1-Z2 direction. The support members 705A, 705B, 706A, and 706B are positioned at corner portions of the main body portion 30 on the Z2 side in the Z1-Z2 direction. The support member 702A, 702B, 703A, 703B, 705A, 705B, 706A, 706B includes a soft magnetic portion (soft magnetic support member). At least a portion of the first interface 70A is formed from a contact interface between the soft magnetic support member and the coil member 10. The relative permeability of the soft magnetic support member in the first direction (Z1-Z2 direction) is greater than the relative permeability of the main body portion 30 in the first direction (Z1-Z2 direction). Here, the soft magnetic support member may contain magnetic powder and may be an insulator.

In this example, the two surfaces of the main body portion 30, which are parallel to the first direction, are connected via the support members 702A, 702B, 703A, 703B, 705A, 705B, 706A, and 706B. When the main body portion 30 has an outer shape of rectangular parallelepiped, the support members 702A, 702B, 703A, 703B, 705A, 705B, 706A, and 706B are arranged to include at least one end parts of the four edges parallel to the first direction of the main body portion 30.

By providing the support members 702A, 702B, 703A, 703B, 705A, 705B, 706A, and 706B, the magnetic properties of the coil component 100F are improved. That is, in the coil component 100F shapes as a substantially rectangular parallelepiped, the magnetic flux density tends to decrease at the corner portions of the main body portion 30, which may cause a reduction in inductance. By providing the support members 702A, 702B, 703A, 703B, 705A, 705B, 706A, and 706B having the soft magnetic support member at the corner portions of the main body portion 30 as in this embodiment, magnetic flux can easily pass through the corner portions, thereby improving the magnetic properties (inductance) of the coil component 100F.

### (Seventh Embodiment)

Next, a coil component according to the seventh embodiment of the present invention will be described. In the following description, portions common to the coil component according to the first embodiment will be omitted.

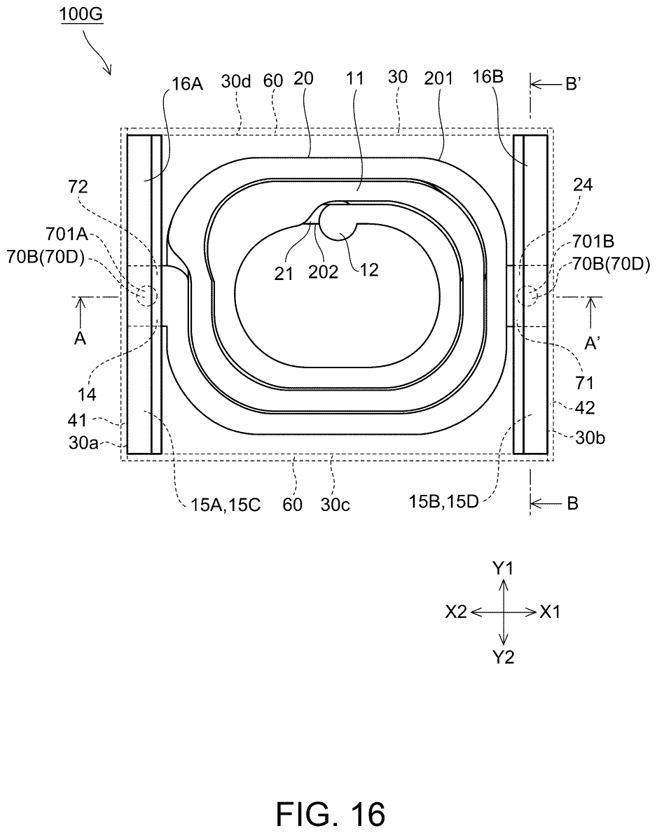

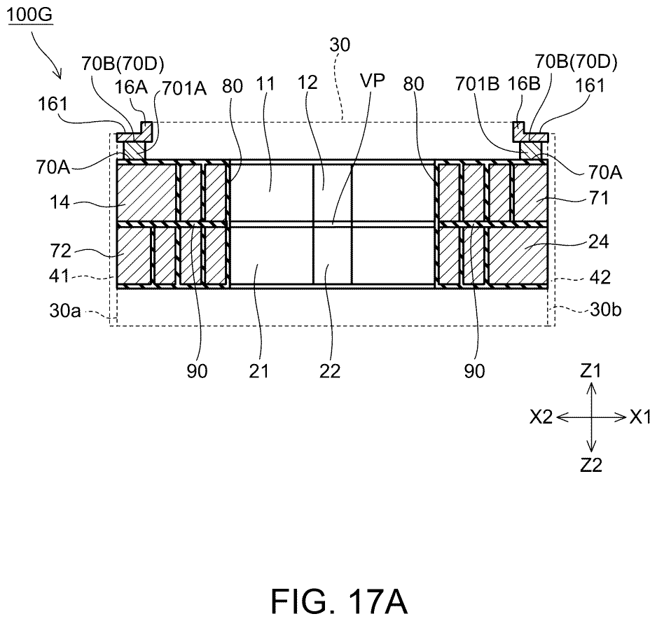

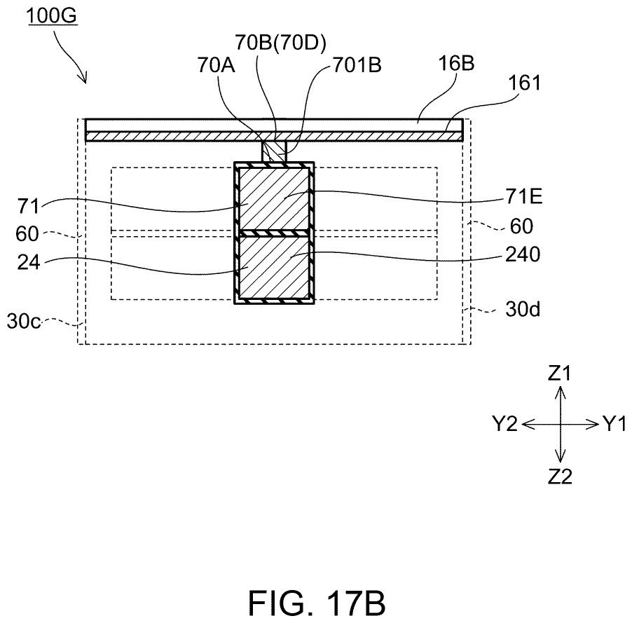

FIG. 16 is an XY plan view illustrating the structure of the first spiral conductor portion included in the coil component according to the seventh embodiment of the present invention. In FIG. 16, for convenience of explanation, the coil conductor portion is shown by solid lines, the main body portion is shown by broken lines, and other components are omitted. FIG. 17A and FIG. 17B are cross-sectional views illustrating the structure of the coil member included in the coil component according to the seventh embodiment of the present invention. FIG. 17A shows an XZ cross-sectional view taken along line A-A′ in FIG. 16, and FIG. 17B shows a YZ cross-sectional view taken along line B-B′ in FIG. 16.

### (Support Member)

In the coil component 100G according to the seventh embodiment, the support member 701A is provided at a position overlapping the first lead-out section 14 when viewed in the first direction (Z1-Z2 direction), and the support member 701B is provided at a position overlapping the second lead-out section 24 when viewed in the first direction (Z1-Z2 direction). The support member 701A, 701B includes a support conductor portion, which is conductive, and the exposed support surface 70B of the support conductor portion is exposed on the Z1 side in the Z1-Z2 direction of the main body portion 30.

### (External Electrode)

In the coil component 100G according to the seventh embodiment, the external electrodes 16A and 16B are similar to the external electrodes 16A and 16B of the coil component 100C according to the third embodiment. That is, the external electrodes 16A and 16B are provided so as to extend in the Y1 -Y2 direction on the Z1 side in the Z1-Z2 direction of the main body portion 30. The external electrode 16A is in contact with an exposed conductive surface of the exposed support surface 70B of the support member 701A, and the external electrode 16B is in contact with an exposed conductive surface of the exposed support surface 70B of the support member 701B.

In this example, the external electrodes 16A and 16B are provided so as to span two outer surfaces 30c and 30d of the main body portion 30, which are parallel to the XZ plane. The external electrodes 16A and 16B may include a first recess part 161 recessed toward the first direction (Z2 side in Z1-Z2 direction).

The first terminal member 41 may be provided on the outer surface 30a, and the second terminal member 42 may be provided on the outer surface 30b. The first terminal member 41 is bonded to the exposed lead-out surface 140 exposed from the outer surface 30a, the dummy end-face portion 72E, and the external electrode 16A. The second terminal member 42 is bonded to the exposed lead-out surface 240 exposed from the outer surface 30b, the dummy end-face portion 71E, and the external electrode 16B. By bonding these surfaces, the bonding strength and electrical conductivity between the coil conductor portion 20 and the first terminal member 41 and second terminal member 42 are enhanced, while also enabling an increase in the connection area with a conductive material (external terminal or solder) of the coil component 100G.

### (Example of Second Recess Part)

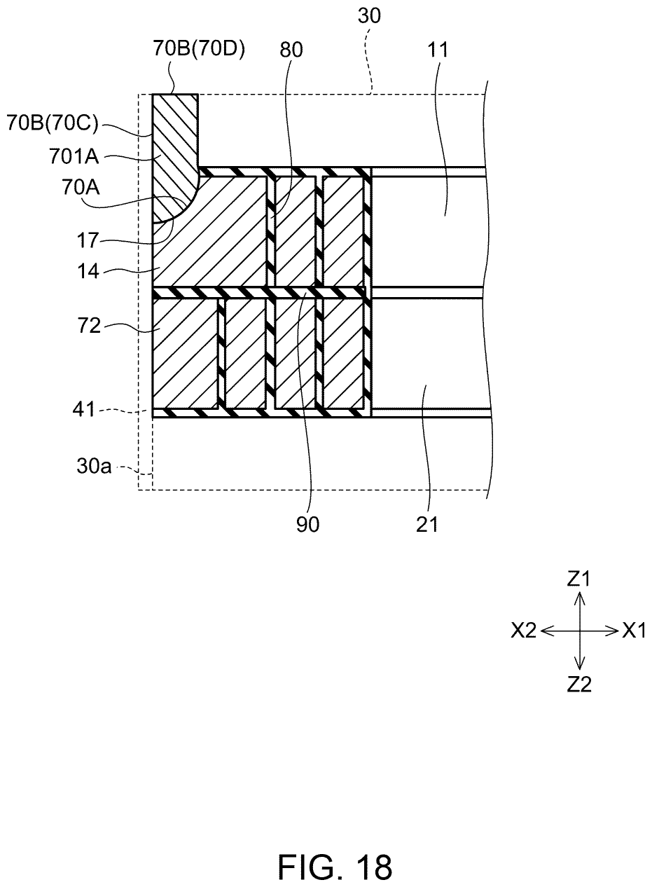

FIG. 18 is a partial cross-sectional view illustrating an example of the second recess part. In FIG. 18, a partial cross-sectional view of a portion on the X2 side in the X1-X2 direction of the coil member 10 is shown.

A second recess part 17 recessed toward the Z2 side in the Z1-Z2 direction may be provided (Z1 side in Z1-Z2 direction) of the coil member 10. In this example, the second recess part 17 is provided in the first lead-out section 14. The second recess part 17 may be recessed in a concave curved shape or in a rectangular shape. The support member (in this example, support member 701A) is disposed in the second recess part 17.

With presence of the second recess part 17, at least a portion of the first interface 70A may be formed from a contact interface between at least a portion of a recessed surface formed by an opening edge and an internal surface of the second recess part 17 and the support member 701A. By providing the second recess part 17, a contact interface between the support member 701A and the coil member 10 is ensured, thereby improving the bonding strength between the support member 701A and the coil member 10.

Furthermore, when the support member 701A includes a support conductor portion, which is conductive, at least a portion of the first interface 70A may constitute a contact interface between at least a portion of a conductive surface of the recessed surface formed by the internal surface of the second recess part 17 and a conductive surface of the support conductor portion of the support member 701A. Accordingly, conductive contact between the support member 701A and the coil member 10 (for example, first lead-out section 14 provided with second recess part 17) is achieved at the recessed surface of the second recess part 17.

In this case, the support member 701A may be configured to taper toward the tip while contacting the conductive surface of the coil conductor portion. This configuration increases the volume of magnetic powder near the coil conductor portion, thereby enabling effective utilization of magnetic flux. The tapering direction may be in the first direction or in a direction orthogonal to the first direction.

The first terminal member 41 may be provided on the outer surface 30a. The first terminal member 41 is bonded to the exposed lead-out surface 140 exposed from the outer surface 30a, the dummy end-face portion 72E, the first exposed surface 70C, and the external electrode 16A. Accordingly, the bonding strength and electrical conductivity between the coil conductor portion 20 and the first terminal member 41 is improved. Meanwhile, the connection area with a conductive material (external terminal or solder) of the coil component 100G is increased.

The second recess part 17 may also be provided at a connecting portion with another support member other than the support member 701A. For example, the second recess part 17 may be provided in the first connecting portion 15A, which is a connecting portion with the support member 702A or the support member 703A. Furthermore, on the X1 side in the X1-X2 direction of the coil member 10, the second recess part 17 may be provided in the first dummy conductor portion 72, which is a connecting portion with the support member 701B.

### (Method for Manufacturing Coil Component 100A)

The method for manufacturing a coil component according to this embodiment is not particularly limited. One example of a non-limited method is as follows. The following manufacturing method describes an example where plural coil components are manufactured in a single batch.

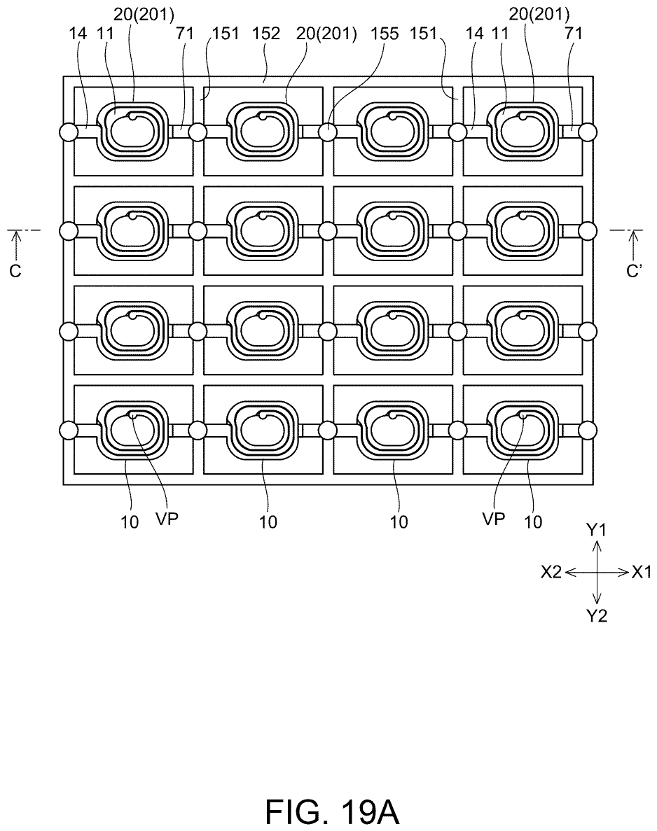

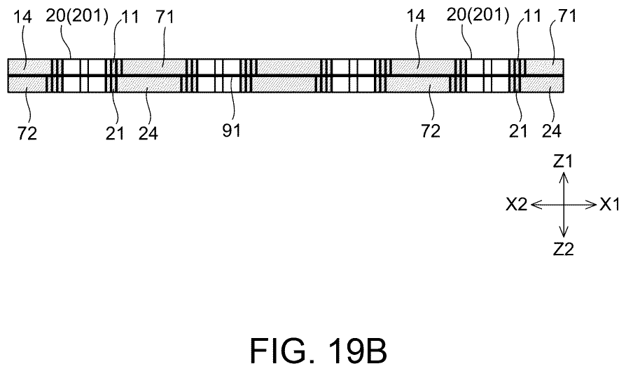

FIG. 19A to FIG. 27C are explanatory diagrams illustrating an example of a method for manufacturing the coil component 100A according to the first embodiment

First, as shown in the XY plan view of FIG. 19A and the XZ cross-sectional view of FIG. 19B (cross section taken along line C-C′ in FIG. 19A), a plurality of spiral portions (first spiral conductor portion 11 and second spiral conductor portion 21) are formed (first step). Specifically, the first spiral conductor portion 11 is formed on one surface of an insulating sheet substrate 91 (specifically, the surface on Z1 side in Z1-Z2 direction), and the second spiral conductor portion 21 is formed on the other surface of the sheet substrate 91 (specifically, the surface on Z2 side in Z1-Z2 direction). The process for forming the first spiral conductor portion 11 and the second spiral conductor portion 21 is not particularly limited and may be performed, for example, by a plating process. In this embodiment, the via member VP, the first lead-out section 14, and the second lead-out section 24 are also formed simultaneously in this process.

In a case where a plating process is included in this step, the coil conductor portion 20 including the first conductor portion 201 includes a portion formed from a plating layer. Furthermore, the first dummy conductor portion 72 is formed by the plating process.

Furthermore, by the same plating process, connecting portions 151 extending in the Y1-Y2 direction and connecting portions 152 extending in the X1-X2 direction are formed around the coil conductor portions 20 when viewed in the first direction (Z1-Z2 direction). The connecting portions 151 and 152 are provided in a lattice pattern at intermediate positions between two adjacent coil conductor portions 20 and are also provided so as to surround the outer periphery of the entire region of the plurality of coil conductor portions 20. The connecting portions 151 and the connecting portions 152 are parts of the conductor pattern and are used to structurally connect the plurality of coil conductor portions 20 to improve shape retention and also serve as a current supply portion for the plating process. Accordingly, in the first step, a conductor pattern including a plurality of spiral portions (first spiral conductor portion 11 and second spiral conductor portion 21) and connecting portions (connecting portions 151 and connecting portions 152) of the plurality of spiral portions is formed.

With formation of the connecting portions 151 and the connecting portions 152, lands 155 may be formed at positions where the extension of the first lead-out section 14 intersects the connecting portions 151 and where the extension of the second dummy conductor portion 71 intersects the connecting portions 151. The land 155 is provided in a circular or rectangular shape having a width larger than the width of the first lead-out section 14 and the connecting portion 151. Here, the first spiral conductor portion 11, the second spiral conductor portion 21, the via member VP, the first lead-out section 14, the second lead-out section 24, the first dummy conductor portion 72, the second dummy conductor portion 71, and the connecting portions 151 and the connecting portions 152 can be integrally formed on the sheet substrate 91. In FIG. 19A and FIG. 19B, boundaries between the above elements that can be integrally formed are shown, but such boundaries may not exist. The same applies to subsequent figures.

Here, the sheet substrate 91 is not particularly limited as long as it has mechanical properties for functioning as a support when forming the first spiral conductor portion 11, the second spiral conductor portion 21, the connecting portions 151 and the connecting portions 152, and suitability (removal characteristics) in the process described below. Examples of the material constituting the sheet substrate 91 include organic materials, inorganic materials, and composite materials thereof. Specific examples of organic materials include thermoplastic resins such as polyimide resin and polyethylene resin, thermosetting resins such as epoxy resin and phenolic resin, and cellulose. Specific examples of inorganic materials include oxide-based materials such as glass and alumina, metal-based materials such as aluminum and magnesium, and inorganic salt-based materials such as calcium carbonate. Specific examples of composite materials include structures in which inorganic materials are dispersed in an organic material matrix. Among these materials, polyimide resin and epoxy resin are preferable, and polyimide resin is most preferable in combination with the plating process.

In next step, at least a portion of the sheet substrate 91 is removed. Specifically, the sheet substrate 91 is removed so as to include a region surrounded by the inner periphery of the first spiral conductor portion 11 when viewed in the first direction (Z1-Z2 direction).

The specific removal process of the sheet substrate 91 is appropriately set according to the material constituting the sheet substrate 91. The removal process is broadly classified into a dry process such as plasma etching and a wet process such as wet etching. A portion of the sheet substrate 91 is removed by the removal process, and a remaining portion that is not removed may remain. For example, when the sheet substrate 91 is made of a composite material of an organic material and an inorganic material, only the organic material may be removed in the removal process.

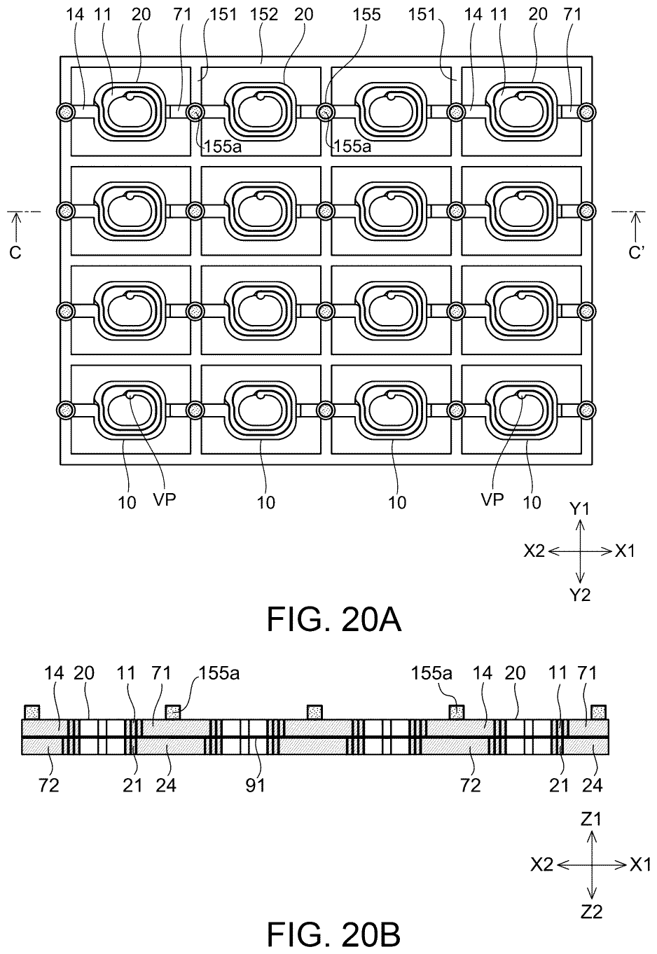

Next, as shown in the XY plan view of FIG. 20A and the XZ cross-sectional view of FIG. 20B (cross section taken along line C-C′ in FIG. 20A), flux 155a is coated on the lands 155 (Z1 side in Z1-Z2 direction). The method of coating the flux 155a is not limited and may include, for example, a method of transferring the flux 155a from a plurality of pins to each land 155 by attaching the flux 155a to the tips of the plurality of pins, or a method of applying the flux 155a by screen printing using a mask such as a metal mask.

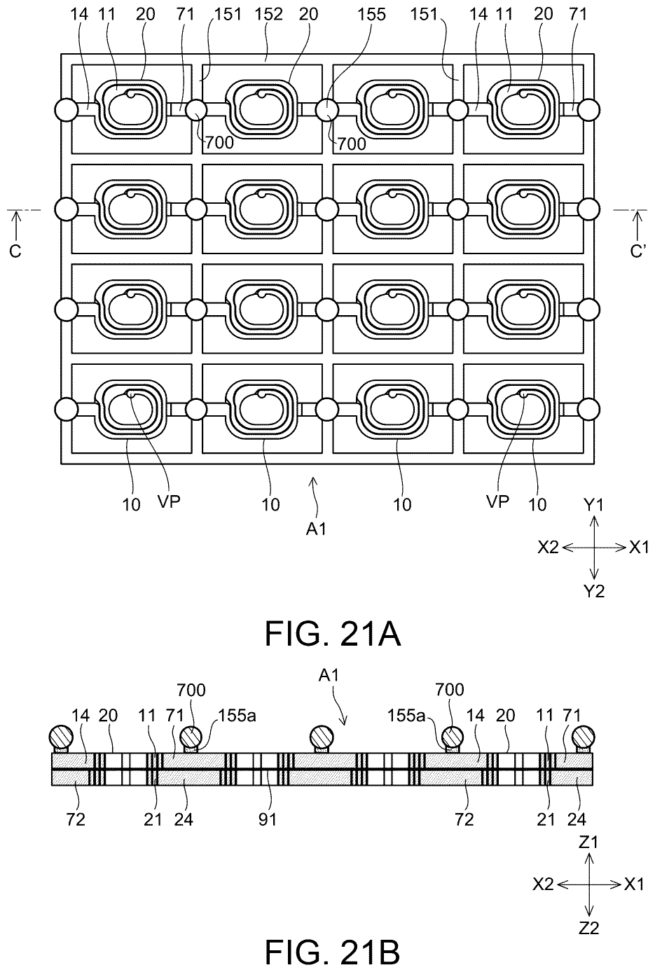

Next, as shown in the XY plan view of FIG. 21A and the XZ cross-sectional view of FIG. 21B (cross section taken along line C-C′ in FIG. 21A), a support member material 700, which provides the support members 701A and 701B, is mounted over the flux 155a coated onto the lands 155 in the previous step (second step). Thus, the support member material 700 extending to one side in the first direction (Z1 side in Z1-Z2 direction,) from the connecting portions 151 and 152 is formed. The method of mounting the support member material 700 is not limited and may include, for example, a method of mounting the support member material 700 on each flux 155a through a mask opening using a mask having a mask opening corresponding to the position of the flux 155a (hereinafter also referred to as a “vibration embedding method”). The second step may be performed before removing the sheet substrate 91.

Examples of the support member material 700 include solder balls, heteronuclear solder balls (copper-core solder balls, resin-core solder balls, etc.), and copper pillars (cylindrical, cylindrical with header, spherical, truncated cone, laminated type, etc.). For example, when using copper-core solder balls, advantages include improved coplanarity as a pillar compared to solder balls without a core, excellent conductivity, plating adhesion equivalent to copper wire, and ease of mounting by the vibration embedding method due to the spherical shape.

When using copper pillars, advantages include improved coplanarity as a pillar compared to solder balls without a core, excellent conductivity, plating adhesion equivalent to copper wire, reduced contact resistance due to planar contact in the case of a cylindrical shape, and efficient use of space. When using copper pillars, if solder is not applied to the connection surface, solder paste may be applied instead of flux 155a in the above step.

The size of each unit of the support member material 700 is not limited, but in the case of a spherical shape, for example, one having a diameter of about 300 μm is used. After mounting the support member material 700, the support member material 700 is fixed to the lands 155 by reflow.

After fixing the support member material 700 to the lands 155, an insulating covering is applied to the exposed surfaces of the connecting portions 151 and 152, the support member material 700, the first spiral conductor portion 11, and the second spiral conductor portion 21. The process for forming the insulating covering is appropriately set according to the material constituting the second insulator portion 80. For example, when the second insulator portion 80 is made of a parylene-based polymer, it is formed by a dry process (CVD). When the second insulator portion 80 contains a curable resin material such as epoxy resin, it may be formed by attaching a powder or liquid containing the material constituting the second insulator portion 80 to the exposed surface and then solidifying the attachment by heating or the like. Other examples include dip coating, sputtering, PVD, and autocatalytic deposition.

Next, a material containing magnetic powder is supplied and shape-formed into a plate material so as to cover the conductor pattern on both surfaces in at least the first direction (Z1-Z2 direction) (third step). An example of the shape forming process is a molding process, in which the coil member 10 is surrounded by a material containing a magnetic material. Specific examples of the molding process include placing the product A1 formed up to the previous steps in a mold and forming it by compression molding of a material containing magnetic material, or transfer molding a material containing magnetic powder or a member serving as a raw material for the material.

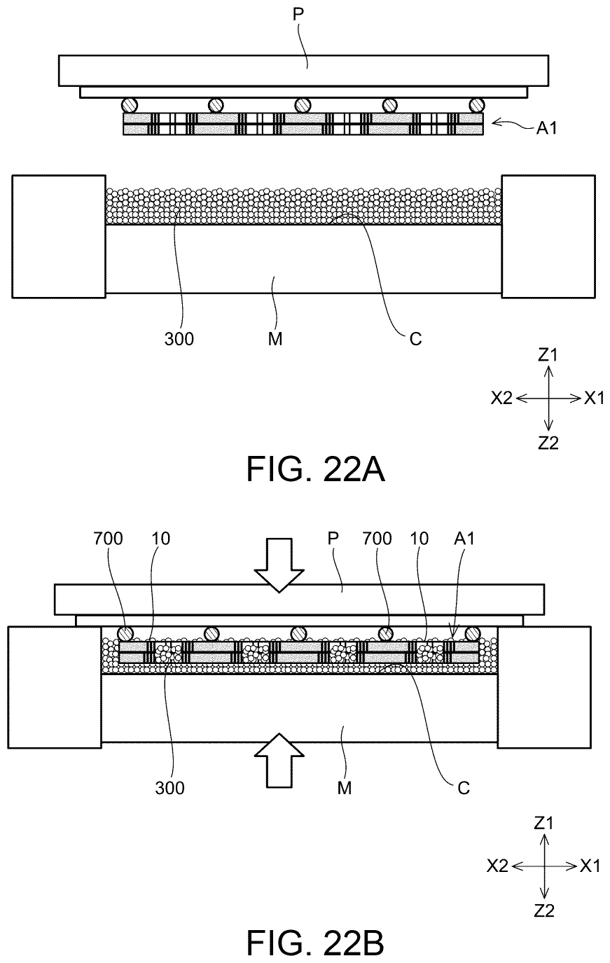

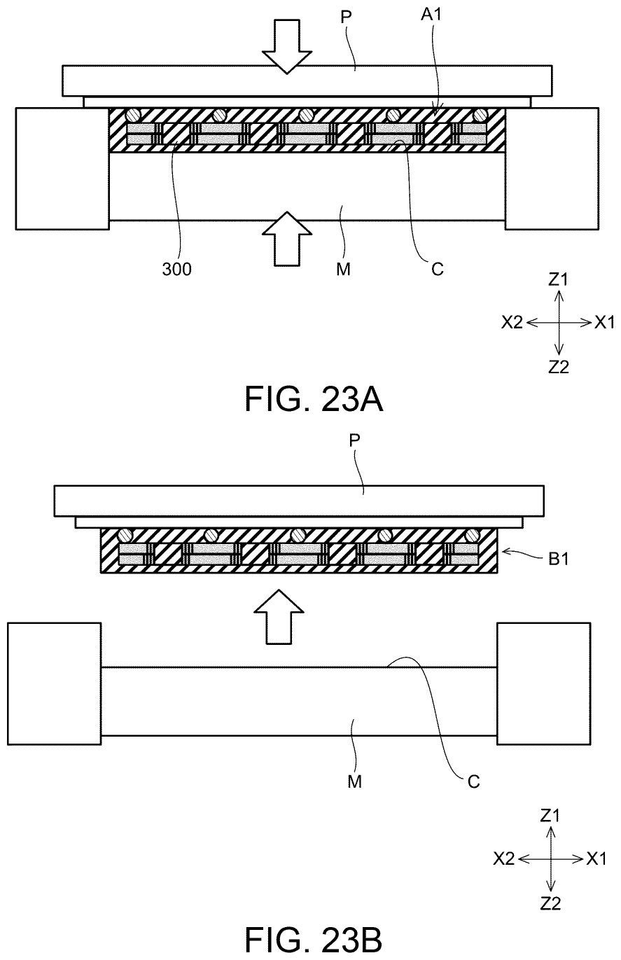

FIG. 22A to FIG. 23B schematically illustrate cross-sectional views of a compression molding process. First, as shown in FIG. 22A, a material containing magnetic material is placed into a cavity C of a mold M, and a product A1 is mounted on a support substrate P. Next, as shown in FIG. 22B, the product A1 mounted on the support substrate P is inserted into the cavity C of the mold M, and compression is applied between the mold M and the support substrate P. In this state, a support member material 700 is interposed between the support substrate P and the coil member 10, and the support member material 700 serves as a pillar to secure a predetermined gap between the coil member 10 and the support substrate P.

In the compression molding process, while a compressive force is applied between the mold M and the support substrate P, the material containing magnetic material is made to flow and spread within the cavity C, so that stress is applied to the product A1 during material filling. Particularly, as the material flows and spreads within the cavity C, the material moves toward the support substrate P from the cavity C, and thus strong stress directed from the cavity C toward the support substrate P is applied to the product A1. In the present embodiment, since the product A1 is supported on the support substrate P by the support member material 700, deformation of the product A1 is suppressed even when the product A1 is pressed toward the support substrate P by the material. That is, positional displacement of each coil member 10 in the product A1 is effectively inhibited.

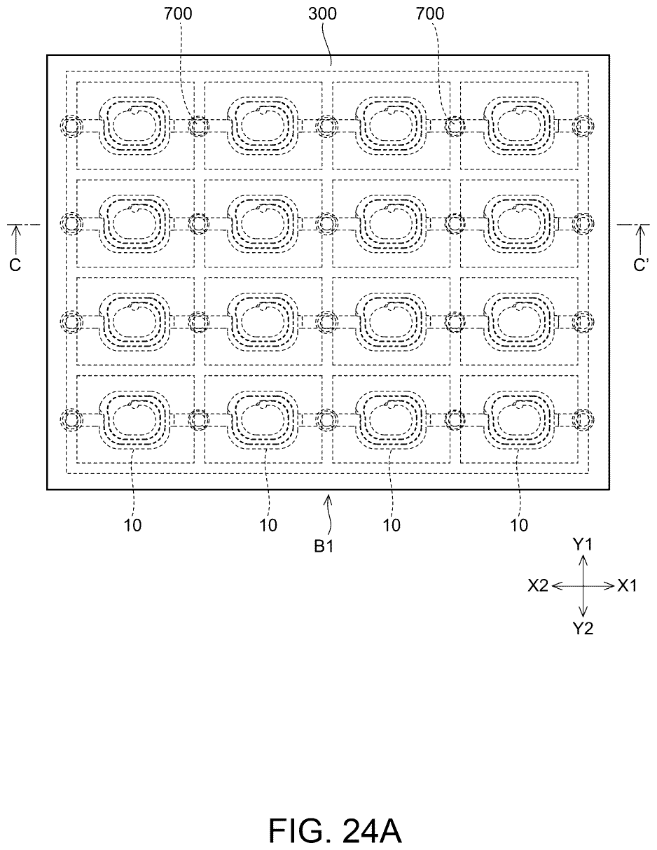

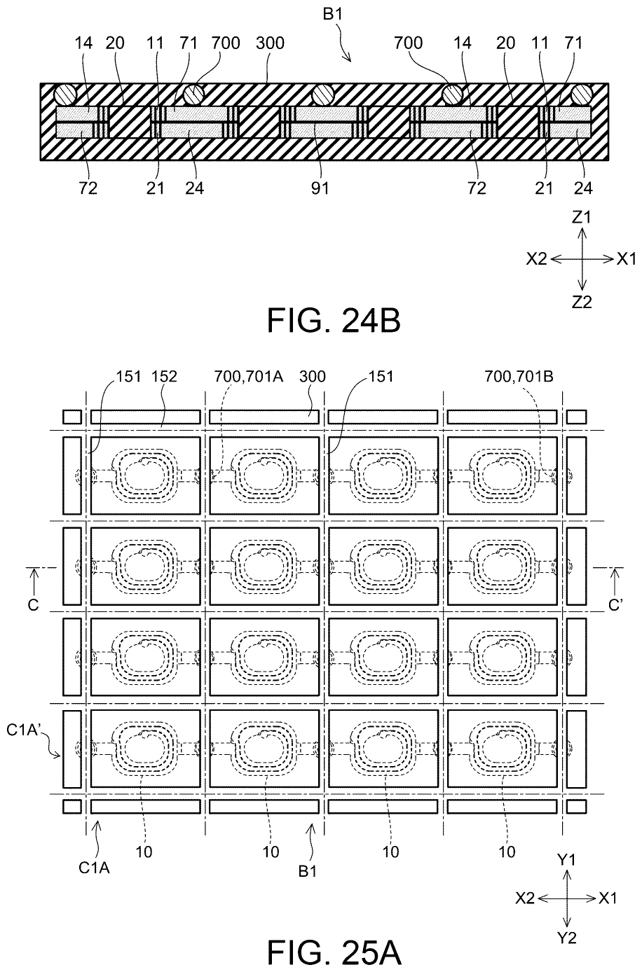

After the material containing magnetic material is filled into the cavity C, it is solidified or cured. Thereafter, demolding is performed (see FIG. 23B). FIG. 24A shows an XY plan view of a product B1 formed from the plate material and obtained after demolding, and FIG. 24B shows a cross-sectional view taken along line C-C′ in FIG. 24A. In the product B1, the entire periphery of the product A1 is covered with a body material 300 (the material containing magnetic material that has been solidified or cured).

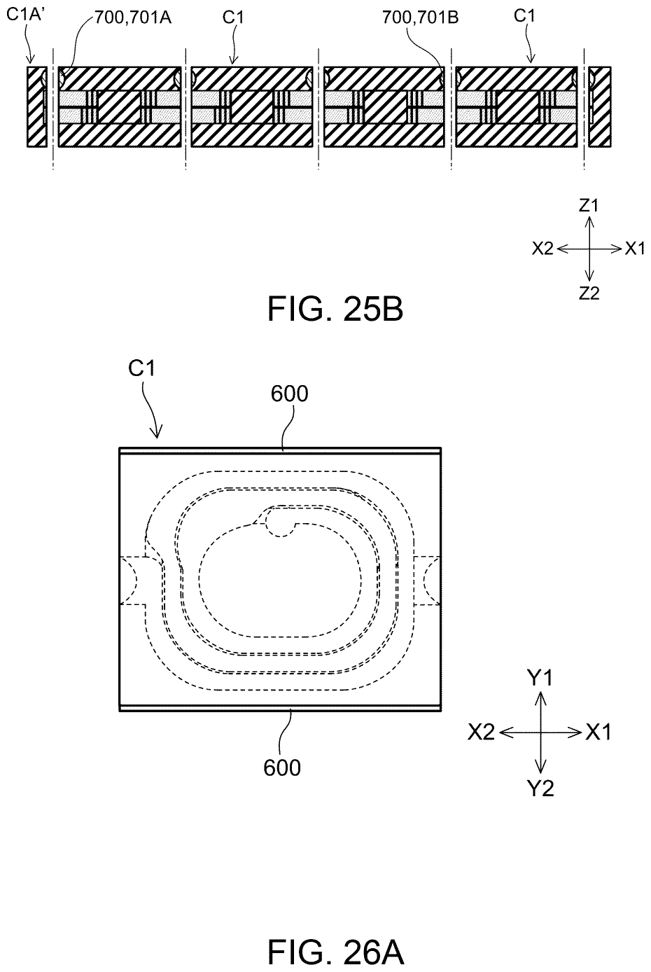

Next, the product B1 formed from the plate material is cut such that a first direction (Z1-Z2 direction) is parallel to the cut surface, and a fourth step of obtaining a plurality of first members including spiral portions (first spiral conductor portion 11, second spiral conductor portion 21) is performed. Specifically, as shown in the XY plan view of FIG. 25A and the XZ sectional view of FIG. 25B (cross section taken along line C-C′ in FIG. 25A), the product B1 is divided at predetermined positions. In this step, the product B1 is diced along respective directions of the connecting portions 151 and 152. The one-dot chain lines shown in FIG. 25A and FIG. 25B indicate division lines (center lines of division) by dicing. By dicing, a product C1 having each coil member 10 and a main body portion 30, where the body material 300 covering the coil member 10 is divided, is formed as the first member. A portion of the product B1 separated from the product C1 by dicing is the second member C1A. In the example shown in FIG. 25A and FIG. 25B, the connecting portions (connecting portions 151, 152) are completely removed (crushed, cut off, ground) while dicing, so that the product C1 and the second member C1A do not include the connecting portions (connecting portions 151, 152).

Thus, in the product C1, the connecting portions 151 and the connecting portions 152 are cut off by dicing and do not remain, but a part of the support member material 700 remains. When the dicing width is narrow, a portion (part C1A′ of the second member C1A), which does not form the product C1 by dicing and remains without being removed, and at least a part of the connecting portions 151, 152 and the support member material 700, may remain.

The part of the support member material 700 remaining on the product C1 side becomes support members 701A, 701B having portions in contact with the coil member 10. Further, a cut surface of the support member material 700 exposed from a cut surface of the body material 300 becomes a exposed support surface 70B (first exposed surface 70C) of the support members 701A, 701B. Further, a cut surface of the first lead-out section 14 exposed from the cut surface of the body material 300 becomes an exposed lead-out surface 140, a cut surface of the first dummy conductor portion 72 becomes a dummy end surface portion 72E, a cut surface of the second lead-out section 24 becomes an exposed lead-out surface 240, and a cut surface of the second dummy conductor portion 71 becomes a dummy end surface portion 71E.

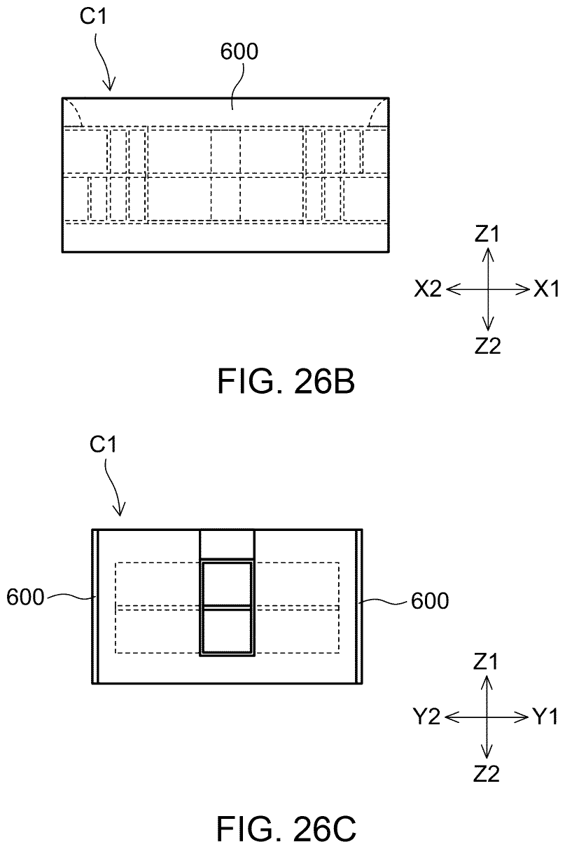

Next, as shown in the XY plan view of FIG. 26A, the XZ plan view of FIG. 26B, and the YZ plan view of FIG. 26C, an insulating cover 600 is applied to some surfaces of the product C1. The surfaces, to which the insulating cover 600 is applied, are outer surfaces of the product C1 other than surfaces on which electrodes are formed in a later step. In the present embodiment, the insulating cover 600 is applied to outer surfaces other than outer surfaces exposing the exposed lead-out surfaces 140, 240 of the product C1. Note that the insulating cover 600 may be applied before or during the fourth step depending on the surfaces to which the insulating cover 600 is applied.

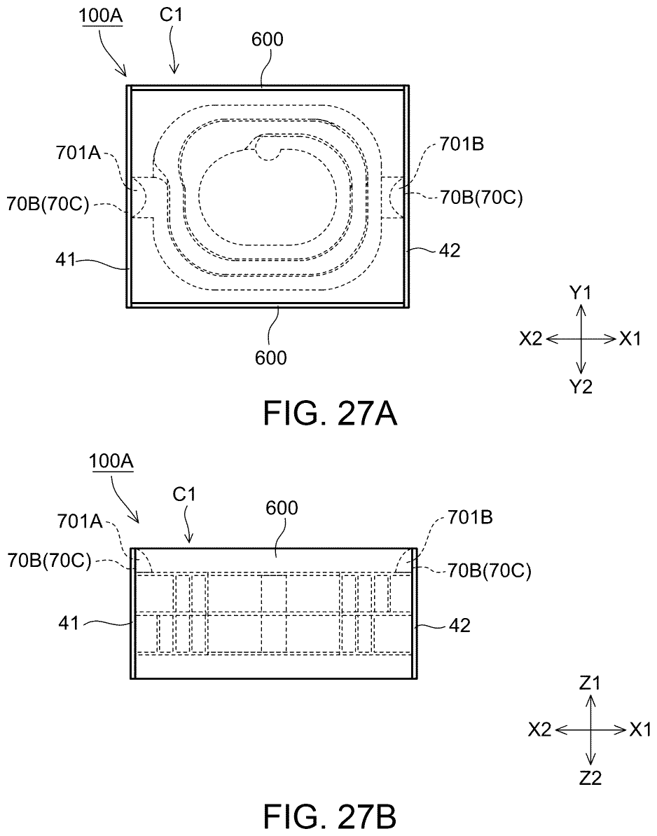

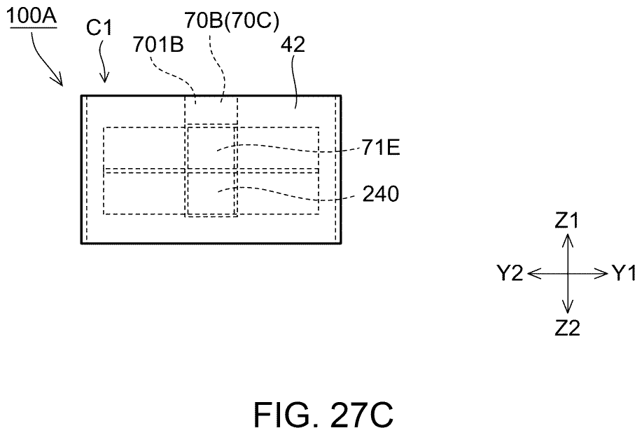

Next, as shown in the XY plan view of FIG. 27A, the XZ plan view of FIG. 27B, and the YZ plan view of FIG. 27C, external electrodes, namely a first terminal member 41 and a second terminal member 42, are formed on surfaces of the product C1 including conductive surfaces not covered with the insulating cover 600 (fifth step). The method of forming the first terminal member 41 and the second terminal member 42 is not limited, and examples include a plating process and a printing process using conductive paste. As a result, a coil component 100A according to the present embodiment is manufactured.

The first terminal member 41 is joined to the exposed lead-out surface 140 and the dummy end surface portion 72E, as well as to the exposed support surface 70B of the support member 701A. The second terminal member 42 is joined to the exposed lead-out surface 240 and the dummy end surface portion 71E, as well as to the exposed support surface 70B of the support member 701B. This improves DCR (Direct Current Resistance) by reducing contact resistance of the first terminal member 41 and the second terminal member 42, and enhances the reliability of the coil component 100A by improving the bonding strength of the first terminal member 41 and the second terminal member 42.

### (Method for Manufacturing Coil Component 100B)

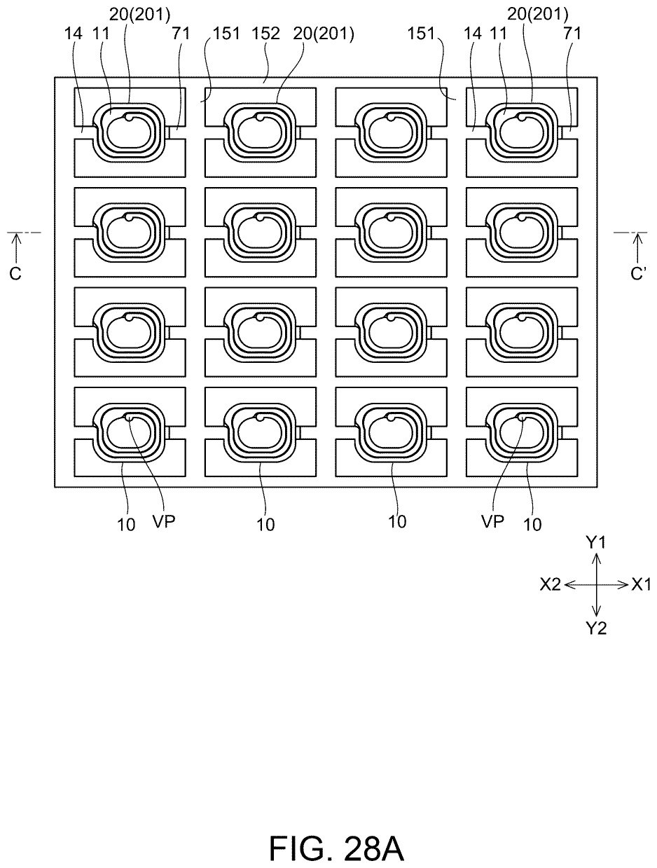

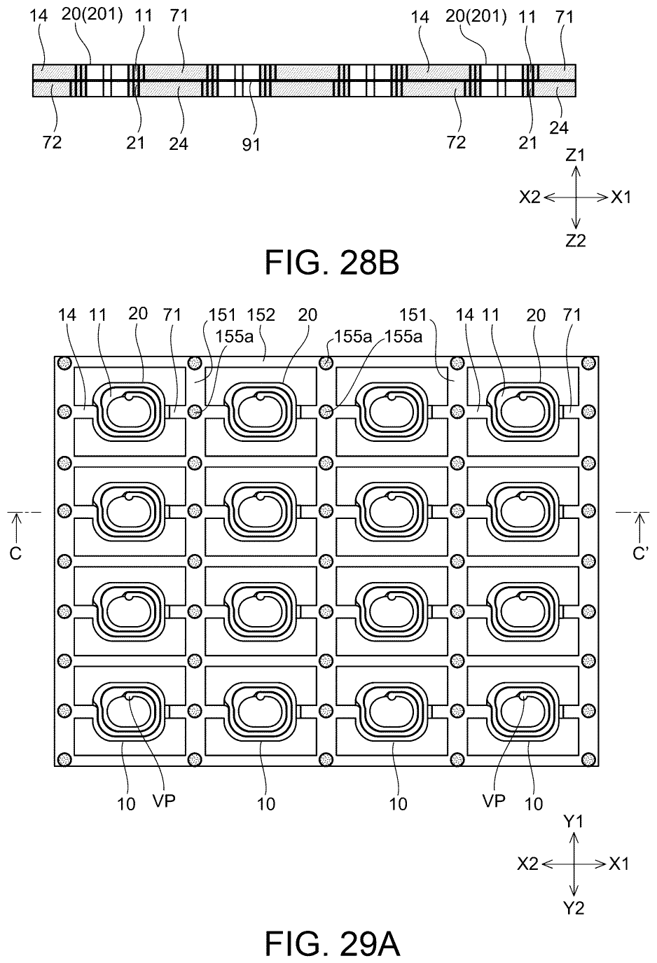

FIG. 28A to FIG. 36C are explanatory diagrams illustrating an example of a method for manufacturing the coil component 100B according to the second embodiment

First, as shown in the XY plan view of FIG. 28A and the XZ cross-sectional view of FIG. 28B (cross section taken along line C-C′ in FIG. 28A), a plurality of spiral portions (first spiral conductor portion 11 and second spiral conductor portion 21) are formed (first step). Specifically, the first spiral conductor portion 11 is formed on one surface of an insulating sheet substrate 91 (specifically, the surface on Z1 side in Z1-Z2 direction), and the second spiral conductor portion 21 is formed on the other surface of the sheet substrate 91 (specifically, the surface on Z2 side in Z1-Z2 direction). The process for forming the first spiral conductor portion 11 and the second spiral conductor portion 21 is not particularly limited and may be performed, for example, by a plating process. In this embodiment, the via member VP, the first lead-out section 14, and the second lead-out section 24 are also formed simultaneously in this process.

In a case where a plating process is included in this step, the coil conductor portion 20 including the first conductor portion 201 includes a portion formed from a plating layer. Furthermore, the first dummy conductor portion 72 is formed by the plating process.

Furthermore, by the same plating process, connecting portions 151 extending in the Y1-Y2 direction and connecting portions 152 extending in the X1-X2 direction are formed around the coil conductor portions 20 when viewed in the first direction (Z1-Z2 direction). The connecting portions 151 and the connecting portions 152 are provided in a lattice pattern at intermediate positions between two adjacent coil conductor portions 20 and are also provided so as to surround the outer periphery of the entire region of the plurality of coil conductor portions 20. The connecting portions 151 and the connecting portions 152 are parts of the conductor pattern and are used to structurally connect the plurality of coil conductor portions 20 to improve shape retention and also serve as a current supply portion for the plating process. Accordingly, in the first step, a conductor pattern including a plurality of spiral portions (first spiral conductor portion 11 and second spiral conductor portion 21) and connecting portions (connecting portions 151 and connecting portions 152) of the plurality of spiral portions is formed.

In next step, at least a portion of the sheet substrate 91 is removed. Specifically, the sheet substrate 91 is removed so as to include a region surrounded by the inner periphery of the first spiral conductor portion 11 when viewed in the first direction (Z1-Z2 direction). It is the same as the manufacturing method described above.

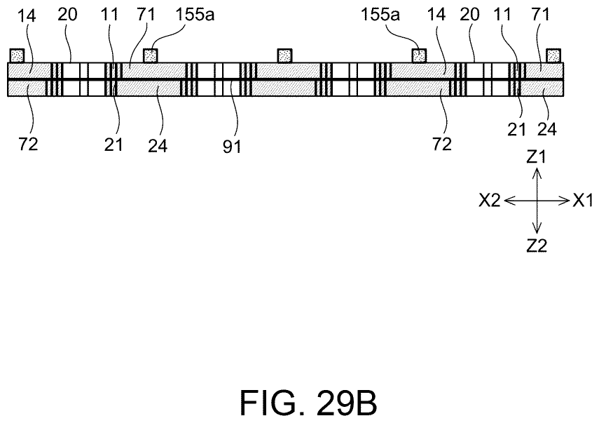

Next, as shown in the XY plan view of FIG. 29A and the XZ sectional view of FIG. 29B (cross section taken along line C-C′ in FIG. 29A), flux 155a is coated over the connecting portions 151 (Z1 side in Z1-Z2 direction). The coating positions of the flux 155a are the intersection positions of the extending first lead-out section 14 and the connecting portions 151, the intersection positions of the extending second dummy conductor portion 71 and the connecting portions 151, and the intersection positions of the connecting portions 151 and the connecting portions 152. The method of coating the flux 155a is not limited and may include, for example, a method of transferring the flux 155a from a plurality of pins to each land 155 by attaching the flux 155a to the tips of the plurality of pins, or a method of applying the flux 155a by screen printing using a mask such as a metal mask.

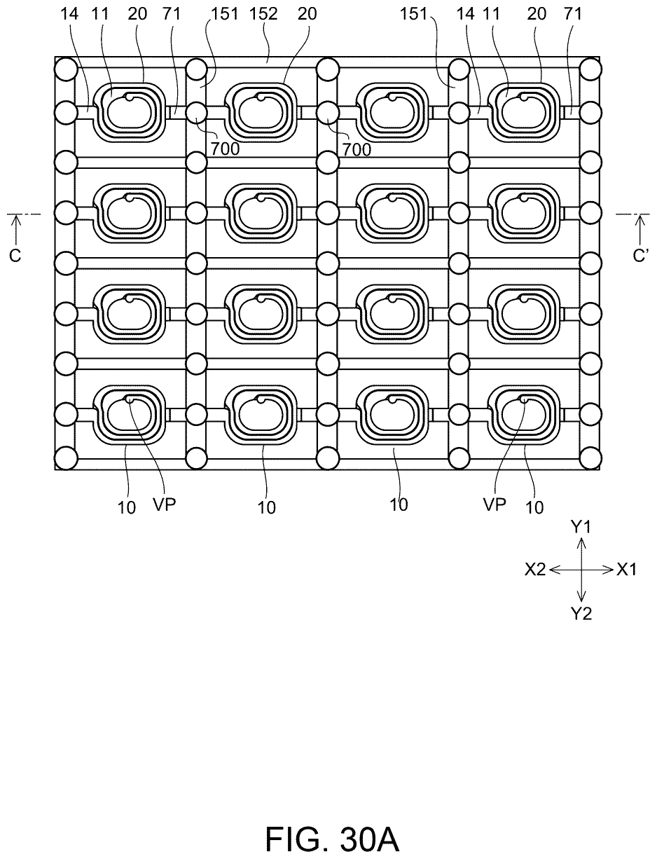

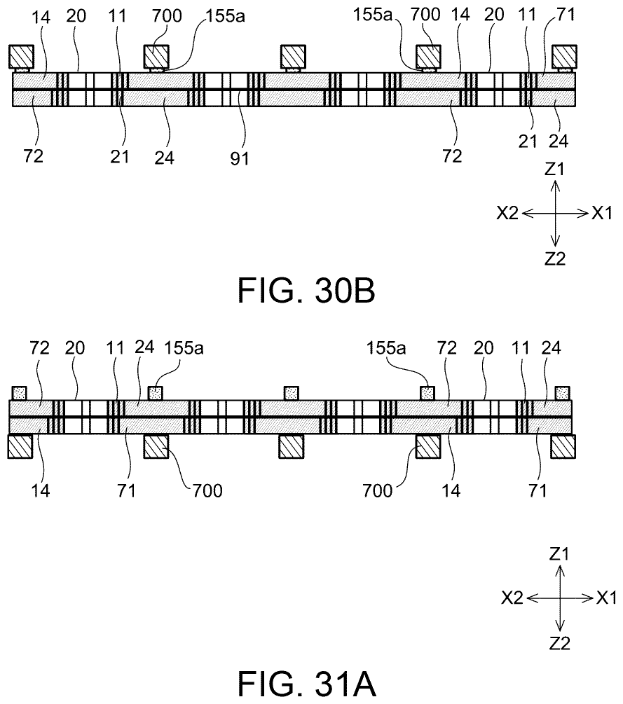

Next, as shown in the XY plan view of FIG. 30A and the XZ cross-sectional view of FIG. 30B (cross section taken along line C-C′ in FIG. 21A), a support member material 700 is mounted over the flux 155a coated in the previous step (second step). Thus, the support member material 700 extending to one side in the first direction (Z1 side in Z1-Z2 direction,) from the connecting portions 151 and 152 is formed. Support members 701A and 701B are formed from the support member material 700 thus provided.

The method of mounting the support member material 700 is not limited and may include a transfer method similar to that described in the previously explained manufacturing method. The support member material 700 may be, for example, a solder ball, a heterogeneous solder ball (such as a copper-core solder ball or a resin-core solder ball), or a copper pillar (such as a cylindrical shape, a cylindrical shape with a header, a spherical shape, a truncated cone shape, or a laminated type) as in the previously explained manufacturing method. After mounting the support member material 700, the support member material 700 is fixed to the connecting portions 151 by reflow.

Next, as shown in the XZ sectional views of FIG. 31A and FIG. 31B, the coating of the flux 155a onto the connecting portions 151, which are formed onto the surface of one side (Z1 side in Z1-Z2 direction) of the coil member 10 in the preceding step, and the mounting and fixing of the support member material 700 onto the surface of the other side (Z2 side in Z1-Z2 direction) of the coil member 10, are performed in the same process (another part of the second step). Support members 704A and 704B are formed from the support member material 700 thus provided.

After the support member material 700 is fixed to the connecting portions 151, an insulating cover is applied to the exposed surfaces of the connecting portions 151 and 152, the support member material 700, the first spiral conductor portion 11, and the second spiral conductor portion 21. The process for forming the insulating covering is the same as that in the above-described manufacturing method.

Next, a material containing magnetic powder is supplied to cover the conductor pattern on at least two surfaces in the first direction (Z1-Z2 direction) and is shape-formed into a plate material (third step). An example of this shape forming process is a molding process, in which the coil member 10 is surrounded by a material containing magnetic material. Specific examples of the molding process include placing a product A2 formed up to the previous step in a mold and forming by compression molding of a material containing magnetic material, or transfer molding a material containing magnetic powder or a member serving as a raw material of the material.

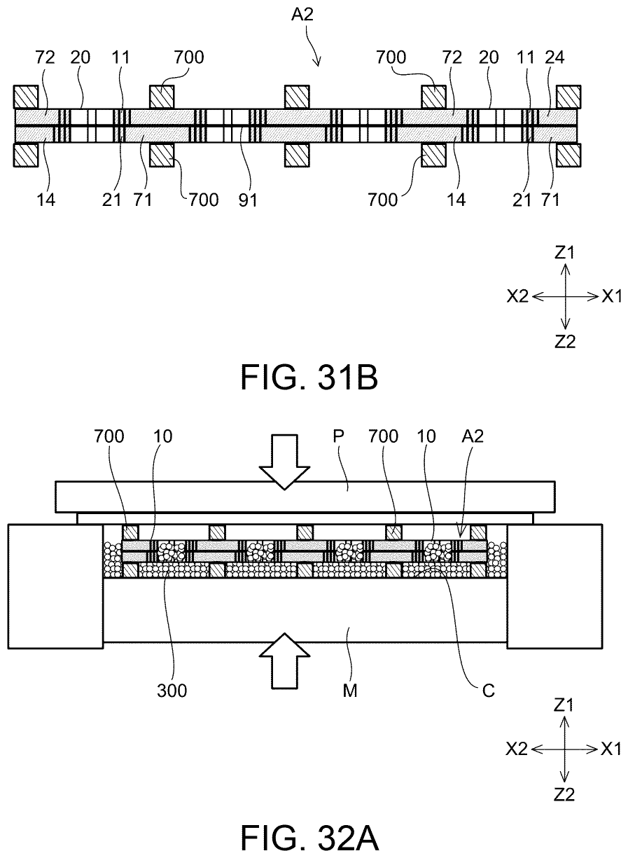

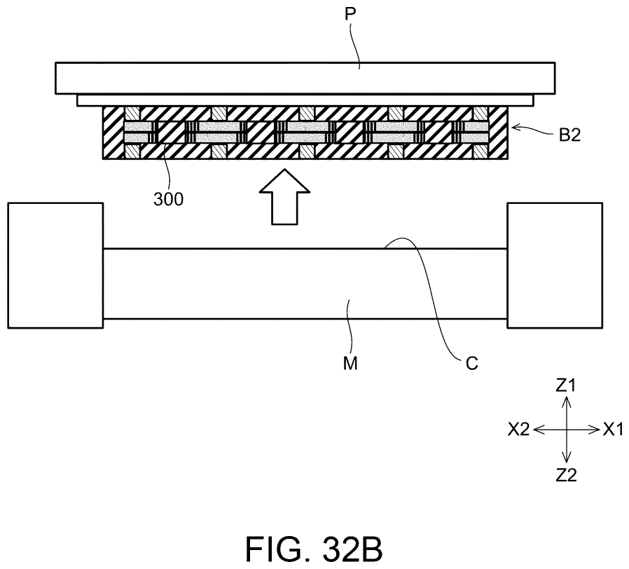

FIG. 32A and FIG. 32B schematically illustrate a cross-sectional view of a compression molding process. First, as shown in FIG. 32A, a material containing magnetic material is placed into a cavity C of a mold M, and a product A2 is mounted on a support substrate P. Next, the product A2 mounted on the support substrate P is inserted into the cavity C of the mold M, and compression is applied between the mold M and the support substrate P. In this state, a support member material 700 on one side is interposed between the support substrate P and the coil member 10, and the support member material 700 serves as a pillar to secure a predetermined gap between the coil member 10 and the support substrate P. In addition, a support member material 700 on the other side is interposed between the cavity C of the mold M and the coil member 10, and the support member material 700 serves as a pillar to secure a predetermined gap between the coil member 10 and the cavity C.

In the compression molding, while a compressive force is applied between the mold M and the support substrate P, the material containing magnetic material is caused to flow and spread within the cavity C, so that stress is applied to the product A2 during material filling. Particularly, as the material flows and spreads within the cavity C, the material moves toward the support substrate P side from the cavity C, and thus strong stress directed from the cavity C toward the support substrate P side is applied to the product A2. In the present embodiment, since one side of the product A2 is supported on the support substrate P by the support member material 700, deformation of the product A2 is suppressed even when the product A2 is pressed toward the support substrate P side by the material. Further, in the present embodiment, since the other side of the product A2 is supported on the cavity C by the support member material 700, deformation of the product A2 toward the cavity C side is suppressed. That is, positional displacement of each coil member 10 in the product A2 is effectively suppressed.

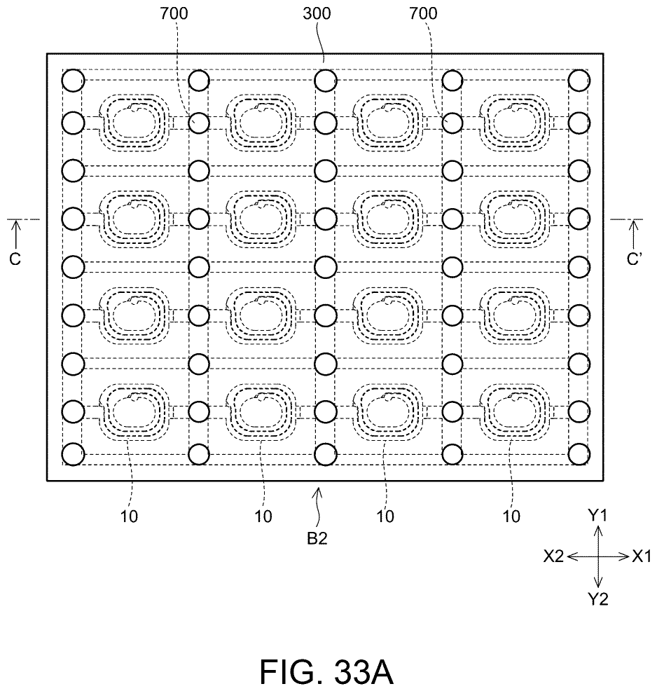

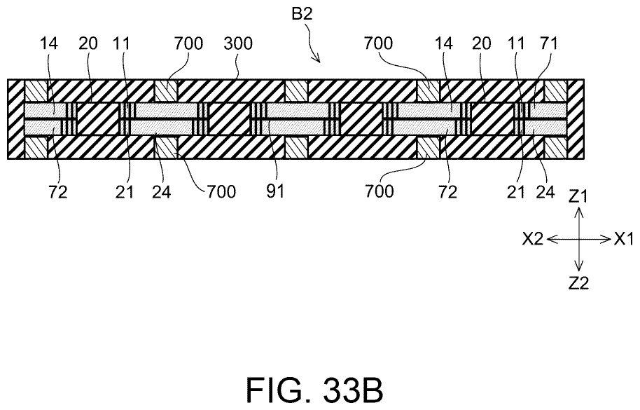

After the material containing magnetic material is filled into the cavity C, it is solidified or cured. Thereafter, demolding is performed (see FIG. 32B). FIG. 33A shows an XY plan view of a product B2 formed from the plate material and obtained after demolding, and FIG. 33B shows a cross-sectional view taken along line C-C′ in FIG. 33A. In the product B2, the entire periphery of the product A2 is covered with a body material 300 (the material containing magnetic material that has been solidified or cured).

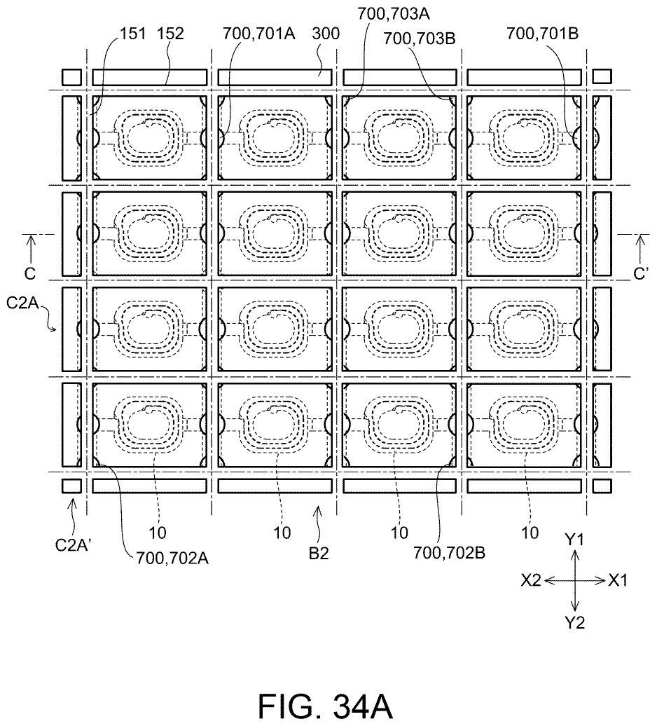

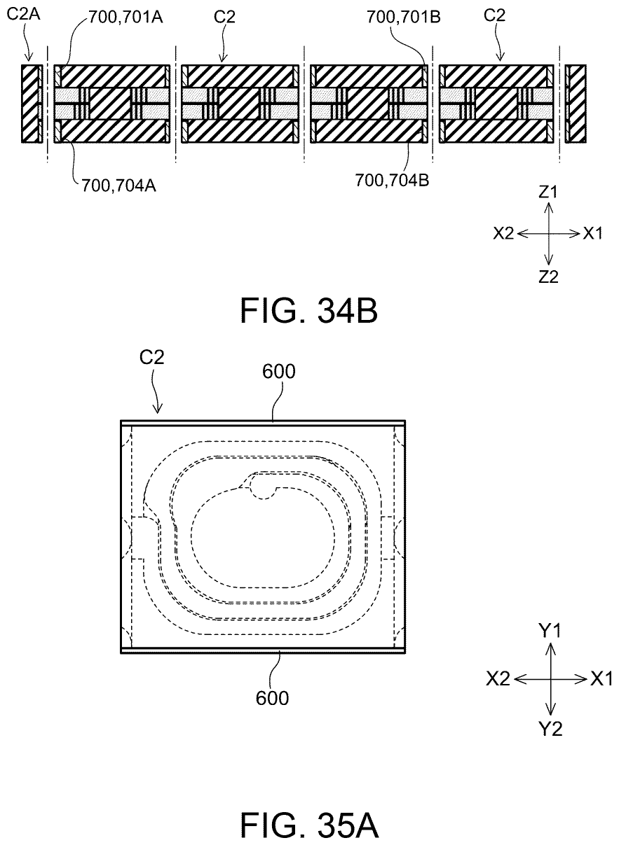

Next, the product B2 formed from the plate material is cut such that a first direction (Z1-Z2 direction) is parallel to the cut surface, and a fourth step of obtaining a plurality of first members including spiral portions (first spiral conductor portion 11, second spiral conductor portion 21) is performed. Specifically, as shown in the XY plan view of FIG. 34A and the XZ sectional view of FIG. 34B (cross section taken along line C-C′ in FIG. 34A), the product B2 is divided at predetermined positions. In this step, the product B2 is diced along respective directions of connecting portions 151 and 152. The one-dot chain lines in FIG. 34A and FIG. 34B indicate dicing lines (division lines). By dicing, a product C2 having each coil member 10 and a main body portion 30, where the body material 300 covering the coil member 10 is divided, is formed as the first member. In the product C2, the connecting portions 152 are cut off by dicing without remaining, but a part of the connecting portions 151 and a part of the support member material 700 remain.

On the other hand, a portion of the product B2 separated from the product C2 by dicing is a second member C2A. In the example shown in FIG. 34A and FIG. 34B, the second member C2A includes a part of one or both of the connecting portion 151 and the support member material 700. Further, in the second member C2A′, neither the connecting portion 151 nor the support member material 700 remains.

A part of the connecting portions 151 remaining on the product C2 side form first connecting portions 15A, 15B, 15C, and 15D. A cut surface of the first connecting portion 15A exposed from a cut surface of the body material 300 becomes an exposed lead-out surface 140. A cut surface of the first connecting portion 15B exposed from the cut surface of the body material 300 forms a dummy end surface portion 71E. A cut surface of the first connecting portion 15C exposed from the cut surface of the body material 300 forms a dummy end surface portion 72E. A cut surface of the first connecting portion 15D exposed from the cut surface of the body material 300 forms an exposed lead-out surface 240.

Further, a part of the support member material 700 remaining on the product C2 side forms the support members 701A, 701B, 702A, 702B, 703A, 703B, 704A, 704B, 705A, 705B, 706A, and 706B. A cut surface of the support member material 700 exposed from a cut surface of the body material 300 forms an exposed support surface 70B (first exposed surface 70C). Further, when the support member material 700 has a planar portion, such as a cylindrical shape, that contacts the support substrate P or the cavity C, the planar portion is exposed from the surface on the Z1 side and the surface on the Z2 side in the Z1-Z2 direction of the body material 300. The exposed planar portion forms an exposed support surface 70B (second exposed surface 70D).

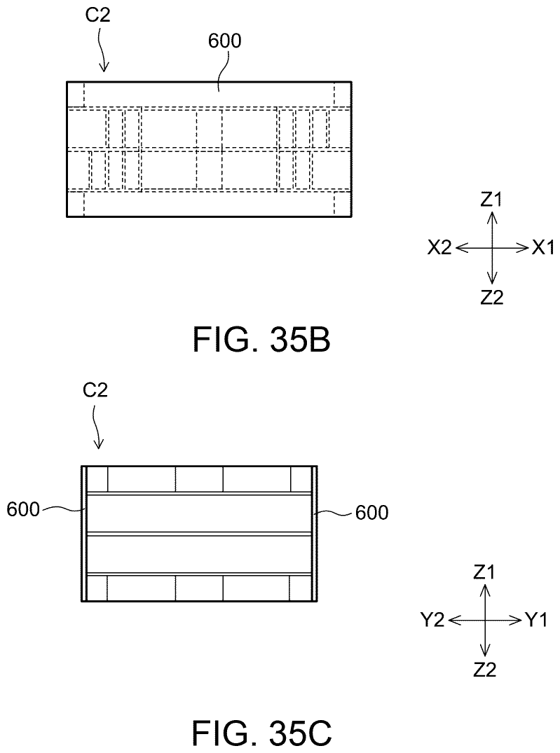

Next, as shown in the XY plan view of FIG. 35A, the XZ plan view of FIG. 35B, and the YZ plan view of FIG. 35C, an insulating cover 600 is applied to some surfaces of the product C2. The surfaces to which the insulating cover 600 is applied are outer surfaces of the product C2 other than surfaces on which electrodes are formed in a later step. In the present embodiment, the insulating cover 600 is applied to outer surfaces other than outer surfaces exposing the exposed lead-out surfaces 140 and 240 of the product C2.

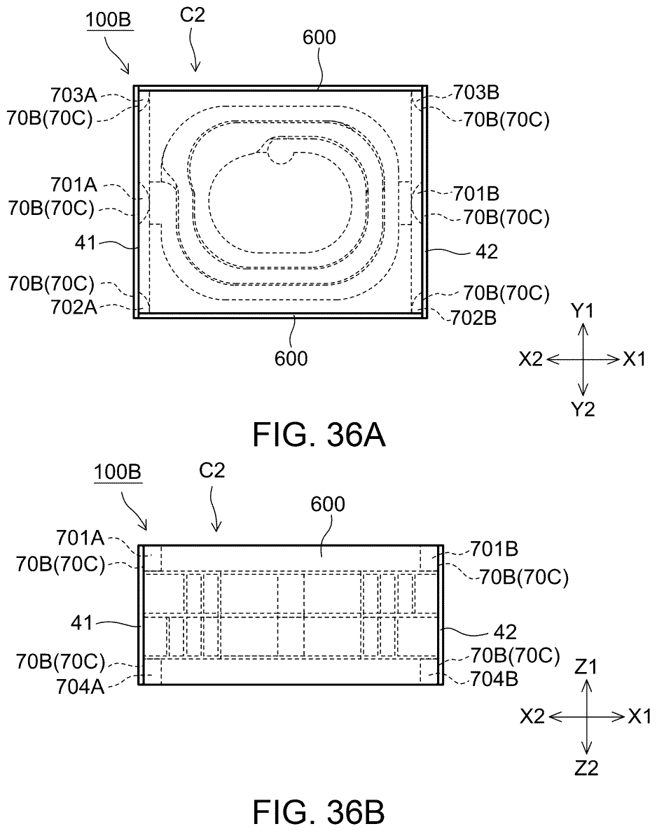

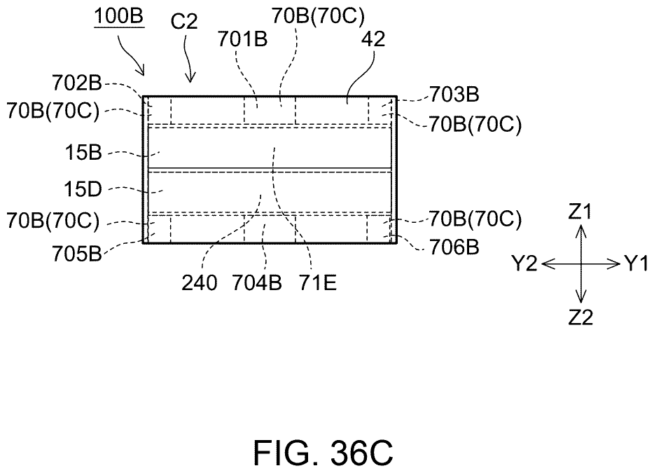

Next, as shown in the XY plan view of FIG. 36A, the XZ plan view of FIG. 36B, and the YZ plan view of FIG. 36C, external electrodes, namely a first terminal member 41 and a second terminal member 42, are formed on conductive surfaces of the product C2, where are not covered with the insulating cover 600 (fifth step). The method of forming the first terminal member 41 and the second terminal member 42 is not limited, and examples include a plating process and a printing process using conductive paste. As a result, a coil component 100B according to the present embodiment is manufactured.

The first terminal member 41 is joined not only to the exposed lead-out surface 140 and the dummy end surface portion 72E, but also to the exposed support surfaces 70B of the support member 701A, support member 702A, support member 703A, support member 704A, support member 705A, and support member 706A. The second terminal member 42 is joined to not only to the exposed lead-out surface 240 and the dummy end surface portion 71E, but also the exposed support surfaces 70B of the support member 701B, support member 702B, support member 703B, support member 704B, support member 705B, and support member 706B. This achieves improvement in DCR (Direct Current Resistance) due to reduced contact resistance between the first terminal member 41 and the second terminal member 42, and enhances the reliability of the coil component 100B due to improved bonding strength between the first terminal member 41 and the second terminal member 42.

### (Method for Manufacturing Coil Component 100C)

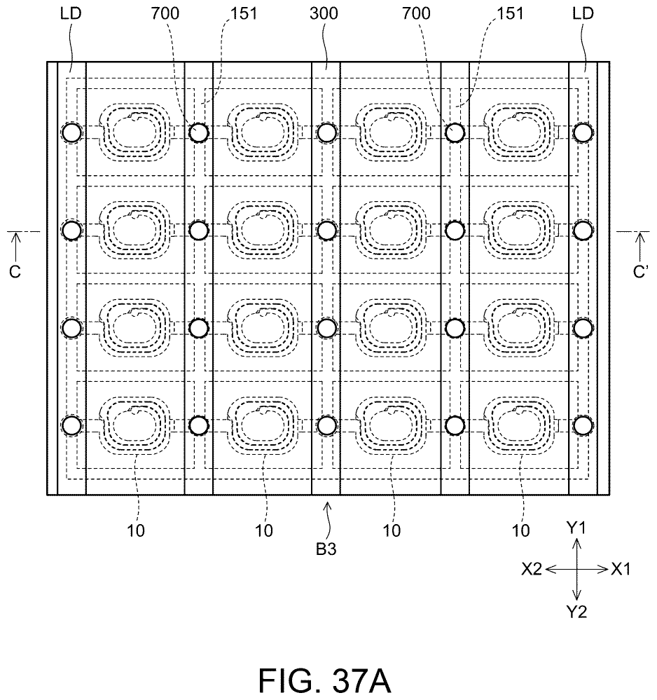

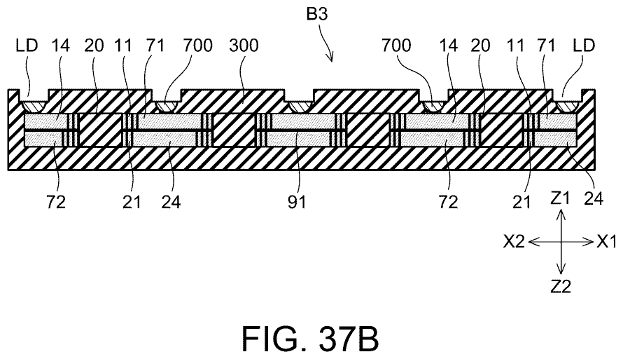

FIG. 37A to FIG. 40C are explanatory diagrams illustrating an example of a method for manufacturing the coil component 100C according to the third embodiment.

In the method for manufacturing the coil component 100C according to the third embodiment, the process from forming the coil member 10 to the shape forming process of the body material 300 that surrounds the coil member 10 with a material containing magnetic material is the same as the method for manufacturing the coil component 100A according to the first embodiment, and therefore description thereof is omitted. In the method for manufacturing the coil component 100C according to the third embodiment, the product obtained by the shape forming process (third step) of the body material 300 is referred to as product B3.

After the shape forming process (third step) of the body material 300, as shown in the XY plan view of FIG. 37A and the XZ cross-sectional view of FIG. 37B (cross section along line C-C′ in FIG. 37A), as part of the fourth step, the product B3 is half-cut at a predetermined position. In this step, the product B3 is half-cut along the connecting portion 151 to a depth where the support member material 700 is exposed from the body material 300. The width of the half-cut is greater than the width of the support member material 700. As a result, a linear recess LD extending in the second direction (Y1-Y2 direction) orthogonal to the first direction (Z1-Z2 direction) and recessed toward the Z2 side in the Z1-Z2 direction is formed, and the support member material 700 is exposed from the bottom surface of the linear recess LD.

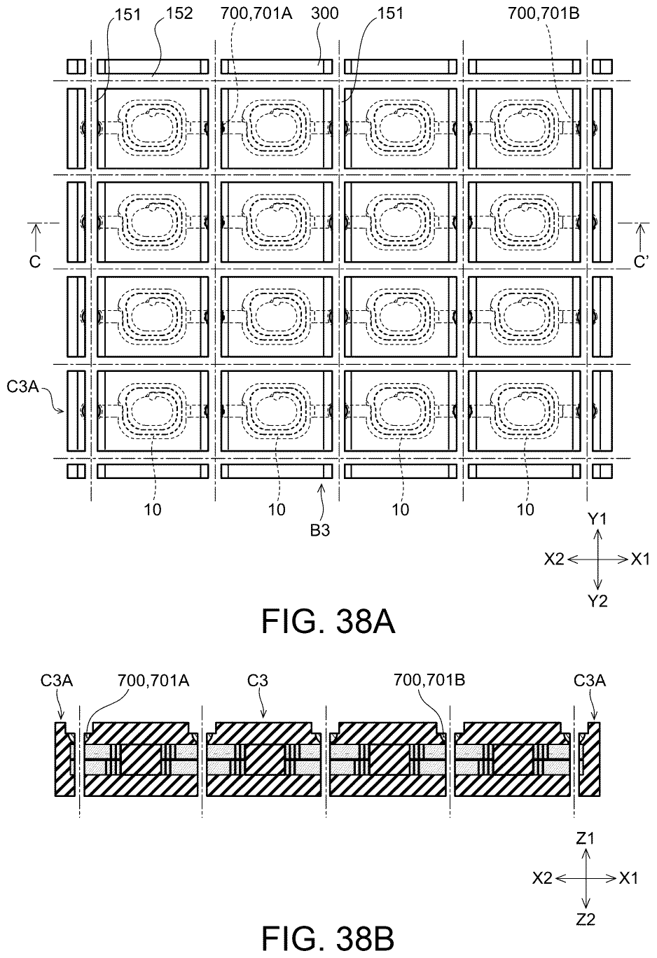

Next, as shown in the XY plan view of FIG. 38A and the XZ cross-sectional view of FIG. 38B (cross section along line C-C′ in FIG. 38A), as another part of the fourth step, the product B3 is divided at a predetermined position (division line). In this step, along the extension direction (Y1-Y2 direction) of the linear recess LD formed in the previous step, the product B3 is diced (full-cut) so that the width of the portion to be removed by dicing (for example, the blade width or the region between two dicing positions) is narrower than the width of the bottom surface of the linear recess LD. The division line is set at or near the center in the width direction (X1-X2 direction) of the bottom surface of the linear recess LD. The one-dot chain lines in FIG. 38A and FIG. 38B indicate the division lines for dicing. By dicing, a plurality of first members (products C3) are formed, each including the coil member 10 and the main body portion 30 obtained by dividing the body material 300.

In the product C3, the connecting portions 151 and the connecting portions 152 are cut off by dicing without remaining, but a part of the support member material 700 remains. On the other hand, in a portion that does not become the product C3 by dicing (for example, the second member C3A shown in FIG. 38A and FIG. 38B), at least one of the connecting portions 151, 152 and the support member material 700 may remain.

The part of the support member material 700 remaining in the product C3 side forms support members 701A and 701B. A cut surface of the support member material 700 exposed from the cut surface of the body material 300 forms an exposed support surface 70B (first exposed surface 70C) of the support members 701A and 701B. A cut surface of the first lead-out section 14 exposed from the cut surface of the body material 300 forms an exposed lead-out surface 140, a cut surface of the first dummy conductor portion 72 forms a dummy end surface portion 72E, a cut surface of the second lead-out section 24 forms an exposed lead-out surface 240, and a cut surface of the second dummy conductor portion 71 forms a dummy end surface portion 71E.

Further, since the dicing width is narrower than the width of the linear recess LD, and the bottom surface of the linear recess LD is diced at or near its center, although the bottom surface of the linear recess LD is divided, the support member material 700 remains exposed from the divided bottom surface. This exposed surface of the support member material 700 forms an exposed support surface 70B (second exposed surface 70D) of the support members 701A and 701B. That is, the first member (product C3) has a stepped portion based on the linear recess LD, and the lower surface of the stepped portion (derived from the bottom surface of the linear recess LD) exposes the support members 701A and 701B (exposed support surface 70B).

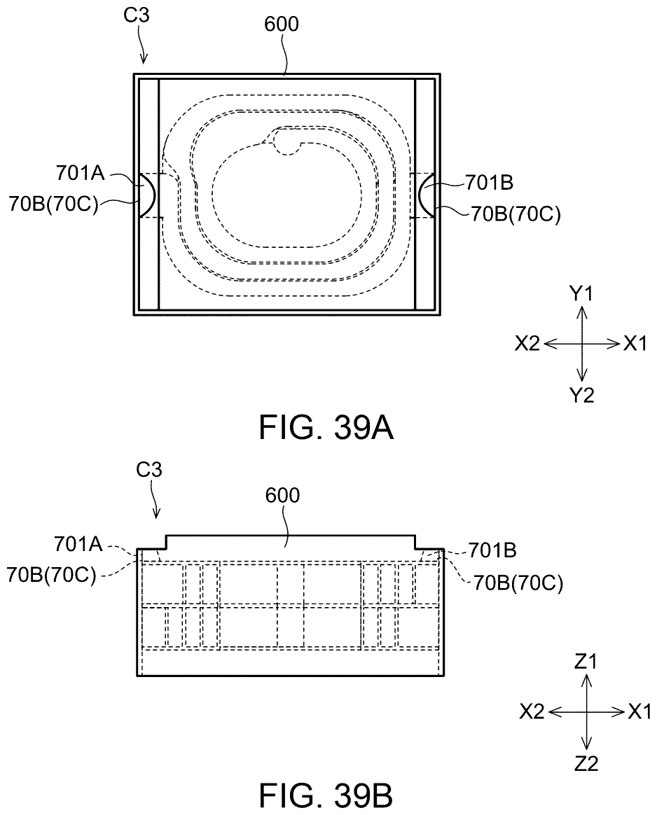

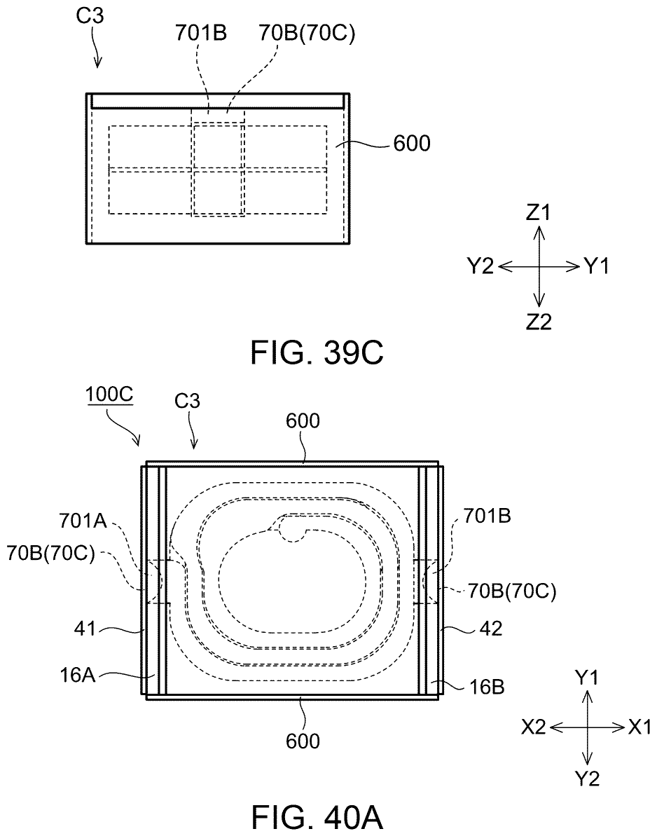

Next, as shown in the XY plan view of FIG. 39A, the XZ plan view of FIG. 39B, and the YZ plan view of FIG. 39C, an insulating cover 600 is applied to some surfaces of the product C3. The surfaces, to which the insulating cover 600 is applied, may be the entire outer surfaces of the product C3 or only the outer surfaces where electrodes are not formed in a later step. In this embodiment, the insulating cover 600 is applied to the entire outer surfaces of the product C3.

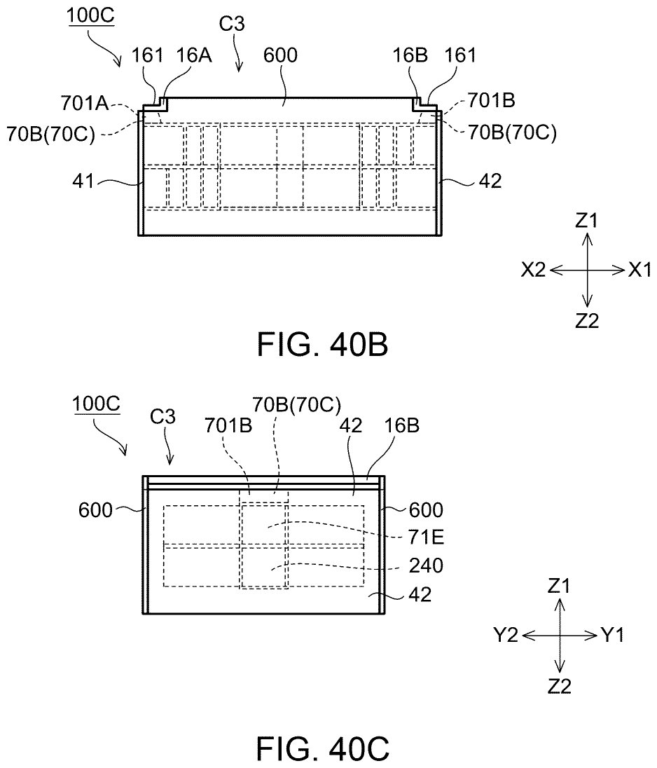

Next, as shown in the XY plan view of FIG. 40A, the XZ plan view of FIG. 40B, and the YZ plan view of FIG. 40C, external electrodes 16A and 16B are formed on the outer surfaces of the product C3 where the exposed support surface 70B is exposed (fifth step). The method of forming the external electrodes 16A and 16B is not limited, and examples include a plating process and a printing process.

The external electrodes 16A and 16B are formed in the recess formed by dicing the bottom surface of the linear recess LD of the product C3. That is, the external electrode 16A contacts the exposed conductive surface of the exposed support surface 70B of the support member 701A, and the external electrode 16B contacts the exposed conductive surface of the exposed support surface 70B of the support member 701B, and both extend in the Y1-Y2 direction. The external electrodes 16A and 16B are provided so as to span two outer surfaces 30c and 30d of the main body portion 30, which are parallel to the XZ plane.

Further, since the external electrodes 16A and 16B are formed in the recess formed by dicing the bottom surface of the linear recess LD, the external electrodes 16A and 16B have a first recess part 161 recessed toward the Z2 side in the Z1-Z2 direction along the recess. As a result, the coil component 100C according to this embodiment is manufactured.

Next, if necessary, the first terminal member 41 and the second terminal member 42 are formed. When the insulating cover 600 is applied to the entire outer surfaces of the product C3, the terminal members are formed after the insulating cover 600 is removed from the portions where the first terminal member 41 and the second terminal member 42 are to be formed.

Here, for further reducing the mounting area of the coil component 100C, the first terminal member 41 and the second terminal member 42 may be omitted. In this case, from the perspective of improving surface insulation and reliability of the coil component 100C, the outer surfaces 30a and 30b may be brought into contact with the insulating cover 600 (outer cover 60). That is, the first terminal member 41 and the second terminal member 42 shown in FIG. 40A to FIG. 40C may be replaced with the insulating cover 600. The point that the first terminal member 41 and the second terminal member 42 may be omitted is similarly applicable to other embodiments including the external electrodes 16A and 16B.

### (Method for Manufacturing Coil Component 100D)

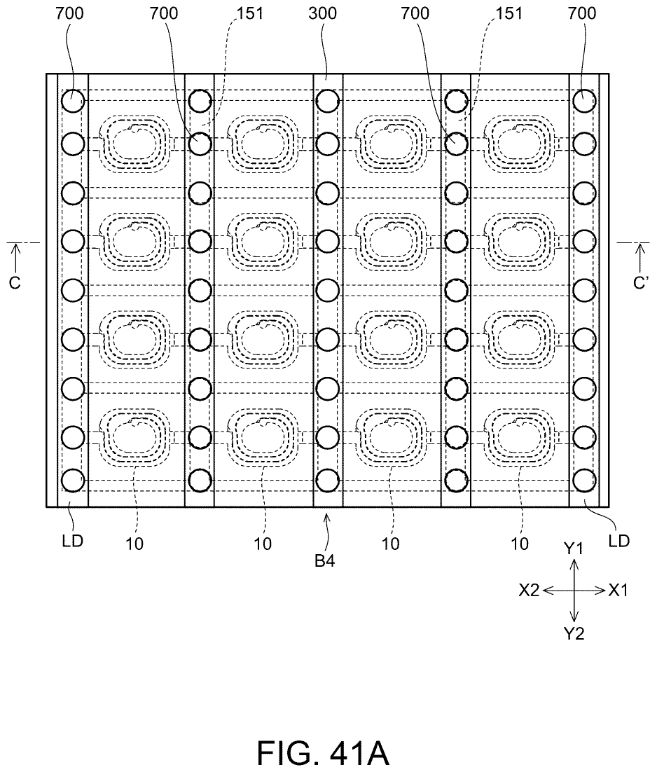

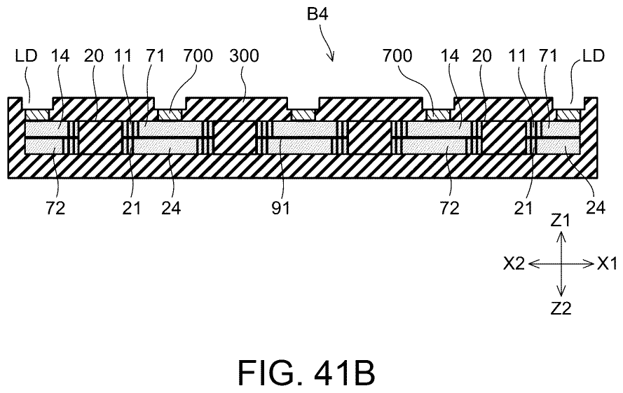

FIG. 41A to FIG. 44C are explanatory diagrams illustrating an example of a method for manufacturing the coil component 100D according to the fourth embodiment.

In the method for manufacturing the coil component 100D according to the fourth embodiment, the processes from the first step to the third step, i.e., from the process of forming the coil member 10 to the shape forming process of the body material 300, which surrounds the coil member 10 with a material containing magnetic material, are the same as those in the method for manufacturing the coil component 100C according to the third embodiment, except for the arrangement of the support member material 700, and therefore description thereof is omitted. In the method for manufacturing the coil component 100D according to the fourth embodiment, the arrangement of the support member material 700 is the same as the arrangement of the support member material 700 on both sides in the Z1-Z2 direction of the connecting portion 151 in the method for manufacturing the coil component 100B according to the second embodiment. In the method for manufacturing the coil component 100D according to the fourth embodiment, the product obtained by the shape forming process (third step) of the body material 300, which is formed of a plate material, is referred to as product B4.

After the shape forming process (third step) of the body material 300, as shown in the XY plan view of FIG. 41A and the XZ cross-sectional view of FIG. 41B (cross section along line C-C′ in FIG. 41A), the product B4 is half-cut at a predetermined position (as part of the fourth step). In this step, the product B4 is half-cut along the connecting portion 151 to a depth where the support member material 700 is exposed from the body material 300. The width of the half-cut is greater than the width of the support member material 700. As a result, a linear recess LD extending in the Y1-Y2 direction and recessed toward the Z2 side in the Z1-Z2 direction is formed, and the support member material 700 is exposed from the bottom surface of the linear recess LD.

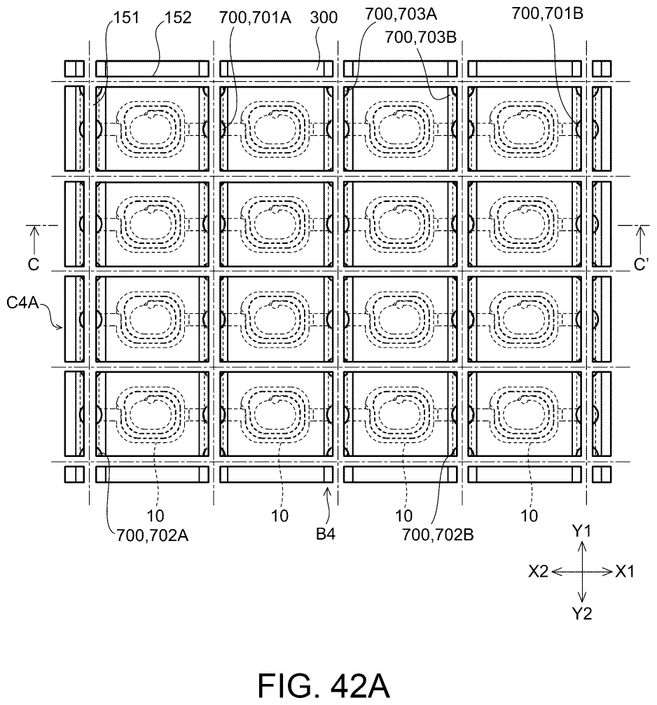

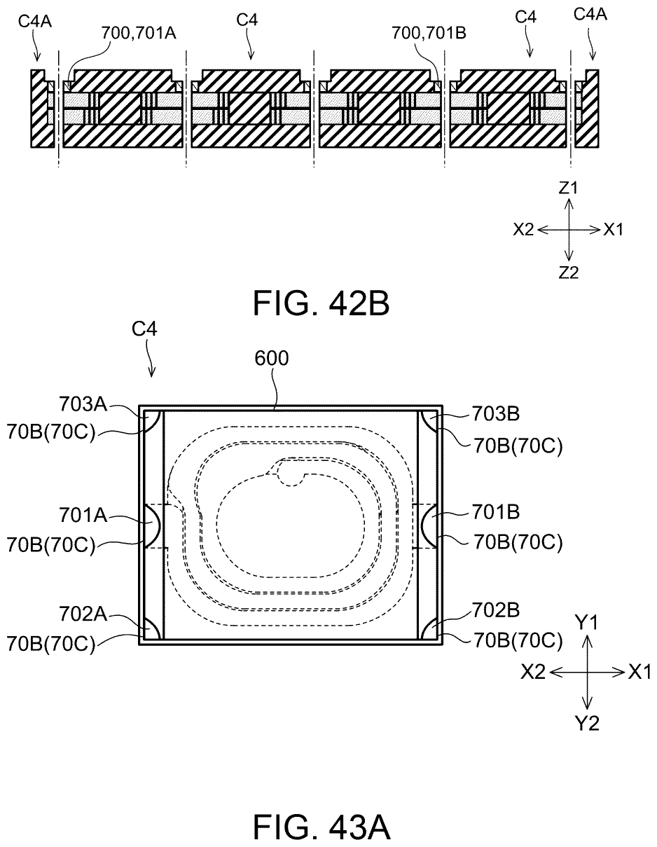

Next, as shown in the XY plan view of FIG. 42A and the XZ cross-sectional view of FIG. 42B (cross section along line C-C′ in FIG. 42A), as another part of the fourth step, the product B4 is divided at a predetermined position. In this step, along the extension direction (Y1-Y2 direction) of the linear recess LD formed in the previous step, the product B4 is diced (full-cut) so that the width of the portion to be removed by dicing is narrower than the width of the bottom surface of the linear recess LD. The division line is set at or near the center in the width direction (X1-X2 direction) of the bottom surface of the linear recess LD. The one-dot chain lines in FIG. 42A and FIG. 42B indicate the dicing lines (division lines). By dicing, a plurality of first members (products C4) are formed, each including the coil member 10 and the main body portion 30 obtained by dividing the body material 300.

In the product C4, the connecting portions 152 are cut off by dicing without remaining, but a part of the connecting portions 151 and a part of the support member material 700 remain. On the other hand, in a portion that does not form the product C4 by dicing (for example, second member C4A shown in FIG. 42A and FIG. 42B), at least partially the connecting portions 151 and the connecting portions 152 and the support member material 700 may remain.

The part of the connecting portion 151 remaining in the product C4 side forms the first connecting portions 15A, 15B, 15C, and 15D. A cut surface of the first connecting portion 15A exposed from the cut surface of the body material 300 forms an exposed lead-out surface 140. A cut surface of the first connecting portion 15B forms a dummy end surface portion 71E. A cut surface of the first connecting portion 15C forms a dummy end surface portion 72E. A cut surface of the first connecting portion 15D forms an exposed lead-out surface 240.

Further, the part of the support member material 700 remaining on the product C4 side forms the support members 701A, 701B, 702A, 702B, 703A, and 703B. A cut surface of the support member material 700 exposed from the cut surface of the body material 300 forms an exposed support surface 70B (first exposed surface 70C) of the support members 701A, 701B, 702A, 702B, 703A, and 703B. In the case where the support member material 700 has a planar portion in contact with a support substrate P or a cavity C of, for example, a cylindrical shape, the planar portion is exposed from the Z1-side surface of the body material 300 in the Z1-Z2 direction, and this exposed planar portion forms an exposed support surface 70B (second exposed surface 70D).

Further, since the dicing width is narrower than the width of the linear recess LD, and the bottom surface of the linear recess LD is diced at or near its center, although the bottom surface of the linear recess LD is divided, the support member material 700 remains exposed from the divided bottom surface. The exposed surface of the support member material 700 forms exposed support surfaces 70B (second exposed surfaces 70D) of the support members 701A, 701B, 702A, 702B, 703A, and 703B.

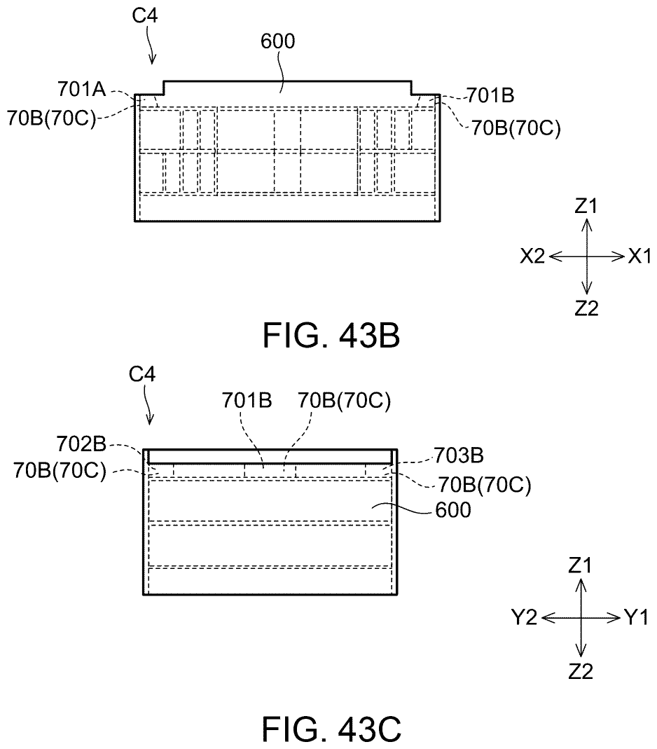

Next, as shown in the XY plan view of FIG. 43A, the XZ plan view of FIG. 43B, and the YZ plan view of FIG. 43C, an insulating cover 600 is applied to some surfaces of the product C4. The surfaces, to which the insulating cover 600 is applied, may be the entire outer surfaces of the product C4 or only the outer surfaces where electrodes are not formed in a later step. In this embodiment, the insulating cover 600 is applied to the entire outer surfaces of the product C4.

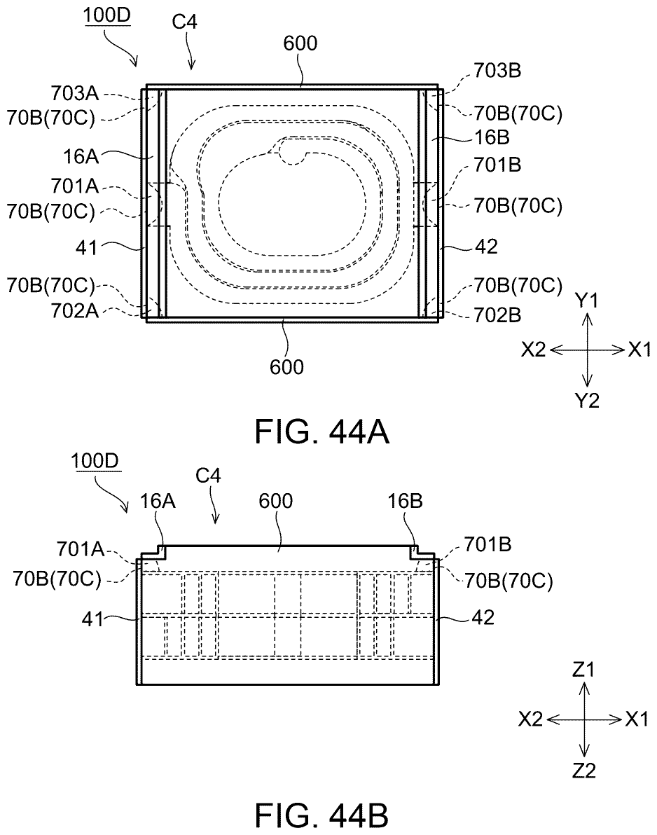

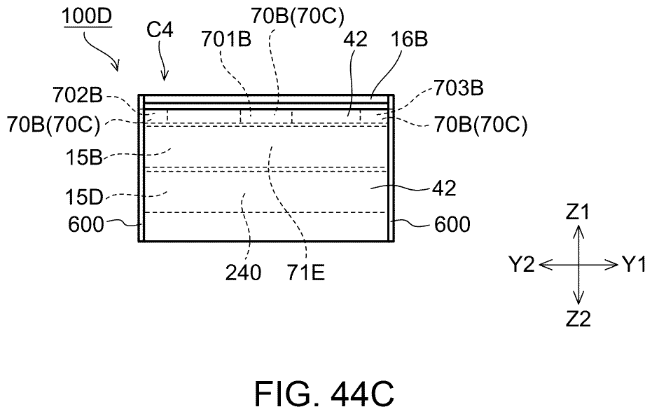

Next, as shown in the XY plan view of FIG. 44A, the XZ plan view of FIG. 44B, and the YZ plan view of FIG. 44C, external electrodes 16A and 16B are formed on the outer surfaces of the product C4 where the insulating cover 600 is not applied. The method of forming the external electrodes 16A and 16B is not limited, and examples include a plating process and a printing process.

The external electrodes 16A and 16B are formed in the recess formed by dicing the bottom surface of the linear recess LD of the product C4. That is, the external electrode 16A contacts the exposed conductive surfaces of the exposed support surfaces 70B of the support members 701A, 702A, and 703A, and the external electrode 16B contacts the exposed conductive surfaces of the exposed support surfaces 70B of the support members 701B, 702B, and 703B, and both extend in the Y1-Y2 direction. The external electrodes 16A and 16B are provided so as to span two outer surfaces 30c and 30d of the main body portion 30, which are parallel to the XZ plane.

Further, since the external electrodes 16A and 16B are formed in the recess formed by dicing the bottom surface of the linear recess LD, the external electrodes 16A and 16B have a first recess part 161 recessed toward the Z2 side in the Z1-Z2 direction along the recess. As a result, the coil component 100D according to this embodiment is manufactured.

Next, if necessary, first terminal member 41 and second terminal member 42 are formed. When the insulating cover 600 is applied to the entire outer surfaces of the product C4, the terminal members are formed after the insulating cover 600 is removed from the portions where the first terminal member 41 and the second terminal member 42 are to be formed.

### (Method for Manufacturing Coil Component 100E)

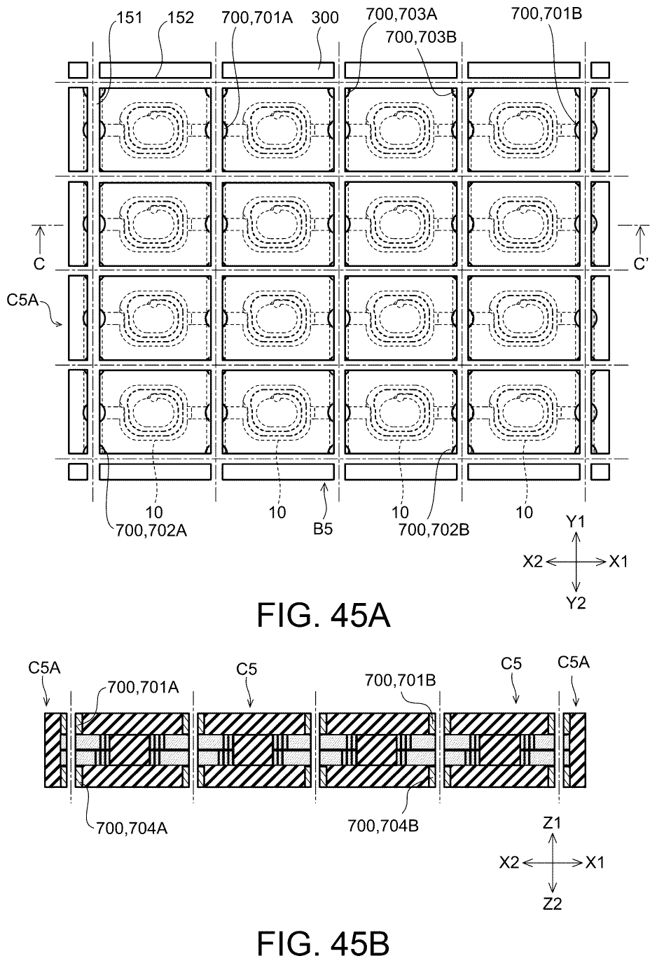

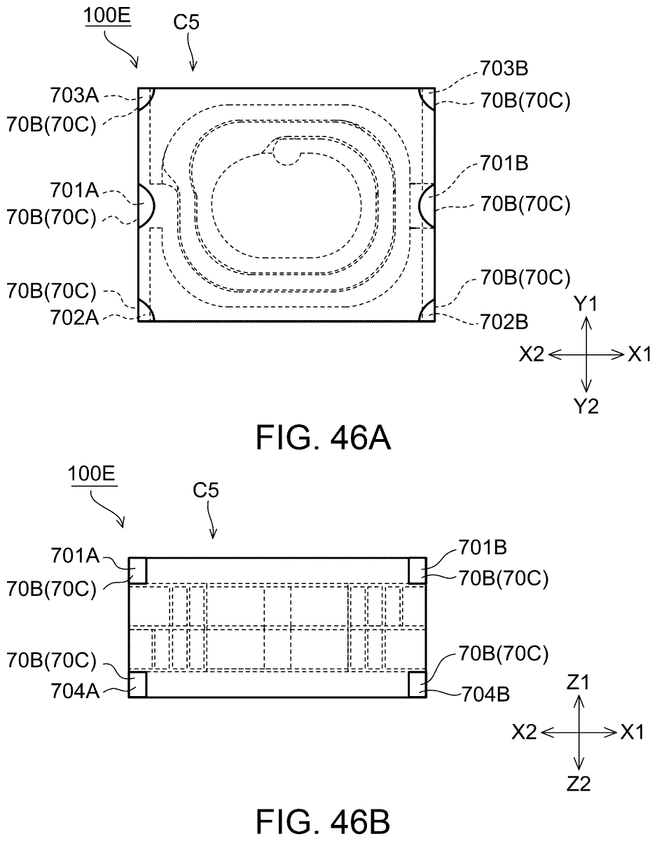

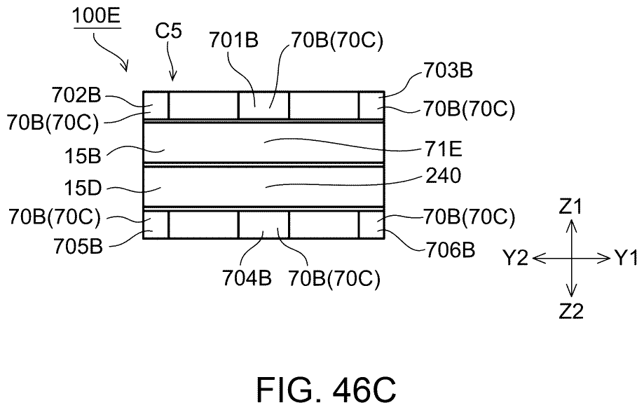

FIG. 45A to FIG. 46C are explanatory diagrams illustrating an example of a method for manufacturing the coil component 100E according to the fifth embodiment.

In the method for manufacturing the coil component 100E according to the fifth embodiment, the processes from the process of forming the coil member 10 to the shape forming process of the body material 300, which surrounds the coil member 10 with a material containing magnetic material, are the same as those in the method for manufacturing the coil component 100B according to the second embodiment, and therefore description thereof is omitted. In the method for manufacturing the coil component 100E according to the fifth embodiment, the product obtained by the shape forming process of the body material 300 is referred to as product B5.

After the shape forming process of the body material 300, a fourth step is performed in which the product B5 formed from the plate material is cut so that the first direction (Z1-Z2 direction) is parallel to the cut surface, thereby obtaining a plurality of first members including the spiral portions (first spiral conductor portion 11 and second spiral conductor portion 21). Specifically, as shown in the XY plan view of FIG. 45A and the XZ cross-sectional view of FIG. 45B (cross section along line C-C′ in FIG. 45A), the product B5 is divided at predetermined positions. In this step, the product B5 is diced along the respective directions of the connecting portions 151 and the connecting portions 152. The one-dot chain lines in FIG. 45A and FIG. 45B indicate the dicing lines. By dicing, products C5 are formed, each including the coil member 10 and the main body portion 30 obtained by dividing the body material 300.

In the product C5, the connecting portions 152 are cut off by dicing without remaining, but a part of the connecting portions 151 and a part of the support member material 700 remain. On the other hand, in a portion that does not form the product C5 by dicing (for example, the second member C5A shown in FIG. 45A and FIG. 45B), at least one of the connecting portions 151, the connecting portions 152 and the support member material 700 may remain.

The part of the connecting portions 151 remaining in the product C5 side forms the first connecting portions 15A, 15B, 15C, and 15D. A cut surface of the first connecting portion 15A exposed from the cut surface of the body material 300 forms an exposed lead-out surface 140. A cut surface of the first connecting portion 15B forms a dummy end surface portion 71E. A cut surface of the first connecting portion 15C forms a dummy end surface portion 72E. A cut surface of the first connecting portion 15D forms an exposed lead-out surface 240.

Further, the part of the support member material 700 remaining in the product C5 side forms support members 701A, 701B, 702A, 702B, 703A, 703B, 704A, 704B, 705A, 705B, 706A, and 706B. A cut surface of the support member material 700 exposed from the cut surface of the body material 300 forms a support exposed surface 70B (first exposed surface 70C). When the support member material 700 has a planar portion in contact with a support substrate P or a cavity C of, for example, a cylindrical shape, the planar portion is exposed from the Z1-side surface and the Z2-side surface of the body material 300 in the Z1-Z2 direction, and the exposed planar portion forms an exposed support surface 70B (second exposed surface 70D).

As shown in the XY plan view of FIG. 46A, the XZ plan view of FIG. 46B, and the YZ plan view of FIG. 46C, in this embodiment, the outer surfaces along the YZ plane, which are the dicing cut surfaces of the product C5, are directly used as electrode surfaces for soldering during mounting, utilizing the exposed lead-out surface 140, the dummy end surface portion 72E, the support exposed surface 70B, the exposed lead-out surface 240, and the dummy end surface portion 71E. Accordingly, the coil component 100E according to this embodiment is manufactured.

### (Method for Manufacturing Coil Component 100F)

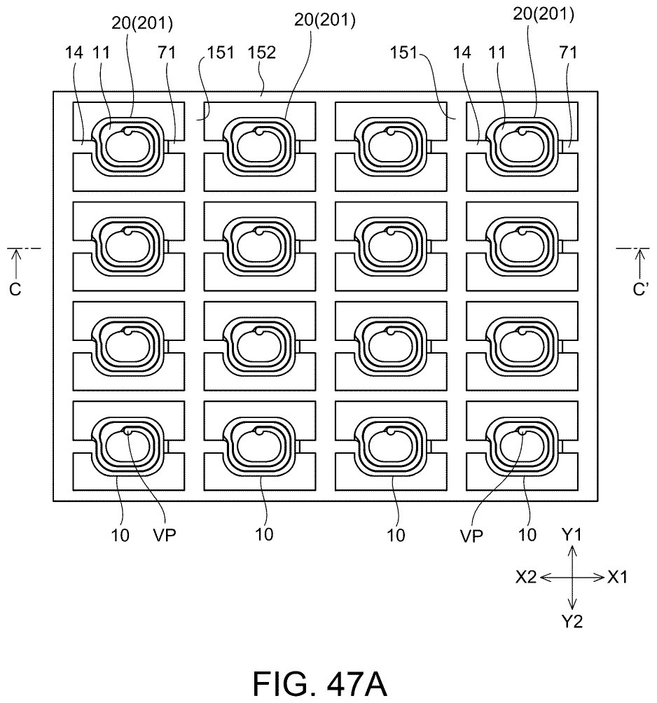

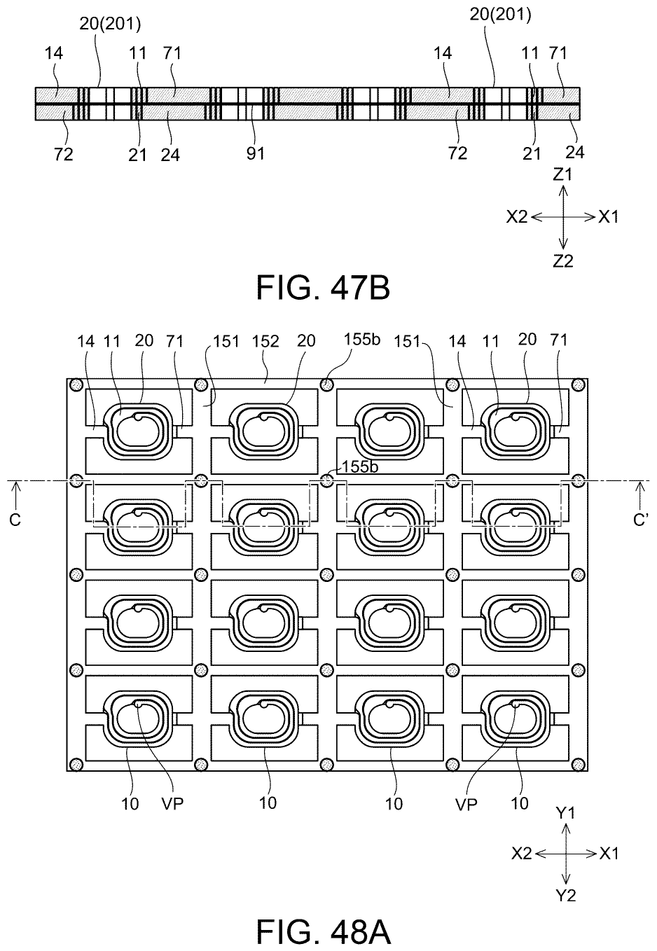

FIG. 47A to FIG. 55C are explanatory diagrams illustrating an example of a method for manufacturing the coil component 100F according to the sixth embodiment.

As shown in the XY plan view of FIG. 47A and the XZ cross-sectional view of FIG. 47B (cross section along line C-C′ in FIG. 47A), a plurality of spiral portions (first spiral conductor portion 11 and second spiral conductor portion 21) are formed. Specifically, the first spiral conductor portion 11 is formed on one surface of an insulating sheet substrate 91 (specifically, the surface on Z1 side in Z1-Z2 direction), and the second spiral conductor portion 21 is formed on the other surface of the sheet substrate 91 (specifically, the surface on Z2 side in Z1-Z2 direction). The process for forming the first spiral conductor portion and second spiral conductor portion is not particularly limited. For example, they can be formed by a plating process. In this embodiment, via members VP as well as the first lead-out section 14 and the second lead-out section 24 are also formed simultaneously in this process.

When this step includes a plating process, the coil conductor portion 20 including the first conductor portion 201 includes a portion formed of a plating layer. Further, the first dummy conductor portion 72 is formed by this plating process.

In addition, by the same plating process, connecting portions 151 extending in the Y1-Y2 direction and connecting portions 152 extending in the X1-X2 direction are formed around the coil conductor portion 20 as viewed in the first direction (Z1-Z2 direction). The connecting portions 151 and the connecting portions 152 are provided in a lattice pattern at intermediate positions between two adjacent coil conductor portions 20 and also provided so as to surround the outer periphery of the entire region of the plurality of coil conductor portions 20. The connecting portions 151 and the connecting portions 152 structurally connect the plurality of coil conductor portions 20 to enhance shape retention and are also used as current supply portion in the plating process. Lands 155 may be formed at the intersections of the connecting portions 151 and the connecting portions 152. Thus, in the first step, a conductor pattern including multiple spiral portions (first spiral conductor portion 11 and second spiral conductor portion 21) and connecting portions (connecting portions 151, connecting portions 152) of the multiple spiral portions is formed.

In next step, at least a part of the sheet substrate 91 is removed. Specifically, as viewed in the first direction (Z1-Z2 direction), the sheet substrate 91 is removed so as to include a region surrounded by the inner periphery of the first spiral conductor portion 11. The specific removal process of the sheet substrate 91 is the same as that described in the previous manufacturing methods.

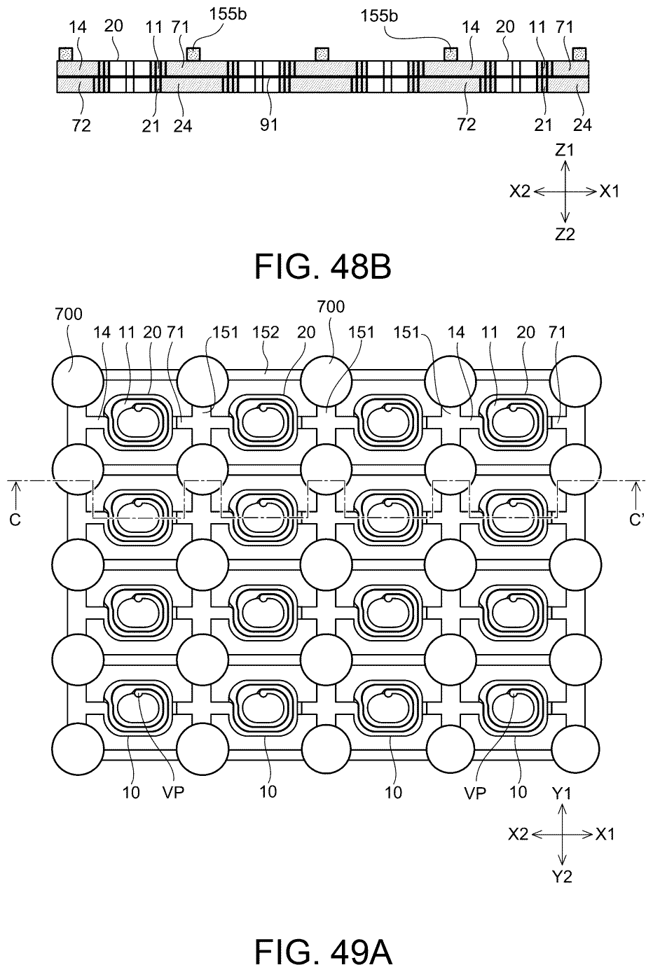

Next, as shown in the XY plan view of FIG. 48A and the XZ cross-sectional view of FIG. 48B (cross section along line C-C′ in FIG. 48A), an adhesive 155b is coated on the connecting portions 151. The adhesive 155b is, for example, a thermosetting adhesive. The application position of the adhesive 155b is the intersections of the connecting portions 151 and the connecting portions 152. When lands 155 are provided at the intersections of the connecting portions 151 and the connecting portions 152, the adhesive 155b is applied on the lands 155. The method of applying the adhesive 155b is not limited. For example, a method of transferring the adhesive 155b from multiple pins to the application positions of the connecting portions 151 by attaching the adhesive 155b to the tips of the pins, or a method of applying the adhesive by screen printing using a mask such as a metal mask can be employed.

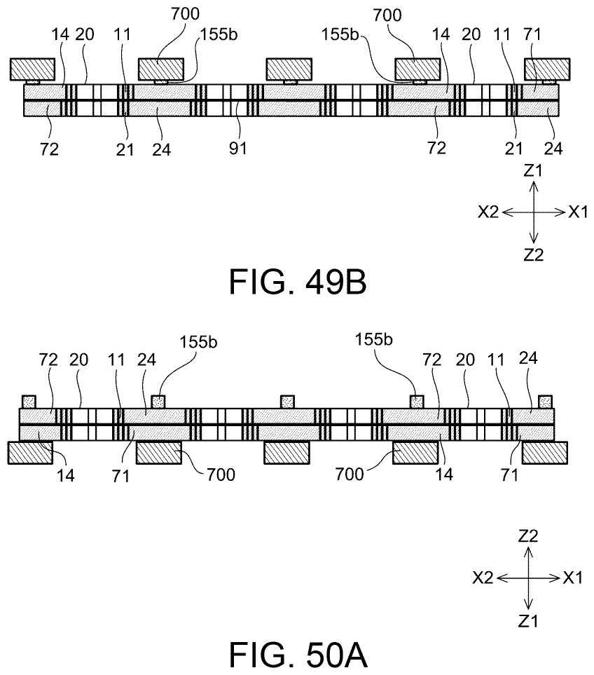

Next, as shown in the XY plan view of FIG. 49A and the XZ cross-sectional view of FIG. 49B (cross section along line C-C′ in FIG. 49A), the support member material 700 is mounted on top of the adhesive 155b (on Z1 side in Z1-Z2 direction) applied in the previous step (part of the second step). Accordingly, the support member material 700 extends from the connecting portions 151 and 152 toward one side in the first direction (Z1 side in Z1-Z2 direction). Support members 702A, 702B, 703A, and 703B are formed from the support member material 700 thus provided. The method of mounting the support member material 700 is not limited. For example, a vibration embedding method similar to that described in the previous manufacturing methods can be employed. The support member material 700 has a soft magnetic portion (soft magnetic support portion). The soft magnetic support portion may contain magnetic powder or may be an insulator. The composition of the soft magnetic support portion is not particularly limited. For example, a powder magnetic core formed by powder compaction or a ferrite core produced by sintering can be used. The shape of the support member material 700 can be various shapes such as spherical, cylindrical, rectangular parallelepiped, or hexagonal prism. After mounting the support member material 700, the support member material 700 is fixed to the connecting portions 151 by thermal curing or the like.

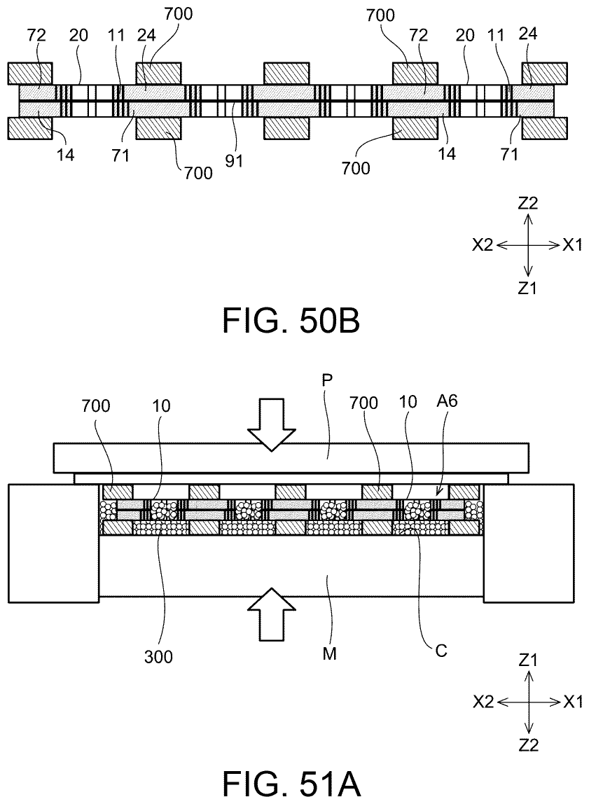

Next, as shown in the XY cross-sectional views of FIG. 50A and FIG. 50B, the application of the adhesive 155b to the connecting portion 151, the mounting and fixing of the support member material 700 performed on one surface (Z1-side in the Z1-Z2 direction) of the coil member 10 in the previous step are similarly performed on the other surface (Z2 side in Z1-Z2 direction) of the coil member 10 (another part of the second step). Support members 705A, 705B, 706A, and 706B are formed from the support member material 700 thus provided.

After fixing the support member material 700 to the connecting portions 151, an insulating coating is applied to the exposed surfaces of the connecting portions 151 and 152, the support member material 700, the first spiral conductor portion 11, and the second spiral conductor portion 21. The process for forming the insulating coating is the same as that in the previous manufacturing methods.

Next, a material containing magnetic powder is supplied to cover the conductor pattern on at least two surfaces in the first direction (Z1-Z2 direction) and is shape-formed into a plate material (third step). An example of this shape forming process is a molding process, in which the coil member 10 is surrounded by a material containing magnetic material. Specific examples of the molding process include placing a product A6 formed up to the previous step in a mold and forming by compression molding of a material containing magnetic material, or transfer molding a material containing magnetic powder or a member serving as a raw material of the material.

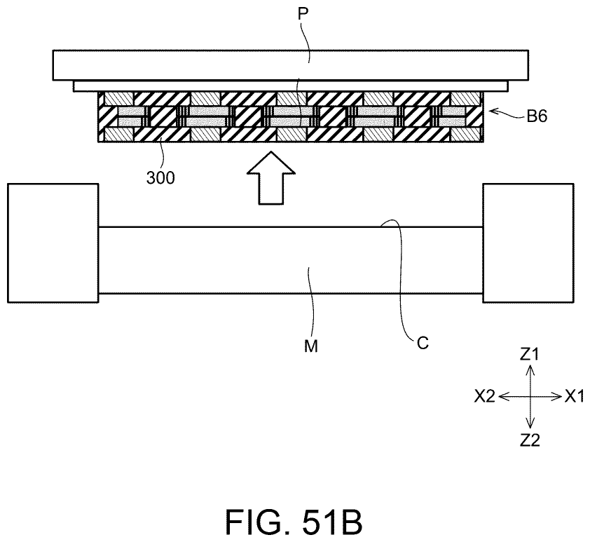

FIG. 51A and FIG. 51B schematically show the compression molding process. First, as shown in FIG. 51A, a material containing magnetic material is placed in a cavity C of a mold M, and the product A6 is mounted on a support substrate P. Next, the product A6 mounted on the support substrate P is inserted into the cavity C of the mold M and compressed between the mold M and the support substrate P. At this time, one support member material 700 is interposed between the support substrate P and the coil member 10, and the support member material 700 acts as a pillar to ensure a certain gap between the coil member 10 and the support substrate P. Also, another support member material 700 is interposed between the cavity C of the mold M and the coil member 10, and the support member material 700 acts as a pillar to ensure a certain gap between the coil member 10 and the cavity C.

In this compression molding, since the material containing magnetic material is made to flow and spread into the cavity C while a compressive force is applied between the mold M and the support substrate P, stress is applied to the product A6 during material filling. In particular, as the material flows and spreads into the cavity C, the material moves from the cavity C toward the support substrate P side, so strong stress is applied to the product A6 toward the support substrate P side. In this embodiment, since one side of the product A6 is supported by the support substrate P via the support member material 700, deformation of the product A6 is suppressed even if the product A6 is pressed toward the support substrate P side by the material. Also, in this embodiment, since the other side of the product A6 is supported by the cavity C via the support member material 700, deformation of the product A6 toward the cavity C side is suppressed. That is, positional displacement of each coil member 10 in the product A6 is effectively suppressed.

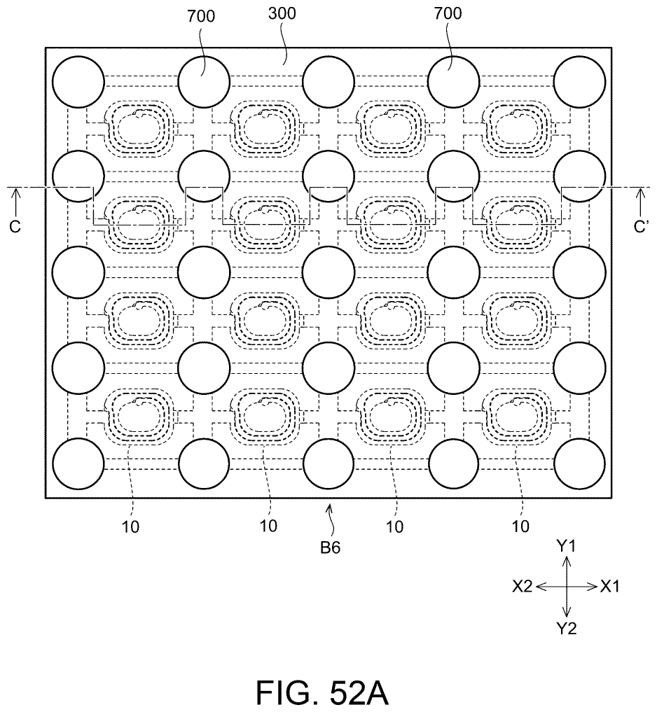

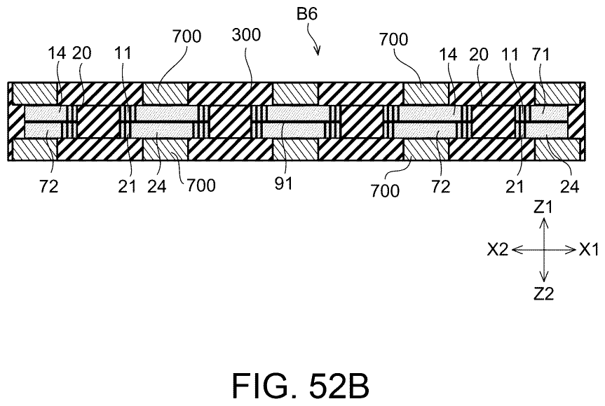

After the material containing magnetic material is filled into the cavity C, it is solidified or cured. Thereafter, demolding is performed (see FIG. 51B). FIG. 52A shows an XY plan view of the product B6 formed from the plate material and obtained after demolding, and FIG. 52B shows an XZ cross-sectional view along line C-C′ in FIG. 52A. In the product B6, the entire periphery of the product A6 is covered with the body material 300 (a material containing magnetic material that has been solidified or cured).

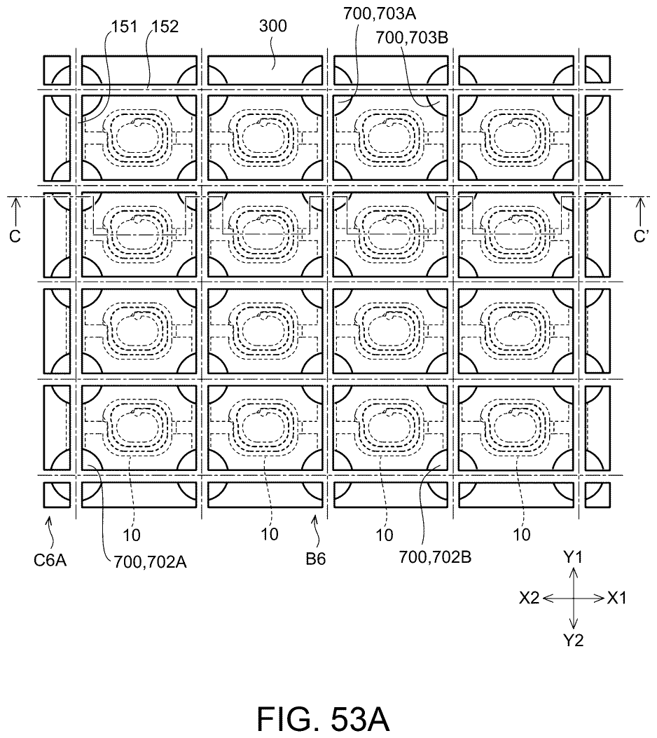

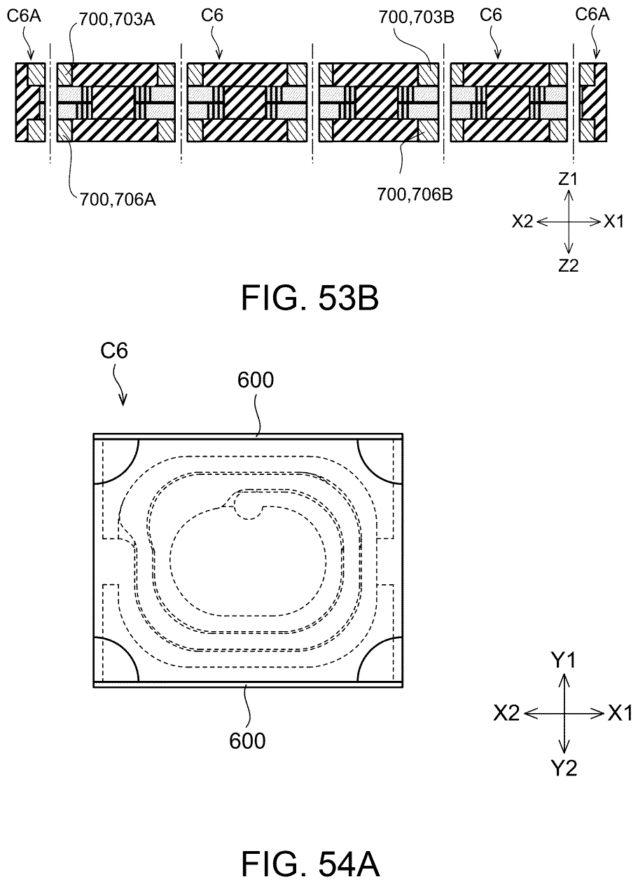

Next, the product B6 formed from the plate material is cut such that a first direction (Z1-Z2 direction) is parallel to the cut surface, and a fourth step of obtaining a plurality of first members including spiral portions (first spiral conductor portion 11, second spiral conductor portion 21) is performed. Specifically, as shown in the XY plan view of FIG. 53A and the XZ sectional view of FIG. 53B (cross section taken along line C-C′ in FIG. 53A), the product B6 is divided at predetermined positions. In this step, the product B6 is diced along respective directions of connecting portions 151 and 152. The one-dot chain lines in FIG. 53A and FIG. 53B indicate dicing lines (division lines). By dicing, a product C6 having each coil member 10 and a main body portion 30, where the body material 300 covering the coil member 10 is divided, is formed as the first member. In the product C6, the connecting portions 152 are cut off by dicing without remaining, but a part of the connecting portions 151 and a part of the support member material 700 remain. On the other hand, at least one of the connecting portions 151 and the support member material 700 may remain in a portion that did not form the product C2 through dicing (e.g., the second member C6A in FIG. 53A and FIG. 53B).

The part of the connecting portions 151 remaining in the product C6 side forms the first connecting portions 15A, 15B, 15C, and 15D. A cut surface of the first connecting portion 15A exposed from the cut surface of the body material 300 forms an exposed lead-out surface 140. A cut surface of the first connecting portion 15B forms a dummy end surface portion 71E. A cut surface of the first connecting portion 15C forms a dummy end surface portion 72E. A cut surface of the first connecting portion 15D forms an exposed lead-out surface 240.

Further, the part of the support member material 700 remaining in the product C6 side forms support members 702A, 702B, 703A, 703B, 705A, 705B, 706A, and 706B. A cut surface of the support member material 700 exposed from the cut surface of the body material 300 forms a support exposed surface 70B (first exposed surface 70C). When the support member material 700 has a planar portion in contact with a support substrate P or a cavity C of, for example, a cylindrical shape, the planar portion is exposed from the Z1-side surface and the Z2-side surface of the body material 300 in the Z1-Z2 direction, and the exposed planar portion forms an exposed support surface 70B (second exposed surface 70D).

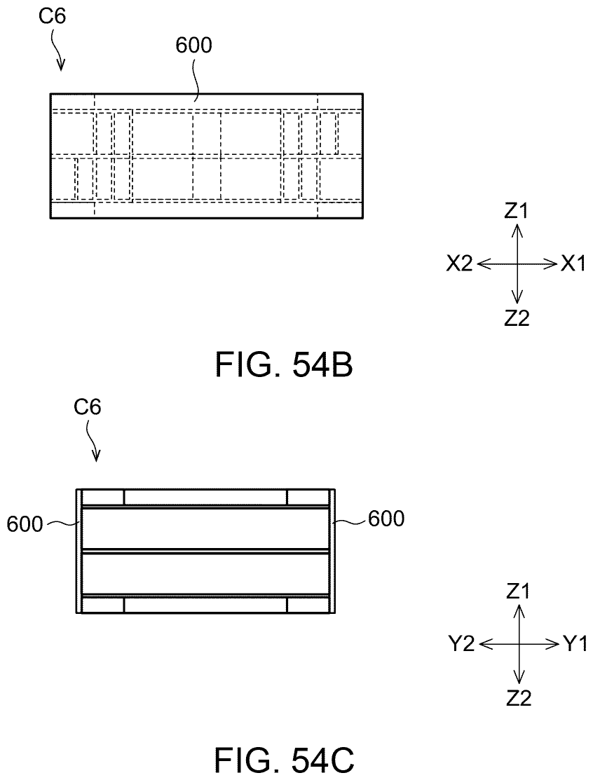

Next, as shown in the XY plan view of FIG. 54A, the XZ plan view of FIG. 54B, and the YZ plan view of FIG. 54C, an insulating cover 600 is applied to some surfaces of the product C6. The surfaces to which the insulating cover 600 is applied are outer surfaces of the product C6 other than the surfaces where electrodes are formed in a later step. In this embodiment, the insulating cover 600 is applied to outer surfaces other than the outer surfaces where the exposed lead-out surfaces 140 and 240 of the product C6 are exposed.

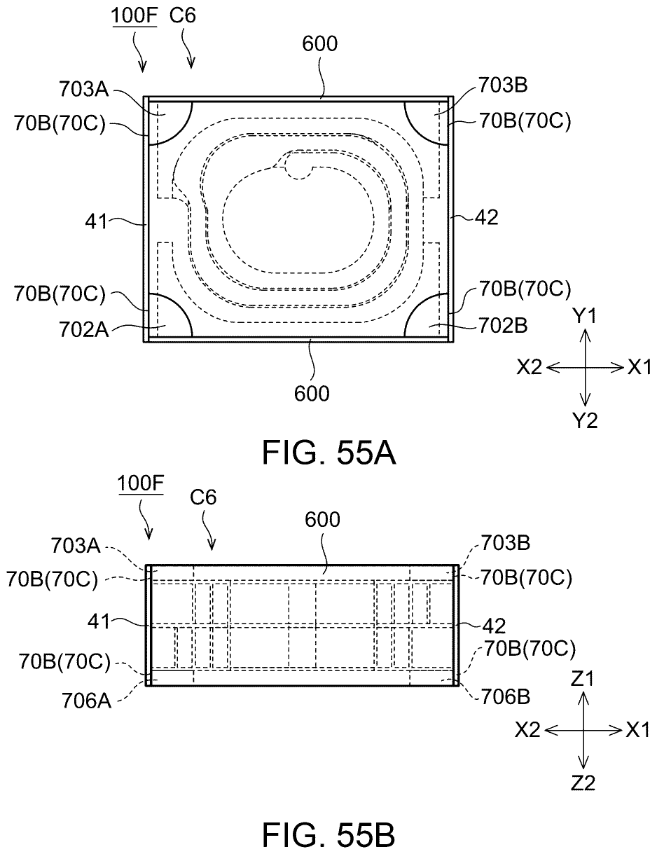

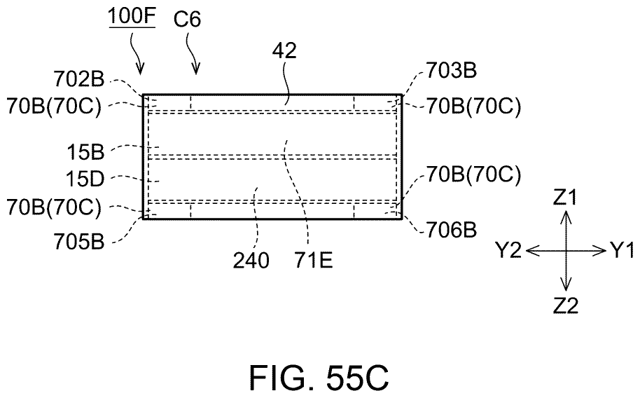

Next, as shown in the XY plan view of FIG. 55A, the XZ plan view of FIG. 55B, and the YZ plan view of FIG. 55C, first terminal member 41 and second terminal member 42, which are external electrodes, are formed on the conductive surfaces of the product C6 where the insulating coat 600 is not applied (fifth step). The method of forming the first terminal member 41 and the second terminal member 42 is not limited, and examples include a plating process and a printing process using conductive paste. As a result, the coil component 100F according to this embodiment is manufactured.

The first terminal member 41 is joined to the exposed lead-out surface 140 and the dummy end surface portion 72E as well as the support exposed surfaces 70B of the support members 702A, 703A, 705A, and 706A, and the second terminal member 42 is joined to the exposed lead-out surface 240 and the dummy end surface portion 71E as well as the support exposed surfaces 70B of the support members 702B, 703B, 705B, and 706B. This improves the direct current resistance (DCR) by reducing the contact resistance of the first terminal member 41 and the second terminal member 42 and enhances the reliability of the coil component 100F by improving the bonding strength of the first terminal member 41 and the second terminal member 42.

Further, as in this embodiment, by providing support members 702A, 702B, 703A, 703B, 705A, 705B, 706A, and 706B having soft magnetic support portions at the corners of the main body portion 30, magnetic flux can easily pass through the corner parts, thereby improving the magnetic characteristics (inductance) of the coil component 100F.

### (Method for Manufacturing Coil Component 100B)

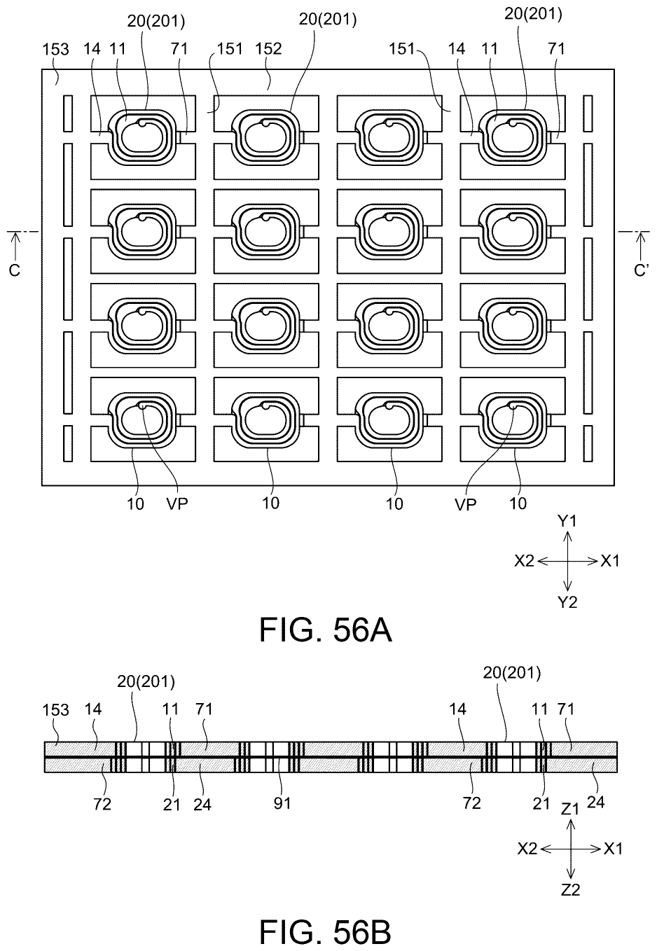

FIG. 56A to FIG. 66C are explanatory diagrams illustrating another example of a method for manufacturing the coil component 100B according to the second embodiment

First, as shown in the XY plan view of FIG. 56A and the XZ sectional view of FIG. 56B (cross-section along line C-C′ in FIG. 56A), a plurality of spiral portions (first spiral conductor portion 11 and second spiral conductor portion 21) are formed (first step). Specifically, the first spiral conductor portion 11 is formed on one surface of an insulating sheet substrate 91 (specifically, the surface on the Z1 side in the Z1-Z2 direction), and the second spiral conductor portion 21 is formed on the other surface of the sheet substrate 91 (specifically, the surface on the Z2 side in the Z1-Z2 direction). The formation process of the first and second spiral conductor portions 11 and 21 is not particularly limited; for example, they can be formed by a plating process. In this embodiment, via member VP as well as first lead-out portion 14 and second lead-out portion 24 are also formed simultaneously during this process.

When this step includes a plating process, the coil conductor portion 20 including the first conductor portion 201 includes a portion formed of a plating layer. Further, the first dummy conductor portion 72 is formed by this plating process.

In addition, by the same plating process, connecting portions 151 extending in the Y1-Y2 direction and connecting portions 152 extending in the X1-X2 direction are formed around the coil conductor portion 20 as viewed in the first direction (Z1-Z2 direction). The connecting portions 151 and the connecting portions 152 are provided in a lattice pattern at intermediate positions between two adjacent coil conductor portions 20 and also provided so as to surround the outer periphery of the entire region of the plurality of coil conductor portions 20. The connecting portions 151 and the connecting portions 152 structurally connect the plurality of coil conductor portions 20 to enhance shape retention and are also used as current supply portion in the plating process. Lands 155 may be formed at the intersections of the connecting portions 151 and the connecting portions 152. Thus, in the first step, a conductor pattern including multiple spiral portions (first spiral conductor portion 11 and second spiral conductor portion 21) and connecting portions (connecting portions 151, connecting portions 152) of the multiple spiral portions is formed.

In next step, at least a part of the sheet substrate 91 is removed. Specifically, as viewed in the first direction (Z1-Z2 direction), the sheet substrate 91 is removed so as to include a region surrounded by the inner periphery of the first spiral conductor portion 11. The specific removal process of the sheet substrate 91 is the same as that described in the previous manufacturing methods.

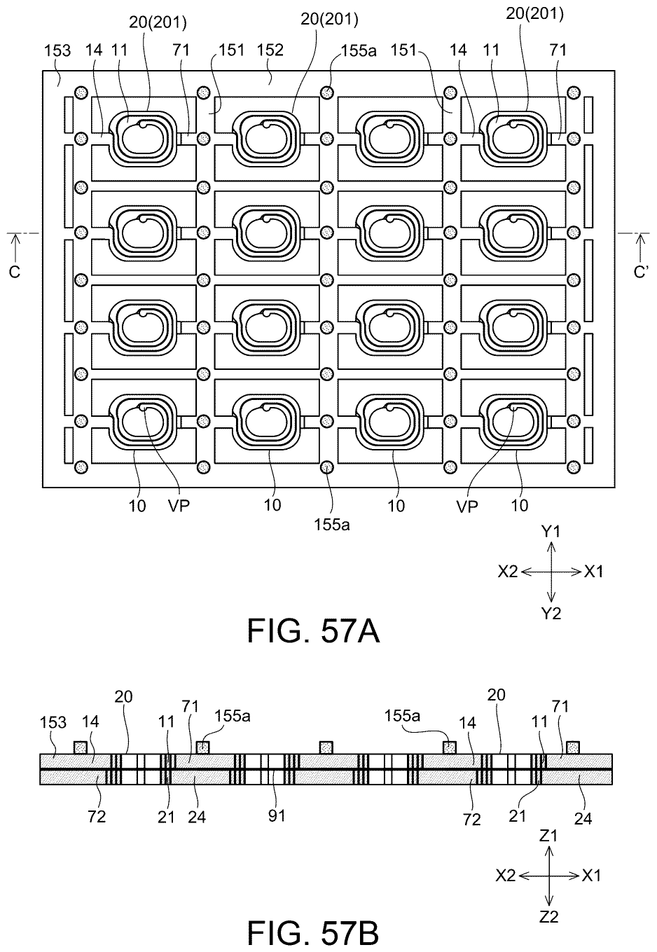

Next, as shown in the XY plan view of FIG. 57A and the XZ sectional view of FIG. 57B (cross section taken along line C-C′ in FIG. 57A), flux 155a is coated over the connecting portions 151 (Z1 side in Z1-Z2 direction). The coating positions of the flux 155a are the intersection positions of the extending first lead-out section 14 and the connecting portions 151, the intersection positions of the extending second dummy conductor portion 71 and the connecting portions 151, and the intersection positions of the connecting portions 151 and the connecting portions 152. The method of coating the flux 155a is not limited and may include, for example, a method of transferring the flux 155a from a plurality of pins to each land 155 by attaching the flux 155a to the tips of the plurality of pins, or a method of applying the flux 155a by screen printing using a mask such as a metal mask.

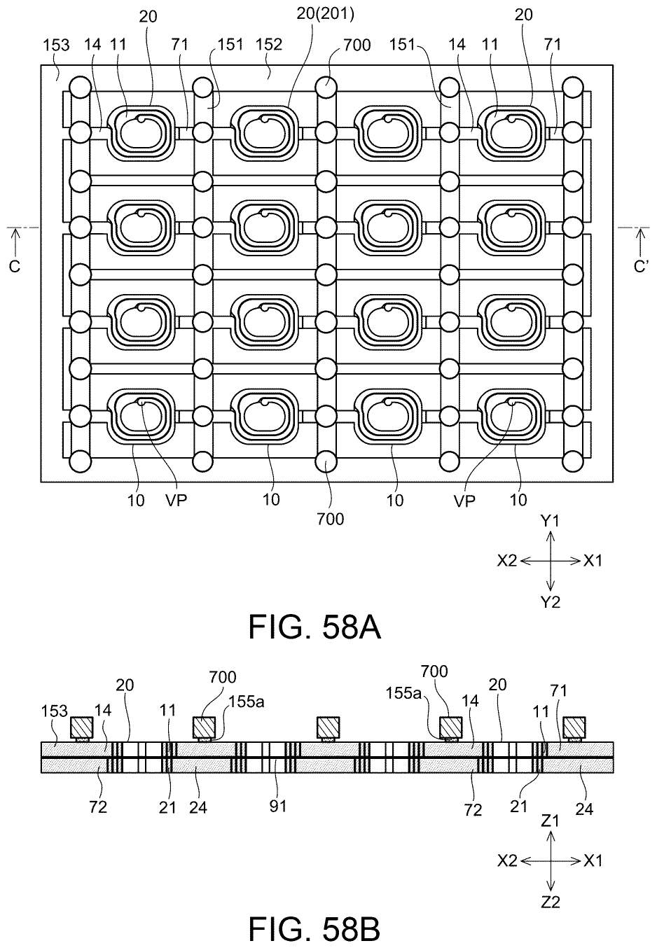

Next, as shown in the XY plan view of FIG. 58A and the XZ cross-sectional view of FIG. 58B (cross section along line C-C′ in FIG. 58A), the support member material 700 is mounted on top of the adhesive 155b (on Z1 side in Z1-Z2 direction) applied in the previous step (part of the second step). Accordingly, the support member material 700 extends from the connecting portions 151 and 152 toward one side in the first direction (Z1 side in Z1-Z2 direction). Support members 701A, 701B, 702A, 702B, 703A, and 703B are formed from the support member material 700 thus provided. The method of mounting the support member material 700 is not limited. For example, a vibration embedding method similar to that described in the previous manufacturing methods can be employed. The support member material 700 may be a solder ball, heterogeneous solder ball (such as copper-core solder ball or resin-core solder ball), or copper pillar (cylindrical, cylindrical with header, spherical, truncated cone, laminated type, etc.), similar to the previous manufacturing method. After mounting the support member material 700, it is fixed to the connecting portion 151 by reflow.

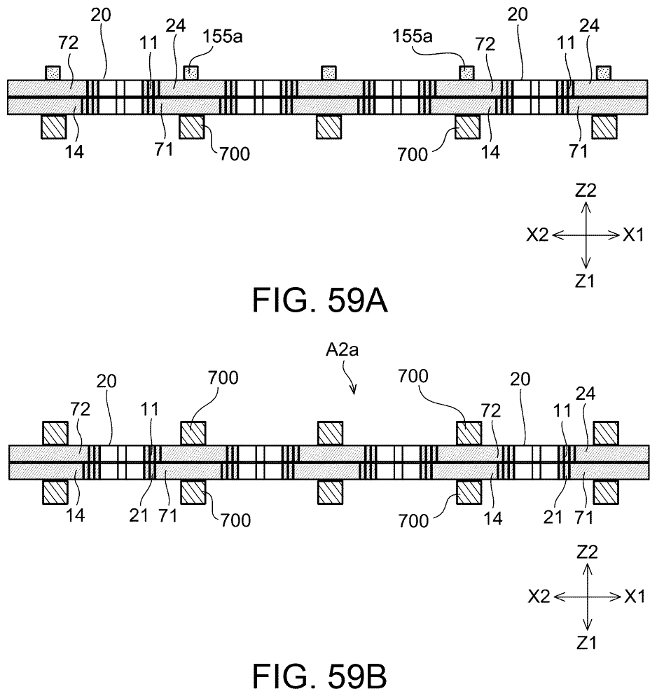

Next, as shown in the XY sectional views of FIG. 59A and FIG. 59B, the application of flux 155a to the connecting portion 151, mounting and fixing of the support member material 700 performed on one surface (Z1 side in Z1-Z2 direction) of the coil member 10 in the previous step are similarly performed on the other surface (Z2 side in Z1-Z2 direction) of the coil member 10 (another part of the second step). From the support member material 700 thus provided, support members 704A, 704B, 705A, 705B, 706A, and 706B are formed.

After fixing the support member material 700 to the connecting portions 151, an insulating coating is applied to the exposed surfaces of the connecting portions 151 and 152, the support member material 700, and the first spiral conductor portion 11 and the second spiral conductor portion 21. The process for forming the insulating coating is similar to the previously described manufacturing method.

Next, a material containing magnetic powder is supplied and shape-formed into a plate material so as to cover the conductor pattern on at least two surfaces in the first direction (Z1-Z2 direction) (third step). An example of this shape forming process is a process in which the coil member 10 is surrounded by a material containing magnetic material. Specific examples of the shape forming process include placing the product A2a formed up to the previous step in a mold and forming it by compression molding of a material containing magnetic material, or transfer molding a material containing magnetic powder or a member serving as a raw material for such material.

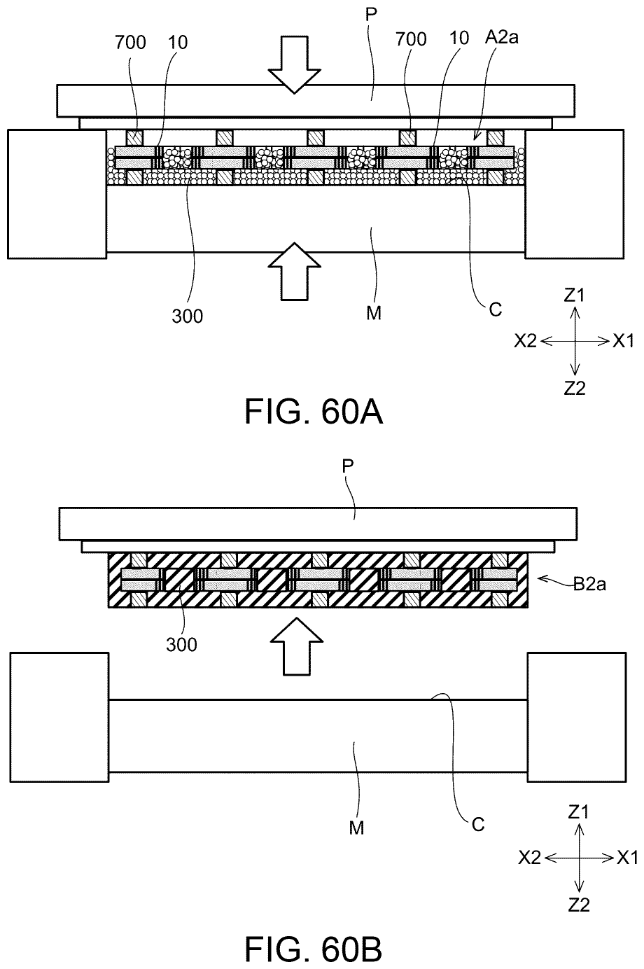

FIG. 60A and FIF. 60B schematically show the compression molding process. First, as shown in FIG. 60A, a material containing magnetic material is placed in a cavity C of a mold M, and the product A2a is mounted on a support substrate P. Next, the product A2a mounted on the support substrate P is inserted into the cavity C of the mold M and compressed between the mold M and the support substrate P. At this time, one support member material 700 is interposed between the support substrate P and the coil member 10, and the support member material 700 acts as a pillar to ensure a certain gap between the coil member 10 and the support substrate P. Also, another support member material 700 is interposed between the cavity C of the mold M and the coil member 10, and the support member material 700 acts as a pillar to ensure a certain gap between the coil member 10 and the cavity C.

In this compression molding, since the material containing magnetic material is made to flow and spread into the cavity C while a compressive force is applied between the mold M and the support substrate P, stress is applied to the product A2a during material filling. In particular, as the material flows and spreads into the cavity C, the material moves from the cavity C toward the support substrate P side, so strong stress is applied to the product A2a toward the support substrate P side. In this embodiment, since one side of the product A2a is supported by the support substrate P via the support member material 700, deformation of the product A2a is suppressed even if the product A6 is pressed toward the support substrate P side by the material. Also, in this embodiment, since the other side of the product A6 is supported by the cavity C via the support member material 700, deformation of the product A2a toward the cavity C side is suppressed. That is, positional displacement of each coil member 10 in the product A2a is effectively suppressed.

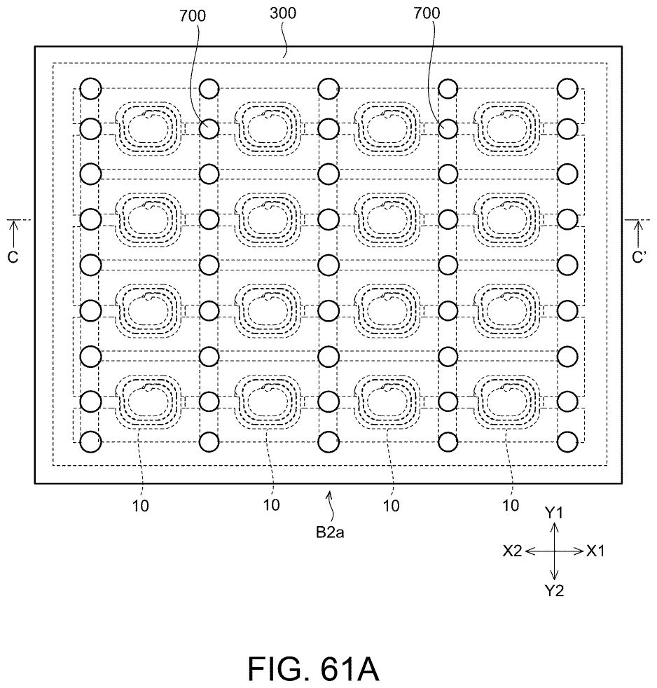

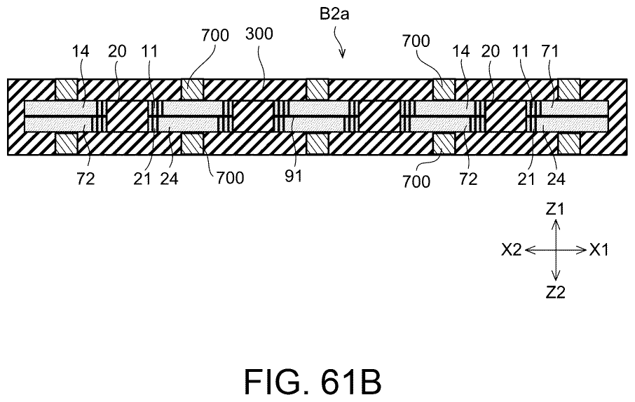

After the material containing magnetic material is filled into the cavity C, it is solidified or cured. Thereafter, demolding is performed (see FIG. 60B). FIG. 61A shows an XY plan view of the product B2a formed from the plate material and obtained after demolding, and FIG. 61B shows an XZ cross-sectional view along line C-C′ in FIG. 61A. In the product B2a, the entire periphery of the product A2a is covered with the body material 300 (a material containing magnetic material that has been solidified or cured).

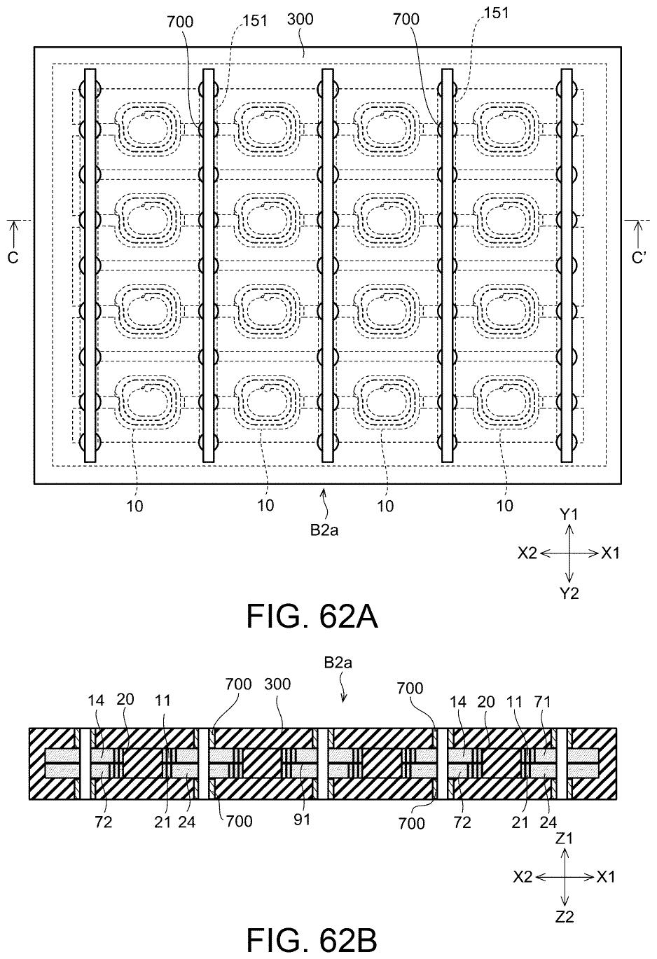

Next, as shown in the XY plan view of FIG. 62A and the XZ cross-sectional view of FIG. 62B (cross section along line C-C′ in FIG. 62A), the product B2a is divided at predetermined positions. In other words, in this step, the product B2a is fully cut along the connecting portions 151. A part of the connecting portions 151 and a part of the support member material 700 remain. Furthermore, in the direction X1-X2, a part, which is more inward than an outer periphery, of an outer peripheral member 153 is diced. By way of dicing, the exposed lead-out surface 140, the dummy end surface portion 71E, the exposed lead-out surface 240, the dummy end surface portion 72E, and the first exposed surface 70C are exposed from the cut surface of the body material 300.

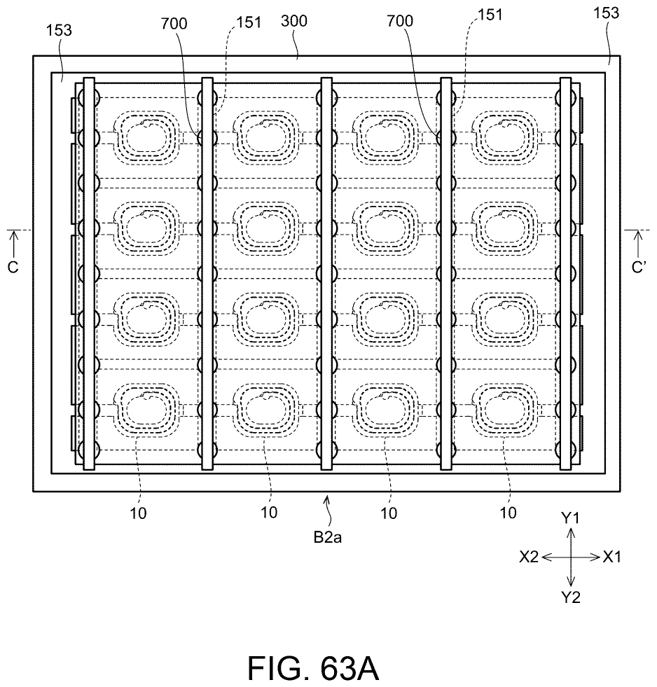

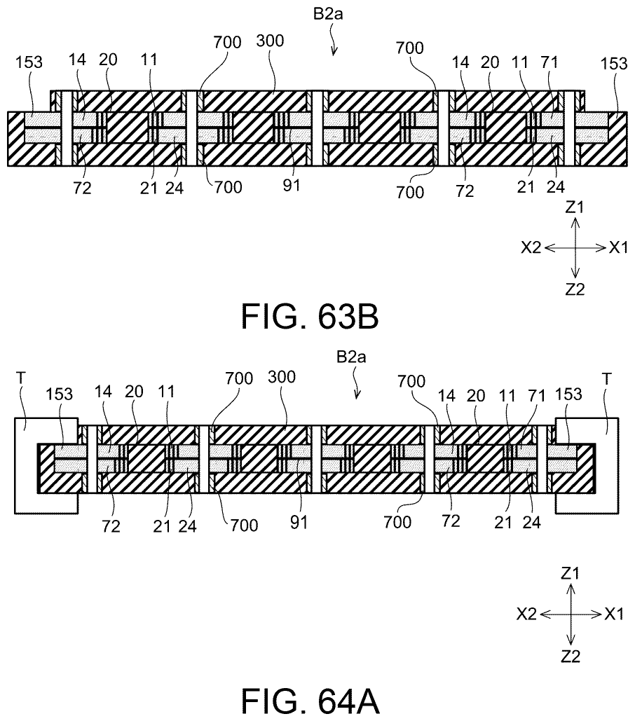

Subsequently, as shown in the XY plan view of FIG. 63A and the XZ cross-sectional view of FIG. 63B (cross section along line C-C′ in FIG. 63A), the body material 300 is half-cut to expose the outer peripheral member 153 when viewed in the direction Z1-Z2.

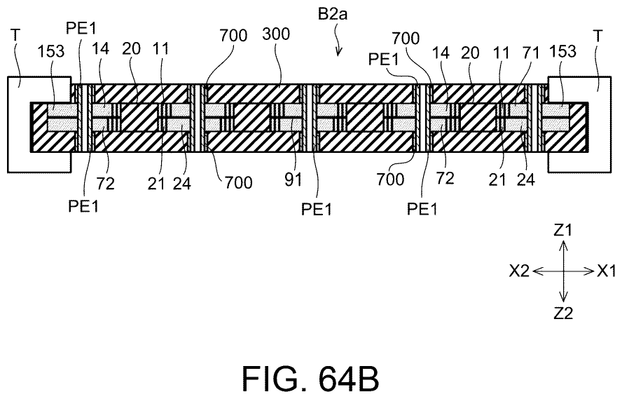

Next, as shown in a schematic cross-sectional view of FIG. 64A, an electrode terminal T is mounted to the outer peripheral member 153, which is exposed from the body material 300 in the previous step. Furthermore, current flows from the electrode terminal T to a conductor portion of the product B2a, and plating is performed by electrolytic plating. By way of the plating, as shown in a schematic cross-sectional view of FIG. 64B, a plated electrode PE1 is formed on the cross section (exposed surface), which is formed by full-cut dicing.

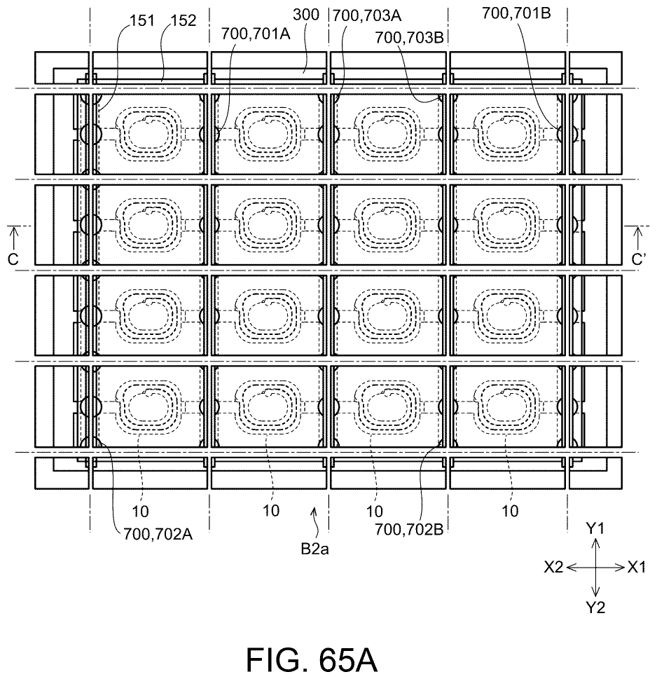

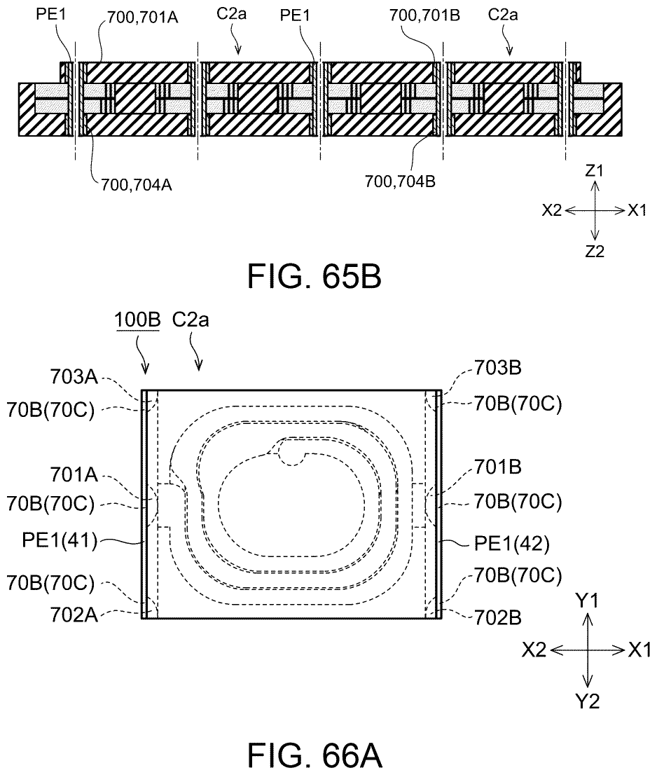

Next, the product B2a formed from the plate material is cut such that a first direction (Z1-Z2 direction) is parallel to the cut surface, and a fourth step of obtaining a plurality of first members including spiral portions (first spiral conductor portion 11, second spiral conductor portion 21) is performed. Specifically, as shown in the XY plan view of FIG. 65A and the XZ cross-sectional view of FIG. 65B (cross section taken along line C-C′ in FIG. 65A), the product B2a is divided at predetermined positions. In this step, the product B2a is diced along respective directions of connecting portions 151 and 152. The one-dot chain lines in FIGS. 65A and 65B indicate dicing lines (division lines). By dicing, a product C2a having each coil member 10 and the main body portion 30, where the body material 300 covering the coil member 10 is divided, is formed into the first members. In the product C2a, the connecting portions 152 are cut off by dicing without remaining, but a part of the connecting portions 151 and a part of the support member material 700 remain.

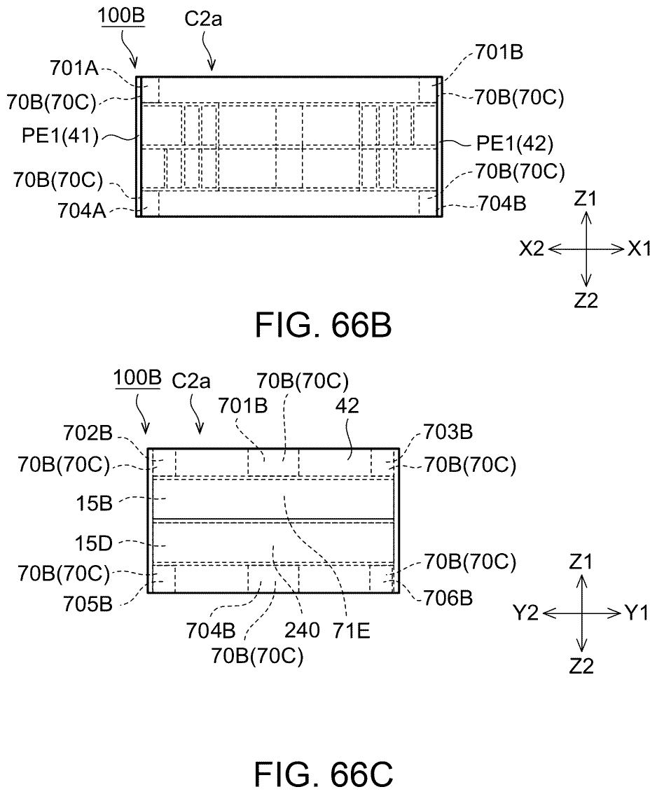

Next, as shown in the XY plan view of FIG. 66A, the XZ plan view of FIG. 66B, and the YZ plan view of FIG. 66C, in the manufacturing method according to this embodiment, the plated electrodes PE1 forms the first terminal member 41 and the second terminal member 42. Accordingly, according to this embodiment, the coil component 100B is produced. In this embodiment, in the formation of the plated electrodes PE1, which form the first terminal member 41 and the second terminal member 42, since only the plated portion is exposed as the cross section by way of dicing, the process for providing a protective film onto a portion other than the plated portion can be partial or entirely omitted. A protective film may also be formed for the portion where the conductor portion is exposed from the outer side of the coil component 100B, which is exposed by dicing.

### (Method for Manufacturing Coil Component 100G)

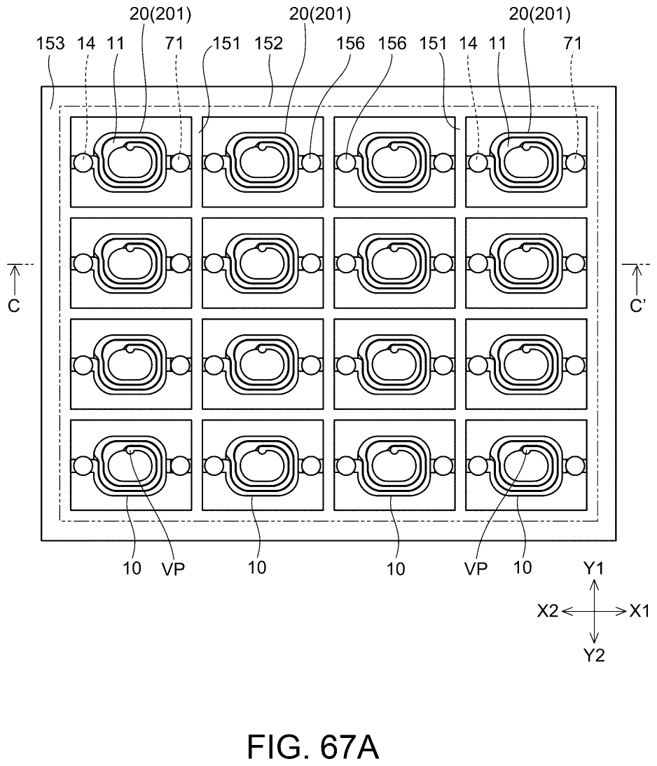

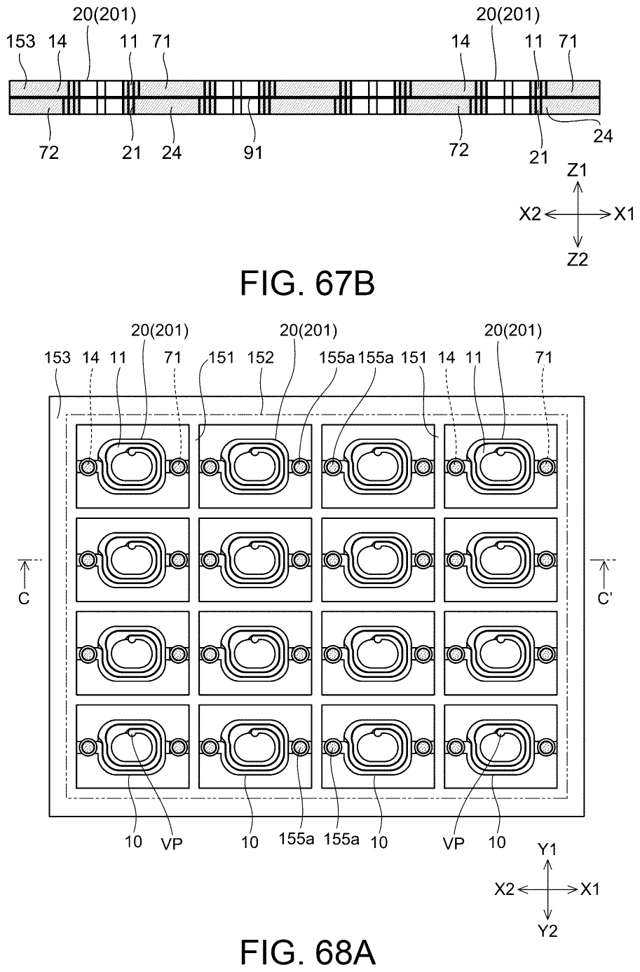

FIG. 67A to FIG. 77C are explanatory diagrams illustrating an example of a method for manufacturing the coil component 100G according to the seventh embodiment.

First of all, as shown in the XY plan view of FIG. 67A and the XZ cross-sectional view of FIG. 67B (cross section along line C-C′ in FIG. 67A), a plurality of spiral portions (first spiral conductor portion 11 and second spiral conductor portion 21) are formed (first step). Specifically, the first spiral conductor portion 11 is formed on one surface of an insulating sheet substrate 91 (specifically, the surface on Z1 side in Z1-Z2 direction), and the second spiral conductor portion 21 is formed on the other surface of the sheet substrate 91 (specifically, the surface on Z2 side in Z1-Z2 direction). The process for forming the first spiral conductor portion 11 and the second spiral conductor portion 21 is not particularly limited. For example, they can be formed by a plating process. In this embodiment, via members VP as well as the first lead-out section 14 and the second lead-out section 24 are also formed simultaneously in this process.

When this step includes a plating process, the coil conductor portion 20 including the first conductor portion 201 includes a portion formed of a plating layer. Further, the first dummy conductor portion 72 is formed by this plating process.

In addition, by the same plating process, connecting portions 151 extending in the Y1-Y2 direction and connecting portions 152 extending in the X1-X2 direction are formed around the coil conductor portion 20 as viewed in the first direction (Z1-Z2 direction). The connecting portions 151 and the connecting portions 152 are provided in a lattice pattern at intermediate positions between two adjacent coil conductor portions 20 and also provided so as to surround the outer periphery of the entire region of the plurality of coil conductor portions 20. The connecting portions 151 and the connecting portions 152 structurally connect the plurality of coil conductor portions 20 to enhance shape retention and are also used as current supply portion in the plating process. Furthermore, by way of the same plating process, an outer peripheral member 153, which connects the connecting portions 151 and 152, is formed on the outer periphery viewed in the first direction (Z1-Z2 direction), and meanwhile, lands 156 may be formed at the position overlapping the first lead-out section 14 and the position overlapping the first dummy conductor portion 72. Thus, in the first step, a conductor pattern including a plurality of spiral portions (first spiral conductor portion 11 and second spiral conductor portion 21), connecting portions of the plurality of spiral portions (connecting portions 151, connecting portions 152), the outer peripheral member 153, and the lands 156 is formed.

Here's the full English translation of the provided Japanese technical text. I've kept the structure and numbering intact so it mirrors the original document clearly:

In the next step, at least a portion of the sheet substrate 91 is removed. Specifically, when viewed in the first direction (Z1-Z2 direction), the sheet substrate 91 is removed so as to include the region enclosed by the inner periphery of the first spiral conductor portion 11. The specific removal process of the sheet substrate 91 is the same as the manufacturing method described as above.

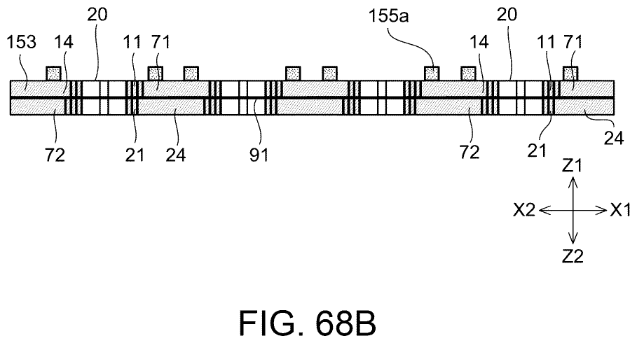

Next, as shown in the XY plan view of FIG. 68A and the XZ cross-sectional view of FIG. 68B (cross section along line C-C′ in FIG. 68A), flux 155a is applied on the lands 156 (Z1 side in Z1-Z2 direction). The method of applying flux 155a is not limited. For example, flux 155a may be attached to the tips of multiple pins and transferred from the pins to the application positions of the connecting portions 151, or applied by screen printing using a mask such as a metal mask.

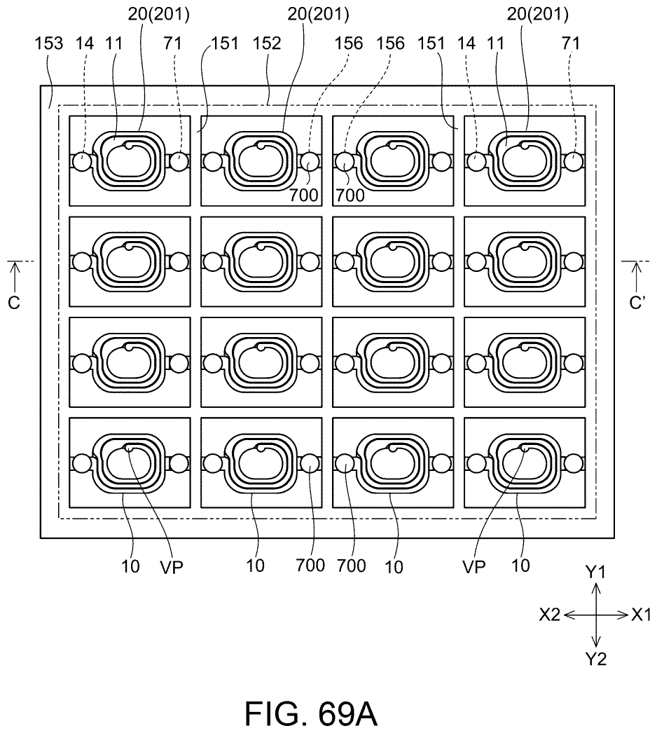

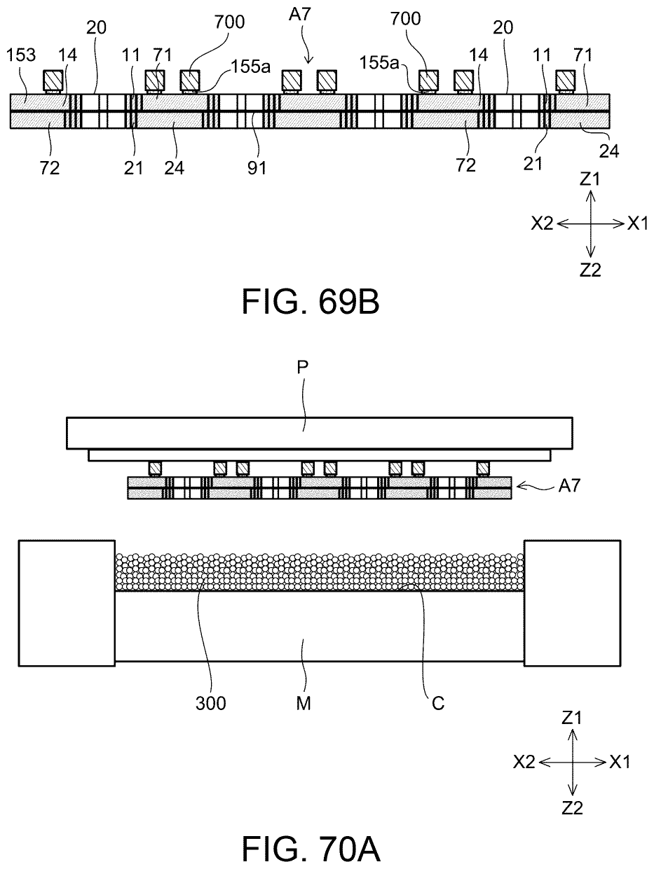

Next, as shown in the XY plan view of FIG. 69A and the XZ cross-sectional view of FIG. 69B (cross section along line C-C′ in FIG. 69A), a support member material 700 that provides support members 701A and 701B is mounted on the flux 155a applied in the previous step (part of the second step). This forms a support member material 700 extending from the lands 156 toward one side of the first direction (Z1 side in Z1-Z2 direction). The method of mounting the support member material 700 is not limited, but examples include the transfer method described as above. As the support member material 700, solder balls, heterogeneous-core solder balls (copper-core solder balls, resin-core solder balls, etc.), and copper pillars (cylindrical, cylindrical with header, spherical, truncated cone, laminated, etc.) may be used as described previously. After mounting the support member material 700, it is fixed to the lands 156 by reflow.

After fixing the support member material 700 to the connecting portions 151, an insulating coating is applied to the exposed surfaces of the connecting portions 151 and 152, the support member material 700, the first spiral conductor portion 11, and the second spiral conductor portion 21. The process of forming the insulating coating is the same as the manufacturing method described above.

Next, a material containing magnetic powder is supplied to form a plate material so as to cover the conductor pattern on at least two sides in the first direction (Z1-Z2 direction) (third step). An example of this shape forming process is surrounding the coil member 10 with a material containing magnetic material. Specific examples of the shape forming process include placing the product A7 formed up to the previous step into a mold and forming it by compression molding of a material containing magnetic material, or transfer molding of a material containing magnetic powder or its raw material.

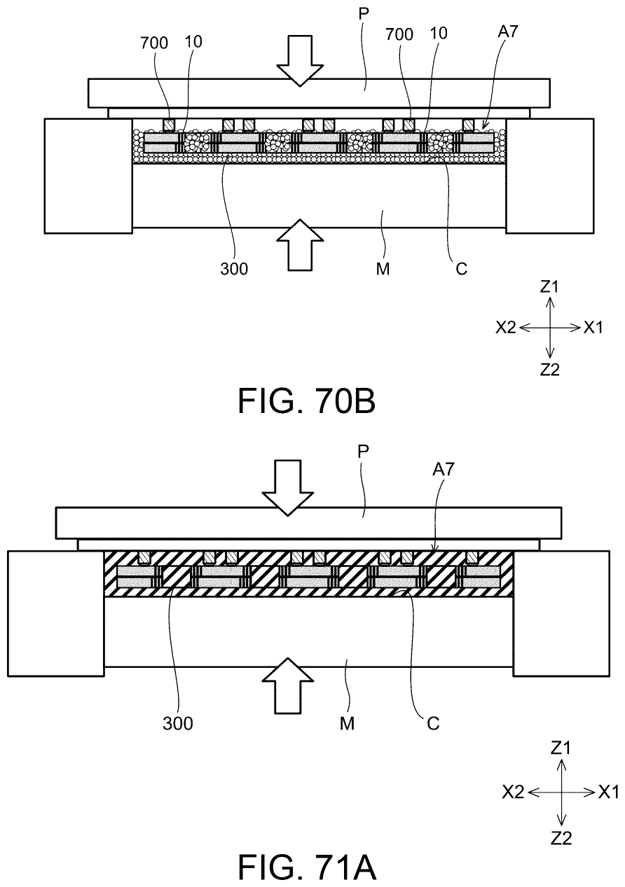

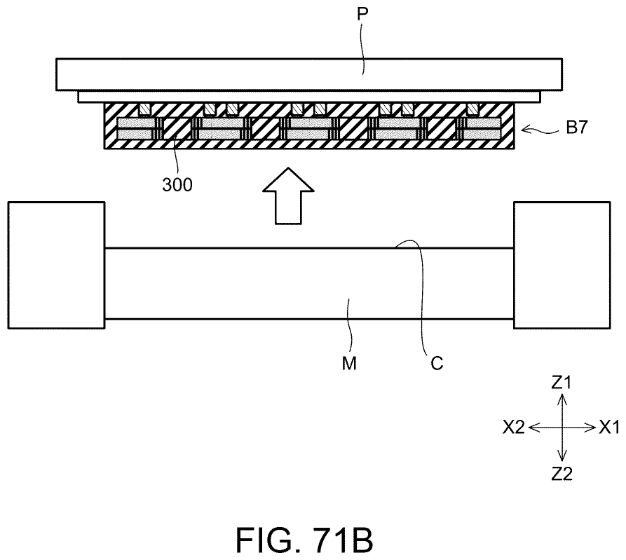

FIG. 70A to FIG. 71B show schematic cross-sectional views of the compression molding process. First, as shown in FIG. 70A, a material containing magnetic material is placed into a cavity C of a mold M, and the product A7 is attached to a support substrate P. Next, the product A7 attached to the support substrate P is inserted into the cavity C of the mold M and compressed between the mold M and the support substrate P. At this time, the support member material 700 is interposed between the support substrate P and the coil member 10, serving as a pillar to ensure a certain gap between the coil member 10 and the support substrate P.

In this compression molding, since the material containing magnetic material is made to flow and spread within cavity C while compression force is applied between the mold M and the support substrate P, stress is applied to the product A7 during material filling. In particular, as the material flows and spreads within cavity C, it moves toward the support substrate P side from the cavity C, thereby applying strong stress toward the support substrate P side on the product A7. In this embodiment, since the product A7 is supported on the support substrate P by the support member material 700, deformation of the product A7 is suppressed even if it is pressed toward the support substrate P side by the material. That is, displacement of each coil member 10 in the product A7 is effectively suppressed.

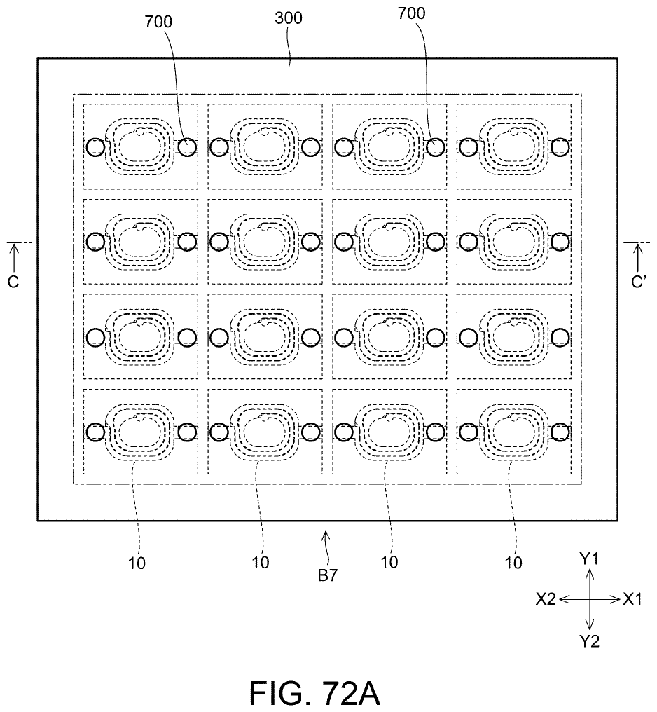

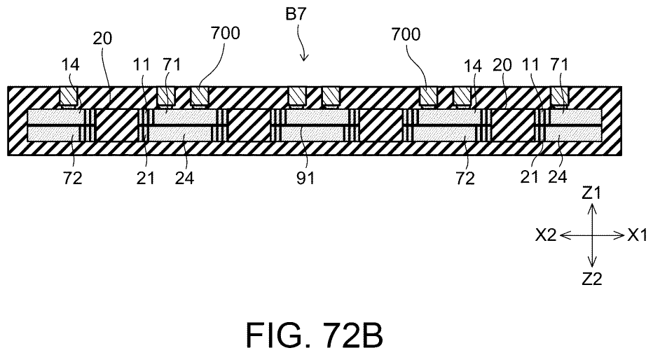

After the material containing magnetic material is filled into the cavity C, it is solidified or cured. Thereafter, demolding is performed (see FIG. 71B). FIG. 72A shows an XY plan view of the product B7 obtained from the demolded plate material, and FIG. 72B shows a cross-sectional view taken along line C-C′ in FIG. 72A. In the product B7, a state that the entire periphery of the product A1 is covered with the body material 300 (the solidified or cured material containing magnetic material) is rendered.

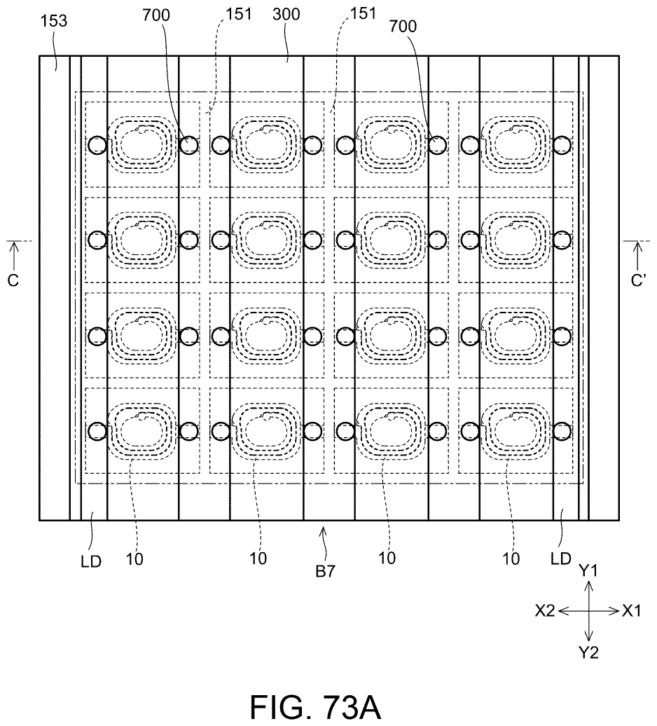

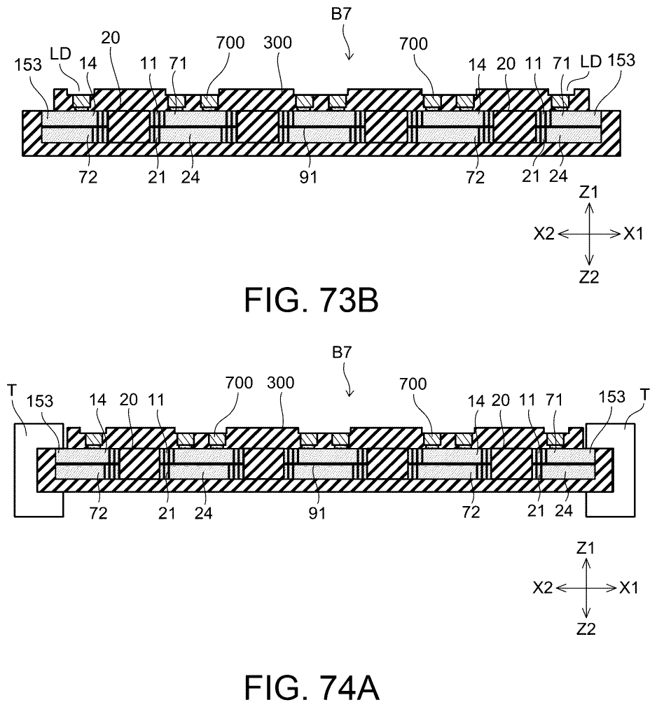

Next, as shown in the XY plan view of FIG. 73A and the XZ cross-sectional view of FIG. 73B (cross section along line C-C′ in FIG. 73A), predetermined positions of product B7 are half-cut. That is, in this step, the body material 300 is half-cut along the connecting portions 151 to a depth exposing the support member material 700, extending in the Y1-Y2 direction, thereby forming a linear recess LD recessed on the Z2 side in the Z1-Z2 direction. The width of the half-cut is wider than the width of the support member material 700.

In adjacent portions of the support member material 700 in the X1-X2 direction (adjacent portions of the support member material 700 where no coil member 10 is interposed therebetween), the width of the linear recess LD is set to be the width including the adjacent portions of the support member material 700. As a result, the support member material 700 is exposed from the bottom surface of the linear recess LD. Furthermore, the body material 300 is half-cut so that the outer peripheral member 153 is exposed when viewed in the Z1-Z2 direction.

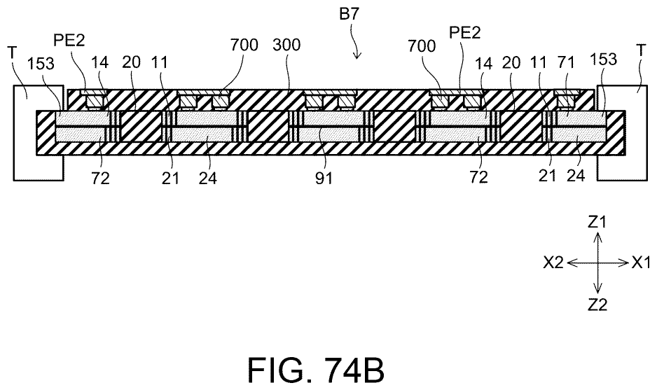

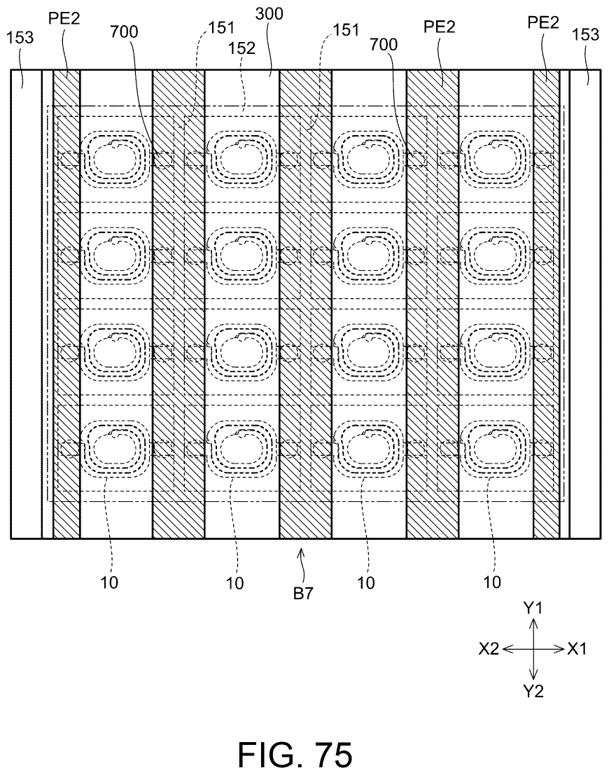

Next, as shown in the schematic cross-sectional view of FIG. 74A, an electrode terminal T is attached to the outer peripheral member 153 exposed from the body material 300 in the previous step. The electrode terminal T is attached so as to clamp the outer peripheral member 153. Then, current is supplied from the electrode terminal T to the conductor portion of the product B7, and plating is performed by electrolytic plating. By this plating, as shown in the schematic cross-sectional view of FIG. 74B, a plating electrode PE2 is formed on the support member material 700 exposed at the bottom surface of the linear recess LD. In the XY plan view of FIG. 75, the hatched portion indicates the plating electrode PE2 formed along the linear recess LD created by half-cutting.

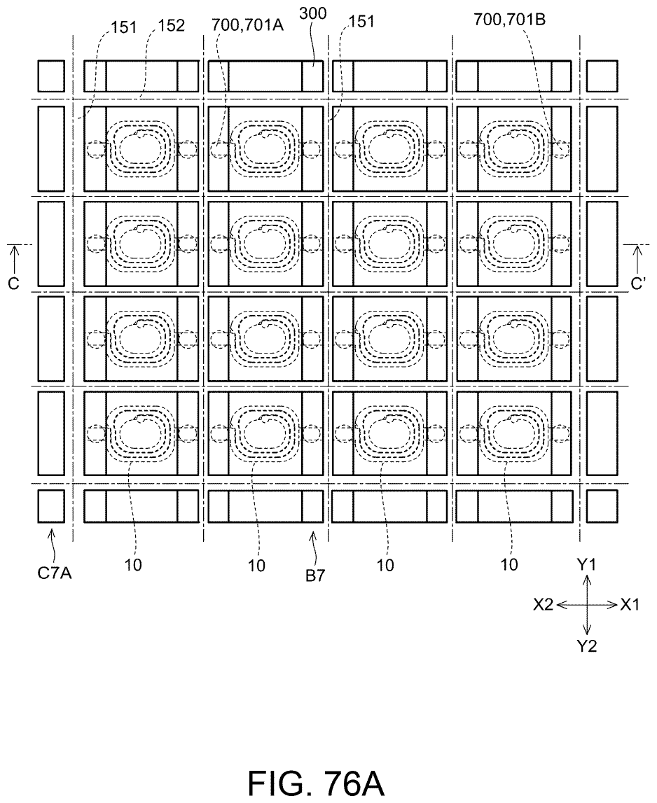

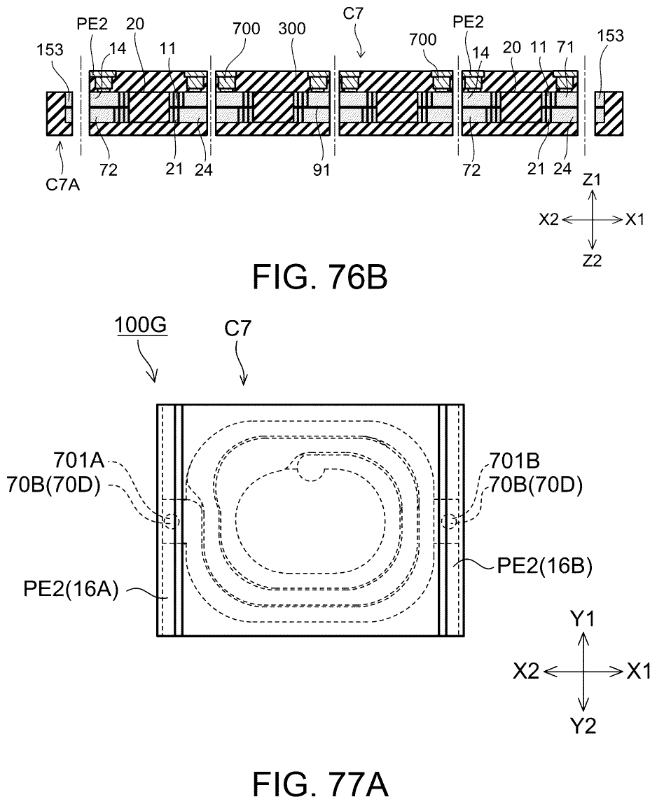

Next, in the fourth step, the product B7 made of the plate material is cut so that the first direction (Z1-Z2 direction) is parallel to the cut surface, thereby obtaining a plurality of first members including the spiral portions (first spiral conductor portion 11 and second spiral conductor portion 21). Specifically, as shown in the XY plan view of FIG. 76A and the XZ cross-sectional view of FIG. 76B (cross section along line C-C′ in FIG. 76A), the product B7 is divided at predetermined positions. In this step, the product B7 is diced along each of the connecting portions 151 and the connecting portions 152. The one-dot chain lines in FIG. 76A and FIG. 76B indicate dicing lines (division lines). By dicing, the product C7 is formed as a first member having each coil member 10 and the body portion 30 covering it, with the body material 300 divided. In addition, the plated electrode PE2, which is formed across the adjacent portions of the support member material 700 in the X1-X2 direction, is also divided. In the product C7, the connecting portions 152 are cut off by dicing and no longer remains, but a part of the connecting portions 151 and a part of the support member material 700 remain.

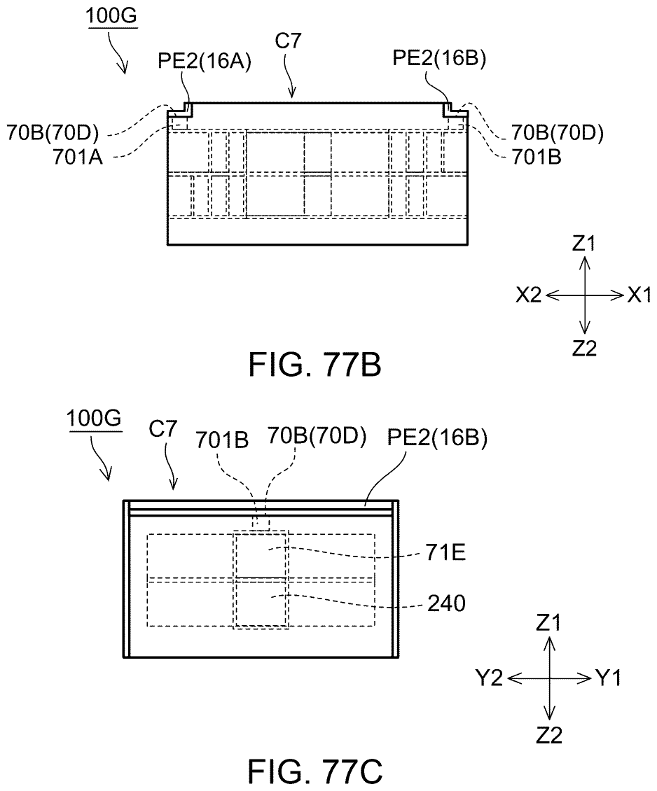

As shown in the XY plan view of FIG. 77A, the XZ plan view of FIG. 77B, and the YZ plan view of FIG. 77C, in the manufacturing method of this embodiment, the plated electrode PE2 forms the external electrodes 16A and 16B. Thus, coil component 100G according to this embodiment is produced. In this embodiment, in formation of the plated electrode PE2 that forms the first terminal member 41 and the second terminal member 42, only the plated portion is exposed as a cut surface by dicing, so the process of providing a protective film on portions other than the plated portion can be omitted. Note that a protective film may be formed on portions where conductor portions are exposed from the outer surface of coil component 100G by dicing.

### (Land Structure)

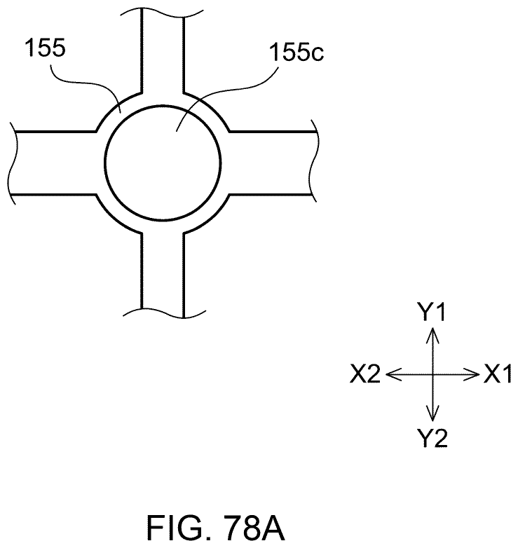

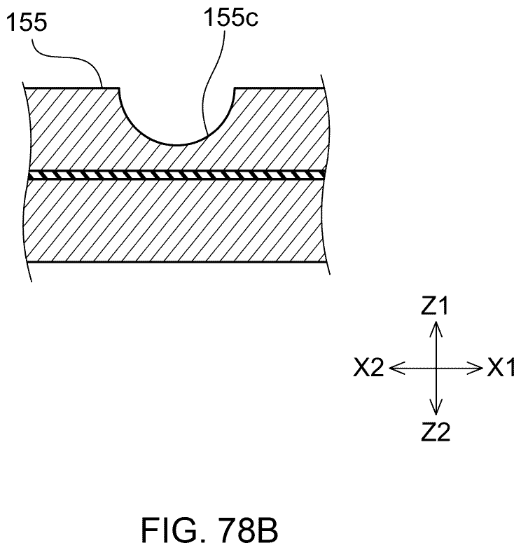

FIG. 78A and FIG. 78B are diagrams illustrating the structure of a land according to this embodiment. FIG. 78A shows an XY plan view of the land, and FIG. 78B shows a cross-sectional view in the XZ plane.

The land 155 may be flat in the XY plane, but as shown in FIG. 78A and FIG. 78B, it is preferable that a recess 155c be provided approximately at the center. When the land 155 is formed by a plating process, if the central portion of the land 155 bulges convexly, mounting the support member material 700 on the land 155 becomes unstable. Therefore, in order to stably mount the support member material 700 on the land 155, it is preferable to provide the recess 155c approximately at the center of the land 155.

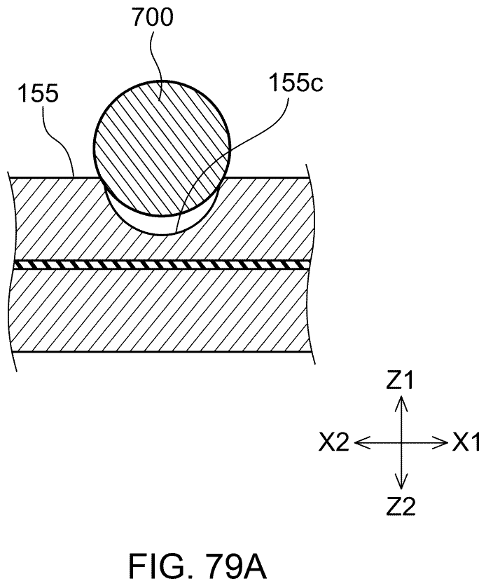

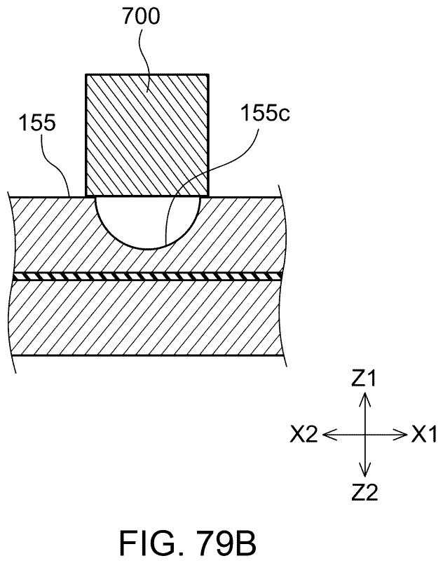

FIG. 79A and FIG. 79B are schematic cross-sectional views illustrating examples of the mounted state of the support member material. FIG. 79A shows the state where a spherical support member material 700 is mounted, and FIG. 79B shows the state where a prismatic (rectangular parallelepiped) support member material 700 is mounted. When mounting the spherical support member material 700 shown in FIG. 79A, the lower side of the sphere fits into the recess 155c of the land 155. When mounting the prismatic support member material 700 shown in FIG. 79B, the support member material 700 does not fit into the recess 155c of the land 155, but since the surface of the land 155 does not bulge convexly, stable mounting is possible.

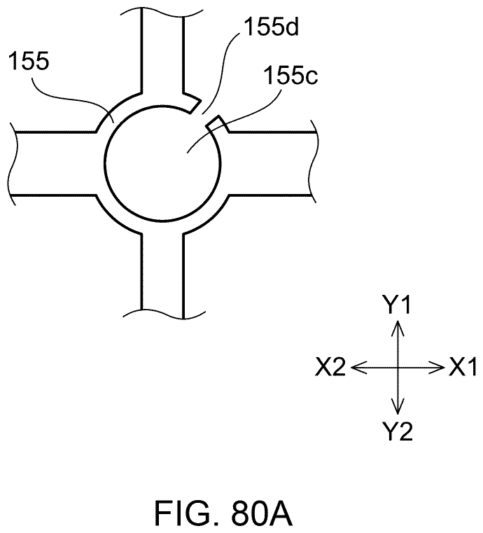

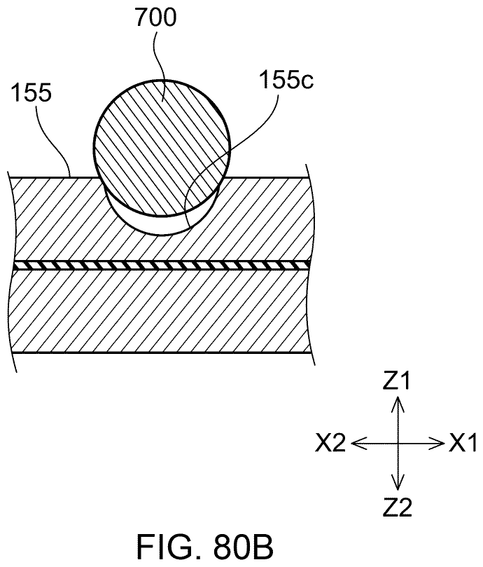

FIG. 80A and FIG. 80B are schematic diagrams illustrating another example of the land 155. FIG. 80A shows an XY plan view of the land, and FIG. 80B shows a schematic cross-sectional view of the state where a support member material is mounted on the land. The land 155 shown in FIG. 80A and FIG. 80B has a recess 155c approximately at its center, but in the XY plane view (viewed in Z1-Z2 direction), a gap 155d is partially provided (i.e., it is not closed). Even with such a shape of land 155, the support member material 700 fits into the recess 155c provided approximately at the center, achieving stable mounting. Furthermore, because the land 155 is not closed, the peelability of the resist film during formation of the land 155 is improved. Even if the land 155 is not closed, the land 155 is reinforced by the support member material 700 being fixed when mounted.

### (Electronic/electric Device)

An electronic/electric device according to an embodiment of the present invention is an electronic/electric device in which a coil component 100A-100G according to an embodiment of the present invention is mounted. The coil conductor portion 20 of the coil component 100A-100G is connected to the substrate at exposed conductor portions located at each of its two end parts and exposed outward. In the coil components 100A, 100B, and 100F, the first terminal member 41 and the second terminal member 42 correspond to the exposed conductor portions. In the coil components 100C, 100D, and 100G, the first terminal member 41, the second terminal member 42, and external electrodes 16A and 16B correspond to the exposed conductor portions. In the coil component 100E, the exposed lead-out surfaces 140 and 240, the dummy end surface portions 71E and 72E, the exposed connecting portion surface 150, and the first exposed surface 70C correspond to the exposed conductor portions. Furthermore, in cases where coil components 100C, 100D, and 100G do not include the first terminal member 41 and the second terminal member 42, the external electrodes 16A and 16B correspond to the exposed conductor portions. Since the electronic/electric device according to an embodiment of the present invention is mounted therein the coil component 100A-100G, miniaturization of the device is easily achieved. Moreover, even when a large current flows or a high frequency is applied in the device, malfunctions due to performance degradation or heat generation of coil components 100A-100G are unlikely to occur.

The embodiments and examples described above are provided to facilitate understanding of the present invention and are not intended to limit the scope of the invention. Therefore, each element disclosed in the above embodiments is intended to include all design changes and equivalents falling within the scope of the present invention.

For example, an example where the coil conductor portion 20 illustrated in the above description comprises a first conductor portion 201 and a second conductor portion 202. However, the configuration may also include only one of the first conductor portion 201 and the second conductor portion 202. Furthermore, while the coil conductor portion 20 is formed of one type of conductive material, this is not limited thereto. It may also be formed of multiple materials.

What is claimed is:

1. A coil component, comprising:
a coil member, comprising a coil conductor portion, which comprises a first spiral conductor portion of a spiral shape when viewed in a first direction;
a main body portion, containing a magnetic powder, having an outer surface extending in a first direction and two intersecting surfaces arranged alongside in the first direction, and covering at least partially the coil member with the intersecting surfaces; and
a support member in contact with the coil member and forming a first interface intersecting the first direction,
wherein the support member has an exposed support surface exposed from the main body portion, and the exposed support surface includes a first exposed surface, which has an in-plane direction along the first direction.

2. The coil component according to claim 1, wherein the support member comprises a support conductor portion, which is conductive, and at least a part of the first interface is formed from a contact interface between a conductive surface of the support conductor portion and a conductive surface of the coil conductor portion.

3. The coil component according to claim 2, wherein the exposed support surface comprises an exposed conductive surface formed from the support conductor portion.

4. The coil component according to claim 3, wherein the exposed support surface comprises the exposed conductive surface exposed between the two intersecting surfaces arranged alongside in the first direction.

5. The coil component according to claim 4, wherein at least a part of the first exposed surface is formed from the exposed conductive surface.

6. The coil component according to claim 4, wherein the exposed support surface includes a second exposed surface intersecting the first direction, and at least a part of the second exposed surface is formed from the exposed conductive surface.

7. The coil component according to claim 6, wherein at least a part of the first exposed surface is formed from the exposed conductive surface.

8. The coil component according to claim 4, further comprising an external electrode in contact with the exposed conductive surface.

9. The coil component according to claim 4, wherein a part of an outermost surface is formed from the exposed conductive surface.

10. The coil component according to claim 3, wherein the coil conductor portion comprises the spiral conductor portion and a lead-out section continuously connected to the spiral conductor portion in a direction perpendicular to the first direction, and the lead-out section has an exposed lead-out surface exposed from the outer surface of the main body portion.

11. The coil component according to claim 3, wherein the support member is configured to taper toward a tip while contacting the conductive surface of the coil conductor portion.

12. The coil component according to claim 10, wherein the exposed lead-out surface extends in a direction perpendicular to the first direction.

13. The coil component according to claim 3, wherein in the main body portion, two surfaces parallel to the first direction are connected via the support member.

14. The coil component according to claim 3, wherein
the outer surface comprises a plurality of surfaces, and two adjacent surfaces among the plurality of surfaces are connected by a connecting portion, and
the support member, in at least a part of the connecting portion, is exposed from the main body portion.

15. The coil component according to claim 4, wherein the main body portion comprises a first recess part recessed in the first direction on at least one of the two surfaces arranged alongside in the first direction, and at least a part of the exposed conductive surface is located on a recessed surface of the first recess part.

16. The coil component according to claim 2, wherein the coil member has a second recess recessed in the first direction, and at least a part of the first interface is formed from a contact interface between at least a part of a recessed surface, which is a surface formed from an opening edge and an inner surface of the second recess, and the support member.

17. The coil component according to claim 16, wherein the support member comprises a support conductor portion, which is conductive, and at least a part of the first interface is formed from a contact interface between a conductive surface of at least a part of the recessed surface and the conductive surface of the support conductor portion.

18. The coil component according to claim 1, wherein:
the support member comprises a soft magnetic support member,
at least a part of the first interface is formed from a contact interface between the soft magnetic support member and the coil member, and
a relative permeability of the soft magnetic support member in the first direction is greater than a relative permeability of the main body portion in the first direction.

19. The coil component according to claim 18, wherein in the main body portion, two surfaces parallel to the first direction are connected via the support member.

20. The coil component according to claim 18, wherein:
the outer surface comprises a plurality of surfaces, and two adjacent surfaces among the plurality of surfaces may be connected by a connecting portion, and
the support member, in at least a part of the connecting portion, is exposed from the main body portion.

21. The coil component according to claim 18, wherein:
the main body portion has an outer shape of rectangular parallelepiped, which has sides parallel to the first direction, and
the support member is arranged to include at least one end part of four sides of the main body portion parallel to the first direction.

22. The coil component according to claim 18, wherein a relative permeability of the soft magnetic support member in the first direction is greater than a relative permeability of the main body portion in the first direction.

23. An electronic/electric device, in which the coil component according to claim 1 is mounted, wherein the coil component is connected to a substrate at terminal members provided on exposed conductor portions located at each of the two end parts of the coil conductor portion and exposed outwards.
